(19) United States
(12) Patent Application Publication
(10) Pub. No.: US 2010/0182663 A1
(43) Pub. Date: Jul. 22, 2010

(54) LIGHT ILLUMINATING APPARATUS AND LIGHT ILLUMINATING METHOD

(75) Inventors: Akio YAMAKAWA, Tokyo (JP); Kenji TANAKA, Tokyo (JP); Terumasa ITO, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/686,991

(22) Filed: Jan. 13, 2010

(30) Foreign Application Priority Data
Jan. 16, 2009 (JP) 2009-007844

(51) Int. Cl. G03H 1/12

(52) U.S. Cl. 359/11

(57) ABSTRACT

There is provided a light illuminating apparatus including: a light source allowing light to illuminate a hologram-recording medium having a recording layer, where information is recorded by an interference fringe of a signal light and a reference light, and a cover layer on an upper-layer side thereof; a spatial light-modulator performing spatial light-modulation on the light from the light source to generate the signal light and/or the reference light; and a light illuminating unit allowing the light, which is subject to the spatial light-modulation by the spatial light-modulator, as a recording/reproduced light to illuminate the hologram-recording medium through an objective lens, wherein a focus position of the recording/reproduced light is set so that a distance from a surface of the hologram-recording medium to the focus position of the recording/reproduced light is smaller than a distance from the surface to a lower-layer side surface of the recording layer.

The present application claims priority to Japanese Patent Application JP 2009-007844 filed in the Japan Patent Office on Jan. 16, 2009, the entire content of which is hereby incorporated by reference.

### BACKGROUND OF THE INVENTION

1. Field of the Present Invention

The present invention relates to a light illuminating apparatus and a light illuminating method of performing illumination of light on a hologram recording medium.

2. Description of the Related Art

Japanese Unexamined Patent Application Publication No 2007-79438 discloses a hologram recording and reproducing scheme of performing data recording by forming a hologram. In the hologram recording and reproducing scheme, at the time of recording, a signal light that is subject to spatial light intensity modulation (intensity modulation) according to recorded data and a reference light provided with a predetermined light intensity pattern, which is defined in advance, are generated, and the signal light and the reference light are allowed to illuminate a hologram recording medium, so that the data recording is performed by forming the hologram on the recording medium.

In addition, at the time of reproducing, the reference light is allowed to illuminate the recording medium. In this manner, the same reference light as that of the time of recording (having the same intensity pattern as that of the time of recording) is allowed to illuminate the hologram that is formed in response to the illumination of the signal light and the reference light at the time of recording, so that a diffracting light according to the recorded signal light component may be obtained. In other words, a reproduced image (reproduced light) according to the recorded data may be obtained. The obtained reproduced light is detected, for example, by an image sensor such as a CCD (charge coupled device) sensor or a CMOS (complementary metal oxide semiconductor), so that reproducing of the recorded data may be performed.

In addition, as a well-known type of the hologram recording and reproducing scheme, there is a so-called coaxial type where the reference light and the signal light are disposed in the same optical axis so as to illuminate the hologram recording medium through a common objective lens.

FIGS. 32, 33A and 33B are diagrams illustrating the coaxial-type hologram recording and reproducing scheme. FIG. 32 diagrammatically illustrates a recording method, and FIGS. 33A and 33B diagrammatically illustrate a reproducing method.

In addition, in FIGS. 32, 33A, and 33B, a case where a reflection-type hologram recording medium 100 having a reflecting layer is illustrated.

First, as shown in FIGS. 32, 33A, and 33B, in a hologram recording and reproducing system, an SLM (spatial light modulator) 101 is provided in order to generate the signal light and the reference light at the time of recording and the reference light at the time of reproducing. The SLM 101 is configured to include an intensity modulator which performs light intensity modulation on the incident light in units of pixels. The intensity modulator may be constructed with, for example, a liquid crystal or the like.

As shown in FIG. 32, at the time of recording, the signal light allocated with an intensity pattern according to the recorded data and the reference light allocated with a predetermined intensity pattern that is defined in advance are generated by the intensity modulation of the SLM 101. In the coaxial type, as shown in the figure, the signal light and the reference light are disposed in the same optical axis, and the spatial light modulation is performed on the incident light. In this case, as shown in the figure, in general, the signal light is disposed at the inner side, and the reference light is disposed at the outer side.

The signal light and the reference light generated by the SLM 101 are allowed to illuminate hologram recording medium 100 through the objective lens 102. As a result, the hologram that represents the recorded data is formed on the hologram recording medium 100 by the interference fringe of the signal light and the reference light. In other words, due to the formation of the hologram, the data are recorded.

On the other hand, at the time of reproducing, as shown in FIG. 33A, the reference light is generated in the SLM 101 (at this time, the intensity pattern of the reference light is the same as that of the time of recording). Next, the reference light is allowed to illuminate the hologram recording medium 100 through the objective lens 102.

In this manner, as shown in FIG. 33B, in response to the illumination of the reference light on the hologram recording medium 100, the diffracting light according to the hologram formed on the hologram recording medium 100 is obtained, so that the reproduced image corresponding to the recorded data may be obtained. In this case, the reproduced image as a reflected light from the hologram recording medium 100 is guided into the image sensor 103 through the objective lens 100 as shown in the figure.

The image sensor 103 receives the guided reproduced image in units of pixels to obtain an electrical signal corresponding to the amount of the received light of each pixel, so that a detected image corresponding to the reproduced image is obtained. The image signal detected by the image sensor 103 becomes the read signal corresponding to the recorded data.

In addition, as understood from the description of FIGS. 32, 33A, and 33B, in the hologram recording and reproducing scheme, the recorded data are recorded and reproduced in units of signal light. In other words, in the hologram recording and reproducing scheme, one hologram (referred to as a hologram page), which is formed by one-time interference of the signal light and the reference light, is the minimum unit of recording and reproducing.

Herein, a technique of recording the data sequentially in units of the hologram page on the hologram recording medium 100 is considered.

In an optical disc system in the related art such as CD (compact disc) or DVD (digital versatile disc), the recording medium is configured to have a disc shape, and the recording of the data is performed by forming marks on the disc in rotation thereof. In this case, guiding grooves (tracks) are formed in a spiral shape or a concentric shape on the recording medium, and the marks are formed so that the positions of the beam spots are controlled to trace the tracks, so that the data are recorded at predetermined positions on the recording medium.

In the hologram recording and reproducing system, a technique is also considered to be employed where the tracks are formed in a spiral shape or a concentric shape on the disc-shaped hologram recording medium 100 and of forming the hologram pages in the tracks by sequentially forming the holograms on hologram recording medium 100 that are driven to rotate in response to the illumination of the signal light and the reference light.

In this manner, in the case where the method of forming the hologram page at the positions in the tracks is employed, the control of the recording and reproducing positions such as a tracking servo control for tracing the beam spot in the tracks or a control of access to a predetermined address is necessarily performed.

In the current state, in order to perform the control of the recording and reproducing positions, separated illumination of dedicated laser light is considered. In other words, a method is considered for allowing the laser light for recording and reproducing the hologram (laser light for illumination of the signal light and the reference light, that is, the recording/reproducing laser light) and the laser light for controlling the hologram recording and reproducing positions (position-control laser light) to separately illuminate.

In this manner, the hologram recording medium 100 corresponding to the method of allowing the position-control laser light to separately illuminate is actually configured to have a structure shown in FIG. 34.

As shown in FIG. 34, in the hologram recording medium 100, a recording layer 106, where the hologram is recorded, and an position control information recording layer, where address information or the like for position control by a convex-concave sectional structure of the substrate 110 are recorded, are separately formed.

More specifically, a cover layer 105, a recording layer 106, a reflecting layer 107, an intermediate layer 108, a reflecting layer 109, and a substrate 110 are formed in the hologram recording medium 100 in this order from the uppermost layer thereof. The reflecting layer 107 formed in a lower layer of the recording layer 106 is disposed so that, at the time of reproducing, the reference light as the recording/reproducing laser light is allowed to illuminate the reflecting layer 107 and so that, when the reproduced image is to be obtained according to the hologram recorded on the recording layer 106, the reproduced image, as the reflected light, is allowed to return to the apparatus side.

In addition, the tracks for guiding the hologram recording and reproducing positions in the recording layer 106 are formed in a spiral shape or a concentric shape on the substrate 110. For example, the tracks are formed by pit columns so as to record the information such as address information.

The reflecting layer 109 formed in an upper layer of the substrate 110 disposed so as to obtain the reflected light for the information recorded on the substrate 110. In addition, the intermediate layer 108 is constructed with, for example, an adhesive material such as a resin.

Herein, in the hologram recording medium 100 having the aforementioned sectional structure, in order to properly perform the position control based on the reflected light of the position-control laser light, the position-control laser light necessary reaches the reflecting layer 109, on which the convex-concave sectional shape is formed. In other words, for this point, the position-control laser light necessarily transmits the reflecting layer 107 that is formed in an upper layer of the reflecting layer 109.

On the other hand, the reflecting layer 107 necessarily reflects the recording/reproducing laser light so that the reproduced image, as a reflected light, according to the hologram recorded on the recording layer 106 is allowed to return to the apparatus side.

By taking into consideration this point, as the position-control laser light, a laser light having a wavelength different from that of the hologram recording/reproducing laser light is used. For example, a blue-violet laser light having a wavelength λ of about 405 nm is used as the hologram recording/reproducing laser light, and for example, a red laser light having a wavelength λ of about 650 nm is used as the position-control laser light.

In addition, a reflecting layer having wavelength selectivity that reflects the blue-violet laser light for recording and reproducing and transmits the red laser light for position control is used as the reflecting layer 107 that is formed between the recording layer 106 and the reflecting layer 109, where the position control information is recorded.

According to the configuration, at the time of recording or reproducing, the position-control laser light reaches the reflecting layer 109, so that the reflected light information for position control may be properly detected at the apparatus side and so that the reproduced image of the hologram recorded on the recording layer 106 may be properly detected at the apparatus side.

FIG. 35 is a diagram illustrating a schematic configuration (mainly with respect to only the optic system) of the recording and reproducing apparatus in the case of the related art where the recording and reproducing are performed in correspondence to the hologram recording medium 100 having the aforementioned structure.

First, the recording and reproducing apparatus is provided with, as an optic system for illumination of a signal light and a reference light for the hologram recording and reproducing, a first laser 1, a collimation lens 2, a polarized beam splitter 3, an SLM 4, a polarized beam splitter 5, a relay lens 6, an aperture 104, a relay lens 7, a dichroic mirror 8, a partial diffraction device 9, a ¼ wavelength plate 10, an objective lens 102, and an image sensor 103.

The first laser 1 emits the hologram recording/reproducing laser light, for example, the aforementioned blue-violet laser light having a wavelength λ of about 405 nm. The laser light emitted from the first laser 1 is incident to the polarized beam splitter 3 through the collimation lens 2.

The polarized beam splitter 3 transmits the one linearly polarized component of linearly polarized components perpendicular to the incident laser light and reflects the other linearly polarized component. For example, in this case, the polarized beam splitter 3 is configured to transmit the p polarization component and to reflect the s polarization component.

Therefore, only the s polarization component of the laser light incident to the polarized beam splitter 3 is reflected and guided into the SLM 4.

The SLM 4 is configured to include, for example, a reflection-type liquid crystal device such as FLC (ferroelectric liquid crystal) so that the polarization direction of the incident light is controlled in units of pixels.

The SLM 4 performs the spatial light modulation according to the driving signal from the modulation controller 20 in the figure so that the polarization direction of the incident light at each pixel is changed by 90° or so that the polarization direction of the incident light is not changed. More specifically, the polarization direction control is performed in units of pixels according to the driving signal so that the change in angle of the polarization direction of the pixel is 90° according to the diving signal of ON and so that the change in angle of the polarization direction of the pixel is 0° according to the diving signal of OFF.

As shown in the figure, the light emitted from the SLM (the light reflected on the SLM 4) is incident again to the polarized beam splitter 3.

Herein, in the recording and reproducing apparatus shown in FIG. 35, by controlling the polarization direction in units of pixels by the SLM 4 and by using the selective transmission/reflection property of the polarized beam splitter 3 according to the polarization direction of the incident light, the spatial light intensity modulation (referred to as a light intensity modulation or simply an intensity modulation) is performed in units of pixels.

FIGS. 36A and 36B illustrate images of intensity modulation that is implemented by combining the SLM 4 and the polarized beam splitter 3. FIG. 36A diagrammatically illustrates a state of the light rays for the light of the ON pixel, and FIG. 36B diagrammatically illustrates a state of the light rays for the light of the OFF pixel.

As described above, since the polarized beam splitter 3 transmits the p polarization and reflects the s polarization, the s polarization is incident to the SLM 4.

According the aforementioned conditions, the light of the pixel (the light of the pixel corresponding to the driving signal ON), of which polarization direction is changed by 90° in the SLM 4, is incident as the p polarization to the polarized beam splitter 3. Therefore, in the SLM 4, the light of the ON pixel is allowed to transmit the polarized beam splitter 3 so as to be guided into the side of the hologram recording medium 100 (refer to FIG. 36A).

On the other hand, the light of the pixel, of which polarization direction is not changed due to the driving signal OFF, is incident as the s polarization to the polarized beam splitter 3. In other words, in the SLM 4, the light of the OFF pixel is allowed to be reflected on the polarized beam splitter 3 so as not to be guided into the side of the hologram recording medium 100 (refer to FIG. 36B).

In this manner, by combining the polarization direction-control-type SLM 4 and the polarized beam splitter 3, the intensity modulator that performs the light intensity modulation in units of pixels is configured. The intensity modulator generates the signal light and the reference light at the time of recording or the reference light at the time of reproducing.

The recording/reproducing laser light that is subject to the spatial light modulation by the intensity modulator is incident to the polarized beam splitter 5. The polarized beam splitter 5 is also configured to transmit the p polarization and to reflect the s polarization, so that the laser light emitted from the intensity modulator (the light transmitting the polarized beam splitter 3) is allowed to transmit the polarized beam splitter 5.

The laser light that transmits the polarized beam splitter 5 is incident to the relay lens system where a relay lens 6, an aperture 104, and a relay lens 7 are disposed in this order. As shown in the figure, due to the relay lens 6, the light flux of the laser light that transmits the polarized beam splitter 5 is condensed at a predetermined focus position, and due to the relay lens 7, the light flux of the laser light as the spreading light after the condensation is converted into a parallel light. The aperture 104 is disposed to the focus position (Fourier plane, frequency plane) due to the relay lens 6 to transmit only the light within a predetermined range from the optical axis as a center thereof and to block the other light.

Due to the aperture 104, the size of the hologram page recorded on the hologram recording medium 100 is limited, so that the hologram recording density (that is, data recording density) is improved. In addition, as described later, at the time of reproducing, although the reproduced image from the hologram recording medium 100 is guided into the image sensor 103 through the relay lens system, at the time, due to the aperture 104, most of the scattered light component together with the reproduced image emitted from the hologram recording medium 100 is blocked, so that an amount of the scattered light that is guided into the image sensor 103 is greatly reduced. In other words, the aperture 104 has a function for improving the hologram recording density at the time of recording and another function for improving the SN ratio (S/N) due to the suppression of the scattered light at the time of reproducing.

The laser light that passes through the relay lens system is incident to the dichroic mirror 8. The dichroic mirror 8 is configured to selectively reflect the light in a predetermined wavelength band. More specifically, in this case, the dichroic mirror 8 is configured to selectively reflect the light in the wavelength band of the recording/reproducing laser light having a wavelength λ of about 405 nm.

Therefore, the recording/reproducing laser light that is incident through the relay lens system is reflected on the dichroic mirror 8.

The recording/reproducing laser light that is reflected on the dichroic mirror 8 is incident to the objective lens 102 through the partial diffraction device 9→the ¼ wavelength plate 10.

The partial diffraction device 9 and the ¼ wavelength plate 10 are disposed in order to prevent the reference light (reflected reference light) reflected from the hologram recording medium 100 at the time of reproducing from being guided into the image sensor 103 and from being noise with respect to the reproduced light. In addition, the function for suppressing reflected reference light by the partial diffraction device 9 and the ¼ wavelength plate 10 is described later.

The objective lens 102 is movably supported in the focus direction and the tracking direction by the two-axis mechanism 12 as shown in the figure. The later-described position controller 19 controls the driving operation of the objective lens 102 by the two-axis mechanism 12, so that the control of the spot position of the laser light is performed.

The recording/reproducing laser light is allowed to illuminate the hologram recording medium 100 so as to be condensed by the objective lens 102.

Herein, as described above, at the time of recording, the signal light and the reference light are generated through the intensity modulation of the intensity modulator (the SLM 4 and the polarized beam splitter 3), and the signal light and the reference light are allowed to illuminate hologram recording medium 100 through the aforementioned path. Therefore, the hologram that represents the recorded data, as an interference fringe of the signal light and the reference light, is formed on the recording layer 106, so that the data recording is implemented.

In addition, at the time of reproducing, only the reference light is generated by the intensity modulator and allowed to illuminate hologram recording medium 100 through the aforementioned path. Due to the illumination of the reference light, the reproduced image corresponding to the hologram formed on the recording layer 106 is obtained as the reflected light from the reflecting layer 107. The reproduced image is allowed to return to the apparatus side through the objective lens 102.

Herein the reference light (forward-path reference light) that is allowed to illuminate the hologram recording medium 100 at the time of reproducing is incident as the p polarization to the partial diffraction device 9 due to the aforementioned operation of the intensity modulator. As described later, since the partial diffraction device 9 is configured to transmit all the forward-path light, the forward-path light as the p polarization is allowed to pass through the ¼ wavelength plate 10. The forward-path reference light as the p polarization that passes through the ¼ wavelength plate 10 is converted into a circularly polarized light in a predetermined rotating direction to illuminate the hologram recording medium 100.

The reference light that is allowed to illuminate the hologram recording medium 100 is reflected on the reflecting layer 107 to be guided as the reflected reference light (backward-path reference light) into the objective lens 102. In this case, due to the reflection of the reflecting layer 107, since the rotating direction of the circular polarization of the backward-path reference light is changed into a rotating direction opposite to the predetermined rotating direction, the backward-path reference light is converted into the s polarization through the ¼ wavelength plate 10.

Herein, the function for suppressing the reflected reference light by the partial diffraction device 9 and the ¼ wavelength plate 10 after the aforementioned transition of the polarization state is described.

The partial diffraction device 9 is implemented by forming, for example, the polarization selecting device having selective diffraction characteristics (diffracting the one linearly polarized component and transmitting the other linearly polarized component) according to the polarization state of a linearly polarized light such as a liquid crystal diffraction device in the area (the area excluding the central portion) to which the reference light is incident. More specifically, in this case, the polarization selective diffraction device included in the partial diffraction device 9 is configured to transmit the p polarization and to diffract the s polarization. Therefore, the reference light in the forward path is allowed to transmit the partial diffraction device 9, so that only the reference light in the backward path is diffracted (suppressed) by the partial diffraction device 9.

As a result, the reflected reference light as the backward-path light is detected as the noise component with respect to the reproduced image, so that the problem of the decrease in the SN ratio is prevented.

In addition, as described for the better understanding, the area of the partial diffraction device 9 to which the signal light is incident (the area to which the reproduced image is incident) is constructed with, for example, a transparent material or to be a hole portion, so that both of the forward-path light and the backward-path light are transmitted. Therefore, the signal light at the time of recording and the reproduced image at the time of reproducing are allowed to transmit the partial diffraction device 9.

Herein, as understood from the description hereinbefore, in the hologram recording and reproducing system, although the reproduced image is obtained by allowing the reference light to illuminate the recorded hologram and by using a diffraction phenomenon, the diffraction efficiency is generally less than several % to 1%. Accordingly, the reference light as the reflected light that is allowed to return to the apparatus side has a very high intensity with respect to the reproduced image. In other words, the reference light as the reflected light becomes a noise component that may not be negligible in the detection of the reproduced image.

Therefore, by suppressing the reflected reference light through the aforementioned partial diffraction device 9 and the ¼ wavelength plate 10, the SN ratio may be greatly improved.

As described above, the reproduced image obtained at the time of reproducing is allowed to transmit the partial diffraction device 9. After the reproduced image transmitting the partial diffraction device 9 is reflected on the dichroic mirror 8, the reproduced image is incident to the polarized beam splitter 5 through the aforementioned relay lens system (the relay lens 7→the aperture 104→the relay lens 6). As understood from the description hereinbefore, since the reflected light from the hologram recording medium 100 is converted into the s polarization through the ¼ wavelength plate 10, the reproduced image incident to the polarized beam splitter 5 is reflected on the polarized beam splitter 5, so that the reproduced image is incident to the image sensor 103.

In this manner, at the time of reproducing, the reproduced image from the hologram recording medium 100 is detected by the image sensor 103, so that the data reproducing is performed by the data reproducing unit 21 in the figure.

In addition, in the recording and reproducing apparatus shown in FIG. 35, an optic system for performing the illumination of the position-control laser light and the detection of the reflected light of the position-control laser light is also provided. More specifically, as shown in the figure, the optic system includes a second laser 14, a collimation lens 15, a polarized beam splitter 16, a condensing lens 17, and a photodetector (PD) 18.

The second laser 14 outputs the aforementioned red laser light having a wavelength λ of about 650 nm as the position-control laser light. The light emitted from the second laser 14 is incident to the dichroic mirror 8 through the collimation lens 15→the polarized beam splitter 16. Herein, the polarized beam splitter 16 is also configured to transmit the p polarization and to reflect the s polarization.

As described above, the dichroic mirror 8 is configured to selectively reflect the recording/reproducing laser light (having a wavelength of 405 nm in this case), so that the dichroic mirror 8 transmits the position-control laser light from the second laser 14.

Similarly to the recording/reproducing laser light, the position-control laser light that transmits the dichroic mirror 8 is allowed to illuminate the hologram recording medium 100 through the partial diffraction device 9→the ¼ wavelength plate 10→the objective lens 102.

In addition, as described for the better understanding, due to the installation of the dichroic mirror 8, the position-control laser light and the recording/reproducing laser light are combined in the same optical axis, and the combined light is allowed to illuminate the hologram recording medium 100 through the common objective lens 102. In other words, therefore, the beam spot of the position-control laser light and the beam spot of the recording/reproducing laser light are formed at the same position in the inner direction of the recording surface, so that the hologram recording and reproducing positions are controlled to be located in the track by the later-described position control operation based on the position-control laser light.

In addition, with respect to the focus direction, the focus position of the position-control laser light is controlled to be located on the reflecting layer 109 in the hologram recording medium 100 by the later-described position control operation (focus servo control) (refer to FIG. 34).

In this case, in the recording and reproducing apparatus, the focus position of the position-control laser light and the focus position of the recording/reproducing laser light are adjusted so as to be separated from each other by a predetermined separation distance. More specifically, in this case, since the recording/reproducing laser light is condensed on the reflecting layer 107 under the recording layer 106, the focus position of the recording/reproducing laser light is adjusted to be located before the focus position of the position-control laser light by the distance from the surface of the reflecting layer 109 to the surface of the reflecting layer 107 (refer to FIG. 34).

Therefore, due to the focus servo operation of allowing the focus position of the position-control laser light to be on the reflecting layer 109, the focus position of the recording/reproducing laser light is automatically allowed to be on the reflecting layer 107.

In FIG. 35, in response to the illumination of the position-control laser light on the hologram recording medium 100, the reflected light corresponding to the recorded information of the reflecting layer 110 may be obtained. The reflected light is incident to the polarized beam splitter 16 through the objective lens 102→the ¼ wavelength plate 10→the partial diffraction device 9→the dichroic mirror 8. The polarized beam splitter 16 reflects the reflected light of the position-control laser light that is incident through the dichroic mirror 8 (the position-control laser light reflected on the hologram recording medium 100 is also converted into the s polarization by the function of the ¼ wavelength plate 10). The reflected light of the position-control laser light reflected by the polarized beam splitter 16 is allowed to illuminate so as to be condensed on the detecting surface of the photodetector 18 through the condensing lens 17.

The photodetector 18 receives the reflected light of the illuminated position-control laser light, converts the reflected light into an electrical signal and supplies the electrical signal to the position controller 19.

The position controller 19 is configured to include a matrix circuit, which performs matrix calculation to generate a reproducing signal (RF signal) for pit columns formed on the reflecting layer 109 or various types of signals necessary for the position control such as a tracking error signal and a focus error signal, a calculation circuit for performing servo signal generation or the like, and a driving controller for controlling the driving of necessary elements such as two-axis mechanism 12.

Although not shown, the recording and reproducing apparatus is provided with an address detection circuit and a clock generation circuit that detect address information or generate a clock based on the reproduced signal. In addition, for example, a slide driver which movably supports the hologram recording medium 100 in the tracking direction (radial direction) is provided.

The position controller 19 controls the two-axis mechanism 12 or the slide driver based on the address information or the tracking error signal, so that the position control of the beam spot of the position-control laser light is performed. By the position control of the beam spot, the position of the beam spot of the recording/reproducing laser light may be moved to a necessary address or be allowed to trace the position along the track (tracking servo control). In other words, therefore, the control of the hologram recording and reproducing positions is performed.

In addition, the position controller 19 also performs the focus servo control for allowing the focus position of the position-control laser light to track on the reflecting layer 109 by controlling the operation of driving the objective lens 102 in the focus direction by the two-axis mechanism 12 based on the focus error signal. As described above, by performing the focus servo control on the position-control laser light, the focus position of the recording/reproducing laser light is allowed to trace the reflecting layer 107.

Herein, in the aforementioned hologram recording and reproducing system employing the coaxial type, a resistance to the inclination (tilt) of the recording medium is low, and the tolerance is very narrow in comparison with, for example, a recording reproducing system corresponding to a current high density optical disc such as BD (Blu-ray Disc, a registered trade mark). Therefore, in the coaxial-type hologram recording and reproducing system, the improvement of the tilt tolerance is one of the most important problems in the implementation of practical system.

In general, in the optical disc system, the deterioration of the reproduced signal caused by the tilt is greatly influenced by the coma aberration. In the hologram recording and reproducing system, the occurrence of the coma aberration caused by the tilt greatly influences the determination of the reproduced signal.

Herein, as described above, the fact that the tilt tolerance of the coaxial-type hologram recording and reproducing system is narrow in comparison with the current optical disc system such as the BD is originated from the large difference in the principle of recording and reproducing.

First, the occurrence of the coma aberration caused by the tilt is described with reference to FIGS. 37A and 37B. FIGS. 37A and 37B are diagrams illustrating the occurrence of the coma aberration caused by the tilt. In each of FIGS. 37A and 37B, the cover layer 105, the recording layer 106, and the reflecting layer 107 of the hologram recording medium 100 are extracted and illustrated. FIG. 37A illustrates the behavior of the light rays (light flux) of the recording/reproducing laser light that is incident to the hologram recording medium 100 in the case where there is no tilt. FIG. 37B illustrates the behavior of the light rays of the recording/reproducing laser light that is incident to the hologram recording medium 100 at the time of occurrence of the tilt.

First, as understood with reference to FIG. 37A, with respect to the laser light that is allowed to illuminate the hologram recording medium 100 through the objective lens 102, the angle thereof at the time of incidence to the medium is changed according to the refractive index of the hologram recording medium 100 except for the central light. In the recording and reproducing apparatus, by taking into consideration the change in the angle at the time of incidence to the medium, the recording/reproducing laser light is configured to be focused on the reflecting layer 107, so that the adjustment of the optic system, the adjustment of the separation distance between the objective lens 102 and the installation position of the medium, or the like is performed.

As shown in FIG. 37A, in the case where there is no tilt, the sectional shape of the light flux of the laser light has left-right symmetry with respect to the optical axis as the center thereof. This state is set to the state where there is no phase difference.

On the other hand, in the case where a tilt occurs from the state of FIG. 37A, as shown in FIG. 37B, the shape of the light ray is changed. In other words, in the case where the tilt occurs, since the sectional shape of the light flux has no left-right symmetry, the light is not condensed at one point unlike the case of FIG. 37A. As a result, the coma aberration occurs.

Due to the occurrence of the coma aberration (tilt), the phase difference of light occurs. In other words, with respect to the light of the outermost circumferential portions (two positions) and the central light among the recording/reproduced light in the figure, three light rays are illustrated. In the case where the tilt occurs, since the optical axis of the laser light is relatively inclined with respect to the recording medium, the angle of the central light at the time of incidence is also changed as shown in the figure. In addition, due to the occurrence of the tilt, the light of the outermost circumferential portions proceeds into the medium at an angle different from that of the case of FIG. 37A. As a result, a phase difference occurs in each light in comparison with the case of FIG. 37A.

FIG. 38 is a diagram for comparing the reproduced wave fronts at the time of occurrence of the coma aberration. (a), (b), and (c) of FIG. 38 illustrate the reproduced wave fronts in the case of the recording reproducing system for the BD, and (d), (e), and (f) of FIG. 38 illustrate the reproduced wave fronts in the case of the hologram recording and reproducing system.

(a) and (d) of FIG. 38 illustrate the reproduced wave fronts in the central portion of the main light ray at the time of occurrence of the coma aberration caused by the tilt.

(b) and (e) of FIG. 38 illustrate the reproduced wave fronts as the spot of the laser light at the time of occurrence of the coma aberration is seen from the position where the RMS (root mean square) value is minimized, that is, the position where the light intensity is strongest.

In addition, (c) and (f) of FIG. 38 illustrate the reproduced wave fronts at the so-called Marechal criterion where the RMS value is 0.07λ.

In addition, in each figure, the reproduced wave front is illustrated by a solid line, and the wave front (reference wave front) where the phase difference is zero is illustrated by a dotted line.

Herein, as shown in the figure, the distance t from the surface of the recording medium to the focus position (that is, the distance from the surface of the recording medium to the reflecting plane) is t=0.1 mm in the case of the BD system. However, in the case of the hologram system, t=0.7 mm.

In addition, the difference in the value of t is caused by the difference in structure of the recording mediums. In the simulations of FIG. 38, the thickness of the cover layer is set to the same value, that is, 0.1 mm in both of the case of the BD and the case of the hologram. In the case of the BD, since the medium has a structure of the cover layer→the reflecting layer (information recording layer), the value of t is equal to the thickness of the cover layer, that is, 0.1 mm. However in the case of the hologram system, the medium has a structure of the cover layer→the recording layer→the reflecting layer. Herein, since the thickness of the recording layer is set to 0.6 mm, if the same thickness of the cover layer, that is, 0.1 mm is used, the value of t is 0.7 mm.

In addition, the numerical aperture NA of the objective lens and the refractive index n of the recording medium is set to the same values in both of the case of the BD and the case of the hologram as follows:

NA=0.85

(Refractive Index n of Recording Medium)=1.55

First, the case of the BD is described.

As shown in (a) of FIG. 38, in the case of BD, when TILT=1.14°, the reproduced wave front of the central portion of the main light ray has a phase difference of +λ to −λ with respect to the reference wave front.

When TILT=1.14°, the reproduced wave front as the spot of the laser light is seen from the position where the light intensity is maximized is illustrated in (b) of FIG. 38, and at this time, the reproduced wave front has a phase difference of +0.33λ to −0.33λ with respect to the reference wave front. At this time, the RMS value is 0.118λ as shown in the figure.

In addition, in the case of the BD, the tilt angle TILT at the Marechal criterion (RMS=0.07λ, which corresponds to the light intensity of about 80% of the non-aberration light intensity) becomes 0.68° as shown in (c) of FIG. 38. At this time, the reproduced wave front has a phase difference of +0.20λ to −0.20 as shown in the figure.

(d) of FIG. 38 illustrates the reproduced wave front when TILT=0.16°, as the reproduced wave front in the case of the hologram system.

First, in the case of the hologram system, it should be noted that there is a plurality of the reproduced wave fronts in the case of the hologram system as shown in the figure.

Herein, in the hologram recording and reproducing, the reference light is constructed with the light from a plurality of pixels in the SLM 101. In other words, the light from a plurality of the pixels is allowed to illuminate the hologram recording medium 100 through the objective lens 102. The hologram is formed by interference of one signal light, which is constructed with similar light of a plurality of the pixels, to the reference light and the light of a plurality of the pixels.

As understood therefrom, at the time of reproducing, the recorded signal light of each pixel is reproduced by each light of a plurality of the pixels of the reference light. In other words, in the hologram recording and reproducing system, as the reproduced wave fronts, there are the wave fronts corresponding to a plurality of the reproduced images that are reproduced from a plurality of the reference light.

In the case where there is no tilt and there is no phase difference in the reference light caused by the coma aberration, a plurality of the reproduced wave fronts is coincident with each other. However, in the case where the coma aberration caused by the tilt occurs and the phase difference occurs in the reference light, since there is a plurality of the wave fronts reproduced from a plurality of the light having different phases, the reproduced wave fronts are not coincident with each other.

In this case, if there is a plurality of the reproduced images having different phases, the light intensities cancel out each other, so that the intensity of the reproduced image is greatly decreased. In other words, in this point, in the case of the hologram recording and reproducing system, the light intensity at the time of occurrence of the coma aberration caused by the tilt is greatly decreased, so that the tilt tolerance is greatly narrowed.

The description returns.

As shown in (d) of FIG. 38, in the hologram system, when TILT=0.16°, the reproduced wave front has a phase difference of +/−λ (1.0λ) with respect to the reference wave front. As shown in (a) of FIG. 38, in the case of BD, when TILT=1.14°, the reproduced wave front has the same phase difference of +/−λ, which is caused from that fact that t=0.1 mm in the case of the BD and t=0.7 mm in the case of the hologram system.

(e) of FIG. 38 illustrates the case as seen from the position where the RMS value is minimized. In the case of the hologram system, as seen from the position where the RMS value is minimized, the reproduced wave front has a phase difference of +/−λ. In this case, RMS=0.707λ, which is much larger than the case of the BD having the same condition (refer to (b) of FIG. 38).

(f) of FIG. 38 illustrates the reproduced wave front at the Marechal criterion. In the case of the hologram system, since the intensities caused by the aforementioned phase difference of the reference light at the time of reproducing are cancelled from each other, the tilt angle TILT at the Marechal criterion is smaller than that of the case of the BD. In the case of the hologram system, the tilt angel at the Marechal criterion is TILT=+/−0.016°, which is decreased by about 1/42 in comparison with the case of the BD. In addition, In this case, reproduced wave front has a phase difference of +/−0.1λ.

As understood from the description hereinbefore, in the case where the coaxial-type is particularly employed as the hologram recording and reproducing scheme, according to the principle of the recording and reproducing, the deterioration in the reproduced signal due to the occurrence of the coma aberration caused by the tilt (the occurrence of the phase difference of the reference light) is much greater than the case of the current optical disc system.

### SUMMARY OF THE INVENTION

It is desirable to provide a coaxial-type hologram recording and reproducing system capable of improving tilt tolerance suitable for implementing a practical system.

According to an embodiment of the present invention, there is provided a light illuminating apparatus having the following configuration.

In other words, the light illuminating apparatus according to the invention includes a light source that allows light to illuminate a hologram recording medium having a recording layer, where information is recorded by an interference fringe of a signal light and a reference light on an upper layer side thereof.

In addition, the light illuminating apparatus includes a spatial light modulator that performs spatial light modulation on the light from the light source to generate the signal light and/or the reference light.

In addition, the light illuminating apparatus includes a light illuminating unit that allows the light, which is subject to the spatial light modulation by the spatial light modulator, as a recording/reproduced light to illuminate the hologram recording medium through an objective lens.

In addition, a focus position of the recording/reproduced light is set so that a distance from a surface of the hologram recording medium to the focus position of the recording/reproduced light is smaller than a distance from the surface to a lower layer side surface of the recording layer.

Herein, if a numerical aperture of the objective lens is denoted by NA, and if a distance from the surface of the hologram recording medium to the focus position of the recording/reproduced light is denoted by t, the occurrence amount W of the coma aberration is expressed by W∝NA³·t.

In other words, the occurrence amount W of the coma aberration may be suppressed by allowing the NA of the objective lens to be small or by allowing the distance t from the surface to the focus position to be small. Herein, as described above with reference to FIG. 34, in the case in the related art, the focus position of the recording/reproduced light is set to the lower layer side surface of the recording layer (the upper layer side surface of the reflecting layer 107, that is, the reflecting plane thereof). In other words, the value of “t” is a distance from the surface of the recording medium to the lower layer side surface of the recording layer, so that the value of “t”, which includes the thickness of the cover layer and the thickness of the recording layer, becomes a relatively large value. In addition, in this point, in the hologram recording and reproducing system in the related art, the occurrence amount W of coma aberration caused by the tilt also tends to be relatively large.

However, according to the invention, the value of “t” is smaller than the distance from the surface of the recording medium to the lower layer side surface of the recording layer. Therefore, the occurrence amount W of coma aberration caused by the tilt may be greatly suppressed in comparison with the case in the related art. Due to the suppression of the coma aberration caused by the tilt, a tilt margin may be extended.

According to the invention, since the focus position of the recording/reproduced light is set to a position near the surface of the recording medium unlike the case in the related art where the focus position is set to the lower layer side surface of the recording layer (reflecting plane of the reflecting layer), the occurrence amount of coma aberration caused by the tilt may be further suppressed in comparison with the case in the related art, so that the tilt tolerance may be improved.

In addition, according to the invention, since a method of setting the NA of the objective lens to be small so as to suppress the occurrence amount of coma aberration is not employed, the tilt tolerance may be improved without a decrease in the information recording/reproducing density.

### BRIEF DESCRIPTION OF THE DRAWINGS

FIG. 1 is a diagram illustrating a configuration of a light illuminating apparatus according to a first embodiment.

FIG. 2 is a sectional view illustrating an example of a structure of a hologram recording medium that is an object of recording and reproducing of the light illuminating apparatus according to the first embodiment.

FIG. 3 is a sectional view illustrating another example of the structure of the hologram recording medium that is an object of recording and reproducing of the light illuminating apparatus according to the first embodiment.

FIG. 4 is a diagram illustrating each area of a reference light area, a signal light area, and a gap area set by a spatial light modulator.

FIG. 5 is a diagram illustrating a focus position of a recording/reproduced light set according to the embodiment.

FIG. 6 is a diagram illustrating an example of a focus position in the case of using the hologram recording medium having the structure shown in FIG. 3.

FIG. 7 is a diagram illustrating a result of a simulation performed on a relationship among NA of an objective lens, a setting value of distance t, and a reproduction tilt tolerance.

FIGS. 8A and 8B are diagrams illustrating an example of setting of a separation distance between an objective lens and a hologram recording medium in a case where a focus position of the recording/reproduced light is changed.

FIG. 9 is a diagram illustrating a shape of a hologram formed on the hologram recording medium by a recording reproducing system in the related art.

FIG. 10 is a diagram illustrating the behavior of light rays of a signal light and a reference light illuminated on the hologram recording medium and a light ray of a backward-path light in the embodiment.

FIG. 11 is a diagram illustrating a shape of a hologram formed on the hologram recording medium in the embodiment.

FIG. 12 is a diagram illustrating the behavior in which a recorded hologram is reproduced in the embodiment.

FIG. 13 is a diagram illustrating the behavior of light in the entire optic system in the related art.

FIG. 14 is a diagram illustrating the behavior of light in the entire optic system with respect to a forward-path light at the time of recording in the embodiment.

FIG. 15 is a diagram illustrating the behavior of light in the entire optic system with respect to a backward-path light at the time of reproducing in the embodiment.

FIG. 16 is a diagram illustrating a reason that positions of the forward-path light and the backward-path light on the real image plane are coincident with each other in the embodiment.

FIG. 17 is a diagram illustrating a result of a simulation with respect to items of tilt tolerance, diffraction efficiency, and SNR (SN ratio).

FIG. 18 is a diagram illustrating an internal configuration of a light illuminating apparatus according to a second embodiment.

FIGS. 19A and 19B are diagrams illustrating driving states of an aperture included in the light illuminating apparatus according to the second embodiment at the time of recording/reproducing.

FIG. 20 is a diagram illustrating an example of a structure of a partial diffraction device included in the light illuminating apparatus according to the second embodiment at the time of recording/reproducing.

FIG. 21 is a diagram illustrating a backward-path conjugating plane.

FIGS. 22A and 22B are diagrams illustrating the occurrence behavior of a scattered light from a hologram recording medium.

FIG. 23 is a diagram illustrating a detailed example of a method of extending a minimum modulation unit of a reference light according to a third embodiment.

FIG. 24 is a diagram illustrating another example the method of extending the minimum modulation unit of the reference light.

FIGS. 25A and 25B are diagrams illustrating the behavior of light in the entire optic system in the case of extending the minimum modulation unit of the reference light.

FIG. 26 is a diagram illustrating the behavior of light rays of a signal light and a reference light illuminated on the hologram recording medium in the third embodiment.

FIG. 27 is a diagram illustrating a hologram formed in response to illumination of the signal light and the reference light in the third embodiment.

FIGS. 28A and 28B are diagrams illustrating the behavior of light rays from a real image plane through an objective lens pupil plane to a focus plane in the cases of changing a pixel size of an SLM.

FIG. 29 is a diagram illustrating an example of shifting a focus position for suppressing a decrease in SNR caused by DC concentration.

FIG. 30 is a diagram illustrating results of simulation on diffraction efficiency and SNR in the case where there is no tilt and in the case where there is a tilt) (TILT=+/−0.112°) in the third embodiment.

FIGS. 31A and 31B are diagrams illustrating a modified example of the third embodiment.

FIG. 32 is a diagram illustrating a method of recording a hologram according to a coaxial type.

FIGS. 33A and 33B are diagrams illustrating a method of reproducing a hologram according to the coaxial type.

FIG. 34 is a sectional view illustrating an example of a structure of a hologram recording medium.

FIG. 35 is a diagram illustrating an internal configuration of a recording and reproducing apparatus in the related art.

FIGS. 36A and 36B are diagrams illustrating intensity modulation implemented by combining a polarization-direction-control-type spatial light modulator and a polarized beam splitter.

FIGS. 37A and 37B are diagrams illustrating occurrence of a coma aberration caused by tilt.

FIG. 38 is a diagram illustrating comparisons of reproduced wave fronts in the case of BD and in the case of a hologram system.

### DESCRIPTION OF THE PREFERRED EMBODIMENTS

Hereinafter, exemplary embodiments (hereinafter, referred to as embodiments) for implementing the invention are described. In addition, the description is made in the following order.

1. First Embodiment

1-1. Configuration of Hologram Recording and Reproducing system

1-2. Suppression of Coma Aberration Caused by Tilt

1-2-1. Detailed Method of Suppressing Coma Aberration

1-2-2. Detailed Method of Shifting Focus Position

1-2-3. Change in The behavior of Light Due to Shifting of Focus Position

1-3. Result of Simulation

1-4. Statistics

2. Second Embodiment

3. Third Embodiment

3-1. Extension of Minimum Modulation Unit of Reference Light

3-2. Shifting of Focus Position for Suppressing DC concentration

3-3. Result of Simulation

3-4. Modified Examples of Third Embodiment

4. Modified Example

### 1. First Embodiment

### 1-1. Configuration of Hologram Recording and Reproducing System

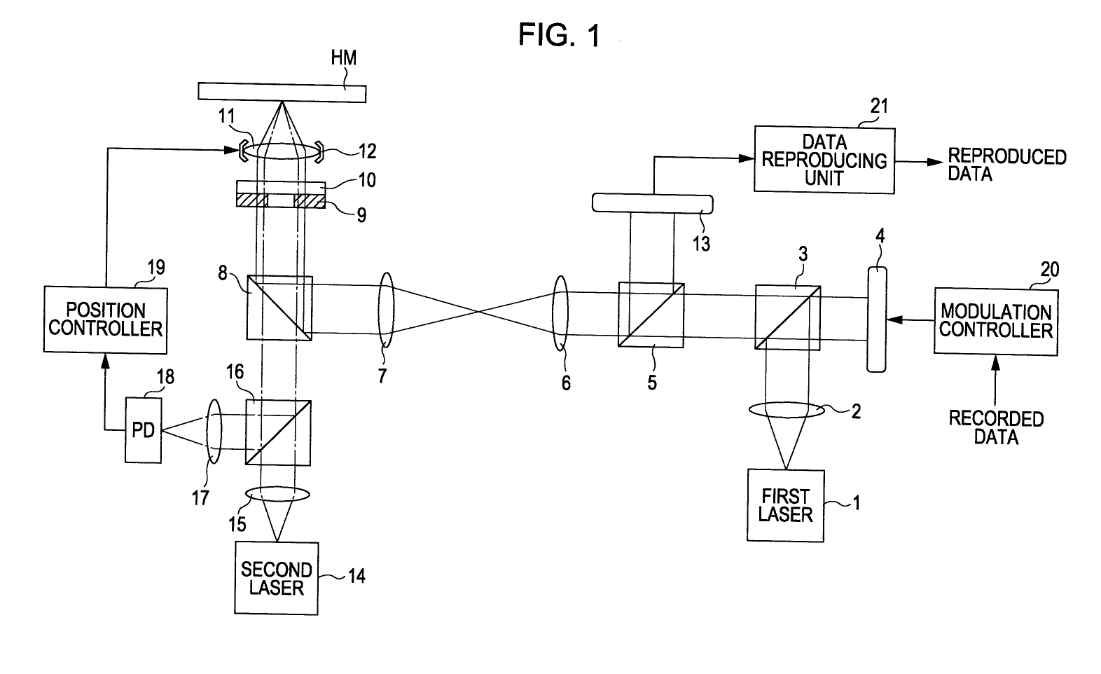

FIG. 1 is a diagram illustrating an internal configuration of a light illuminating apparatus according to a first embodiment of the invention. In the embodiment, a case is exemplified where a light illuminating apparatus according to the invention is used for a recording and reproducing apparatus for recording and reproducing a hologram. FIG. 1 illustrates a configuration of a main optic system of the recording and reproducing apparatus according to the embodiment.

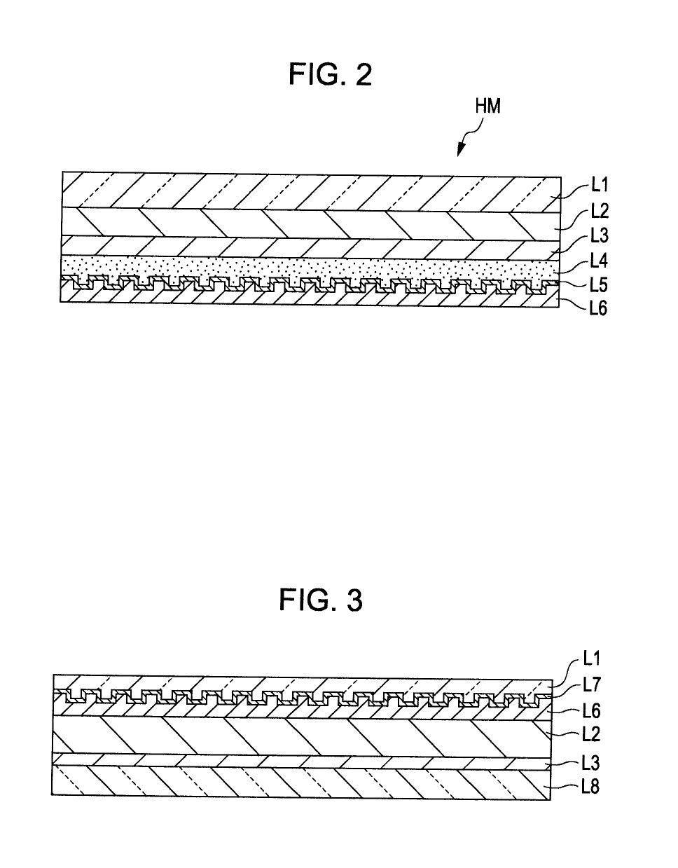

First, before the internal configuration of the recording and reproducing apparatus according to the embodiment is described, a structure of a hologram recording medium HM that is an object of the recording and reproducing of the recording and reproducing apparatus is described with reference to a sectional view of the structure shown in FIG. 2.

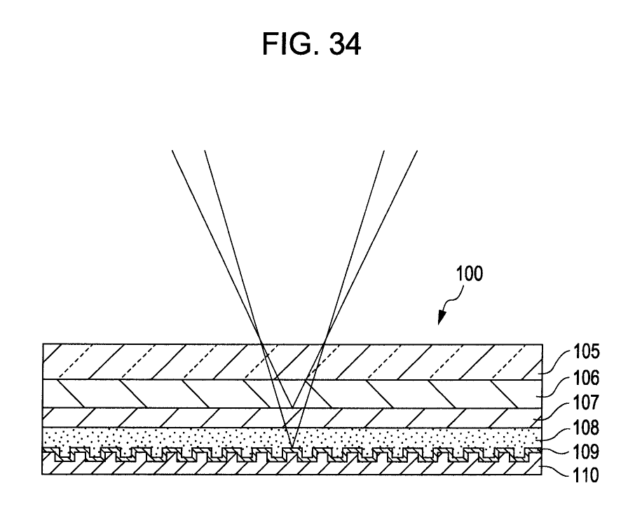

As understood from comparison of FIG. 2 with FIG. 34, the hologram recording medium HM used in the embodiment has the same sectional structure as the hologram recording medium 100 in the related art. In other words, a cover layer L1 of FIG. 2 is the same as the cover layer 105 of FIG. 34. A recording layer L2, a reflecting layer L3, an intermediate layer L4, a reflecting layer L5, and a substrate L6 are the same as the recording layer 106, the reflecting layer 107, the intermediate layer 108, the reflecting layer 109, and the substrate 110, respectively.

For the better understanding, these layers are described. First, these layers are laminated in this order from the upper layer to the lower layer, that is, in this order of the cover layer L1→the recording layer L2→the reflecting layer L3→the intermediate layer L4→the reflecting layer L5→the substrate L6. In addition, with respect to the aforementioned “upper layer” and “lower layer”, a layer corresponding to an upper surface, to which a light for recording/reproducing is incident, is the upper layer, and a layer corresponding to a lower surface, that is the surface opposite to the upper surface, is the lower layer.

In this case, the cover layer L1 is constructed with, for example, plastic, glass, or the like to be disposed so as to protect the recording layer L2 that is disposed to the underlying layer thereof. In addition, the recording layer L2 is constructed with, for example, a photopolymer, or the like, that is, a material capable of recording information by a change in refractive index according to a distribution of intensity of an illuminated light to record or reproduce a hologram by a recording/reproducing laser light described later. In addition, the reflecting layer L3 is disposed to return a reproduced image, which is obtained from the hologram recorded on the recording layer L2 according to the illumination of the reference light at the time of reproducing, as a reflected light to the apparatus side. Similarly to the reflecting layer 107 in FIG. 34, a material having wavelength selectivity is selected as the reflecting layer L3. In the embodiment described later, for example, a blue-violet laser having a wavelength λ of about 405 nm is allowed to illuminate as a laser light for hologram reproducing/reproducing, and a red laser light having a wavelength λ of about 650 nm is allowed to illuminate as a laser light for position controlling. Accordingly, a reflecting layer of reflecting the blue-violet laser light for recording/reproducing and of transmitting the red laser light for position controlling is used as the reflecting layer L3.

In addition, the substrate L6 and the reflecting layer L5 are disposed to control the position of recording/reproducing the hologram, and tracks for guiding the position of the reproducing/reproducing the hologram in the recording layer L2 are formed in a spiral shape or in a concentric shape on the substrate L6. For example, in this case, the tracks are also formed to perform information recording addresses, information, or the like by using bit columns. The reflecting layer L5 is formed, for example, by sputtering, vaporizing, or the like on the surface (front surface) of the substrate L6, on which the tracks are formed. As described for the better understanding, the reflecting layer L5 may be configured so as to reflect the position control light, but it does not necessarily have wavelength selectivity. The intermediate layer L4 formed between the reflecting layer L5 and the reflecting layer L3, is constructed with, for example, an adhesive material such as a resin.

Alternatively, a hologram recording medium having the following structure shown in FIG. 3 may also be used. In comparison with the hologram recording medium HM shown in FIG. 2, in the hologram recording medium shown in FIG. 3, a layer position of the position control information recording layer (track formation layer) is changed. More specifically, in the hologram recording medium shown in FIG. 3, a layer including the substrate L6, on which the tracks are formed, the reflecting layer L7 is inserted between the cover layer L1 and the recording layer L2. Similarly to the aforementioned reflecting layer L5, the reflecting layer L7 is formed on the track formation surface of the substrate L6. Due to the insertion of the substrate L6 and the reflecting layer L7, in the hologram recording medium shown in FIG. 3, the cover layer L1→the reflecting layer L7→the substrate L6→the recording layer L2→the reflecting layer L3 are formed in this order from the upper layer side. In this case, the substrate L8, which is constructed with, for example, plastic, glass, or the like, is formed on the underlying layer of the reflecting layer L3.

In the hologram recording medium shown in FIG. 3, the position control light is selectively reflected by the reflecting layer L7. Therefore, a layer having wavelength selectivity is used for the reflecting layer L7. More specifically, a wavelength selective reflecting layer is used for selectively reflecting only the light having the wavelength band of the position-control laser light. In addition, in this case, the reflecting layer L3 disposed on the underlying layer of the recording layer L2 does not necessarily have the wavelength selectivity, but it may be constructed with a normal reflecting layer.

The description is made with reference to FIG. 1 again. In the recording and reproducing apparatus according to the embodiment, the hologram recording medium HM is supported so as to be rotated by a spindle motor (not shown). In the recording and reproducing apparatus, the hologram recording/reproducing laser light and the position control laser light illuminate the hologram recording medium HM that is supported in this manner.

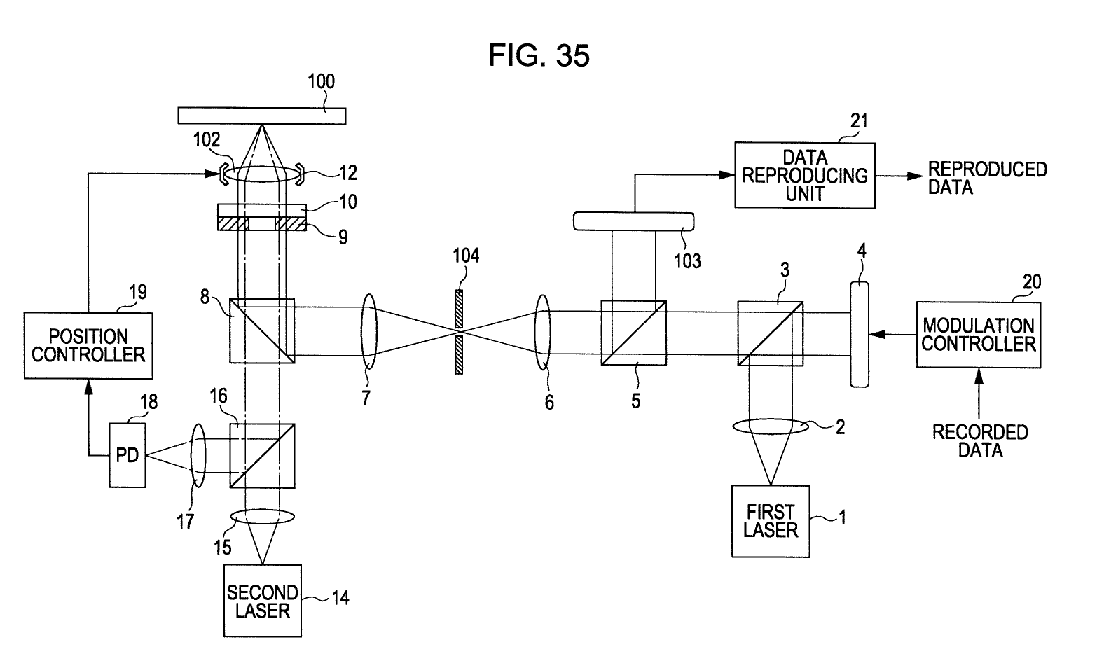

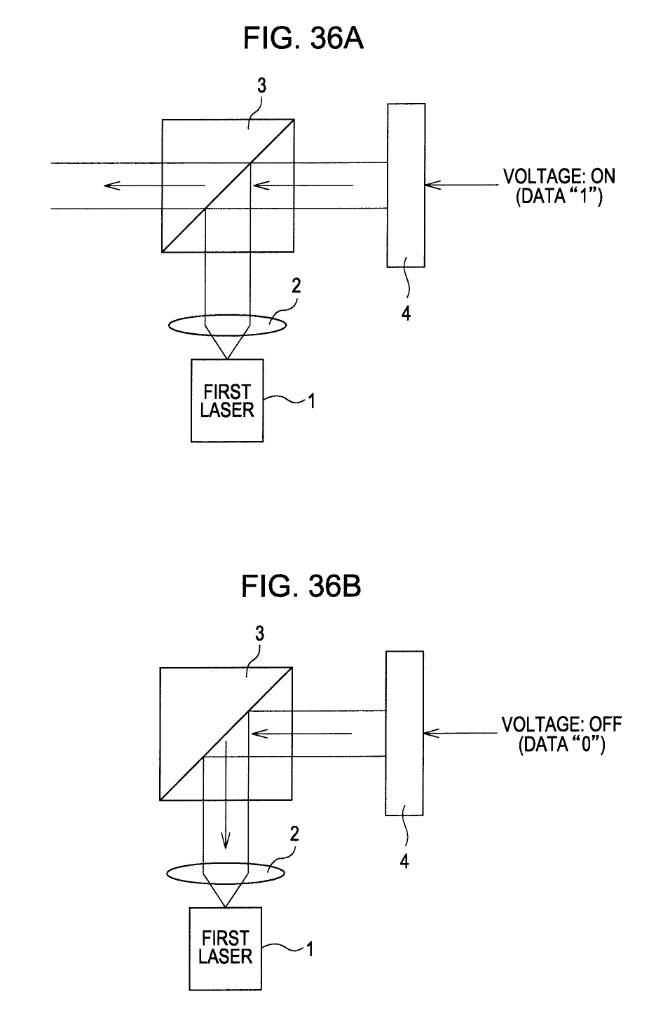

In FIG. 1, the same elements as those of the aforementioned recording and reproducing apparatus in FIG. 35 are denoted by the same reference numerals. As understood from the comparison with FIG. 35, the recording and reproducing apparatus according to the embodiment has substantially the same configuration as that of the recording and reproducing apparatus in the related art. Therefore, by the illumination of the recording/reproduced light from the first laser 1 as the light source, the recording and reproducing of the hologram are performed; and by the illumination of the position control light from the second laser 14 as the light source, the control (focus servo) of the hologram recording and reproducing positions is performed.

In the recording and reproducing apparatus according to the embodiment, a coaxial type is employed as the hologram recording and reproducing scheme. In other words, the signal light and the reference light are disposed in the same axes, and the signal light and the reference light illuminate the hologram recording medium, of which predetermined positions are set by the signal light and the reference light, to form the hologram, so that the recording of the data is performed. In addition, at the time of reproducing, the reference light is allowed to illuminate the hologram recording medium to obtain the hologram reproduced image (reproduced signal light), so that the reproducing of the recorded data is performed,

The recording and reproducing apparatus according to the embodiment is provided with, an optic system for illumination of a signal light and a reference light for the recording and reproducing of the hologram, a first laser 1, a collimation lens 2, a polarized beam splitter 3, an SLM 4, a polarized beam splitter 5, a relay lens 6, a relay lens 7, a dichroic mirror 8, a partial diffraction device 9, a ¼ wavelength plate 10, an objective lens 11, and an image sensor 13.

In this case, the first laser 1 outputs, as the hologram recording/reproducing laser light, for example, a blue-violet laser light having a wavelength λ of about 405 nm. The laser light emitted from the first laser 1 is incident though the collimation lens 2 to the polarized beam splitter 3.

In this case, an intensity modulator, which performs spatial light intensity modulation on the incident light by the polarized beam splitter 3 and the SLM 4, is provided. In this case, the polarized beam splitter is configured, for example, to transmit p polarization and to reflect s polarization. Therefore, only the s polarization component of the laser light incident to the polarized beam splitter 3 is reflected to be guided into the SLM 4. The SLM 4 is configured to include, for example, a reflective liquid crystal device such as an FLC (ferroelectric liquid crystal) so as to control a polarization direction of the incident light in units of pixels.

The SLM 4 changes the polarization direction of the incident light at each pixel by 90° according to the driving signal from the modulation controller 20 in the figure or performs the spatial light modulation so that the polarization direction of the incident light is not changed. More specifically, the polarization direction is controlled in units of pixels according to the driving signal so that the change in angle in the polarization direction is 90° at the pixel where the driving signal is set to ON and so that the change in angle in the polarization direction is 0° at the pixel where the driving signal is set to OFF.

The light emitted from the SLM 4 (the light reflected by the SLM 4) is incident again to the polarized beam splitter 3, so that the light (p polarization) through the ON pixel of the SLM 4 is allowed to transmit the polarized beam splitter 3 and so that the light (s polarization) through the OFF pixel is allowed to be reflected by the polarized beam splitter 3. As a result, the intensity modulator, which performs the spatial light intensity modulation (referred to simply “intensity modulation”) on the incident light in units of pixels of the SLM 4, is implemented.

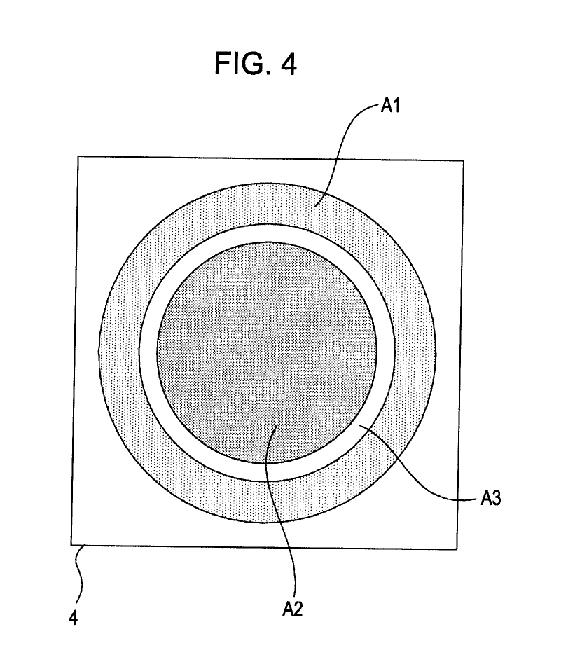

Herein, in the case where the coaxial type is employed, in the SLM 4, in order to dispose the signal light and the reference light in the same optical axis, the areas are set as follows in FIG. 4. As shown in FIG. 4, in SLM 4, the circular area having a predetermined range including a center thereof (coincident with the center of the optical axis) is set as a signal light area A2. Next, outside the signal light area A2, a ring-shaped reference light area A1 is set to be separated from the gap area A3. By the settings of the signal light area A2 and the reference light area A1, the illumination may be performed in the state where the signal light and the reference light are disposed in the same optical axis. In addition, the gap area A3 is set as an area for preventing the reference light generated in the reference light area A1 from leaking into the signal light area A2 and being noise with respect to the signal light. In addition, as described for the better understanding, since the pixel of the SLM 4 has a circular shape, strictly speaking, the signal light area A2 has a circular shape. Similarly to the reference light area A1, strictly speaking, the gap area A3 also has a ring shape. In this sense, the signal light area A2 becomes an area having a substantially circular shape, and the reference light area A1 and the gap area A3 become area having substantially ring shapes.

In FIG. 1, the modulation controller 20 controls driving of the SLM 4 to generate the signal light and the reference light at the time of recording and to generate only the reference light at the time of reproducing. More specifically, at the time of recording, the modulation controller 20 generates a driving signal which allows the pixels of the signal light area A2 of the SLM 4 to be set to an ON/OFF pattern according to the supplied recorded data, which allows the pixels of the reference light area A1 to be set to a predetermined ON/OFF pattern, and which allows other pixels to be set to OFF and supplies the driving signal to the SLM 4. The SLM 4 performs the spatial light modulation (polarization direction control) based on the driving signal, so that the signal light and the reference light that are disposed so as to have the same centers (optical axis) as the emitted light from the polarized beam splitter 3 may be obtained. In addition, at the time of reproducing, the modulation controller 20 controls the driving of the SLM 4 according to a driving signal which allows the pixels of the reference light area A1 to be set to the predetermined ON/OFF pattern and which allows other pixels to be set to OFF, so that only the reference light is generated.

In addition, at the time of recording, the modulation controller 20 is operated to generate the ON/OFF pattern in the signal light area A2 in a predetermined unit of the input recorded data sequence, so that the signal light containing the data in the predetermined unit of the recorded data sequence is sequentially generated. Therefore the recording of the data is performed in units of the hologram pages (in units of data recorded by one-time interference of the signal light and the reference light) on the hologram recording medium HM.

The laser light that is subject to the intensity modulation of the intensity modulator constructed with the polarized beam splitter 3 and the SLM 4 is incident to the polarized beam splitter 5. The polarized beam splitter 5 is also configured to transmit the p polarization and to reflect the s polarization. Therefore, the laser light is allowed to transmit the polarized beam splitter 5.

The laser light that transmits the polarized beam splitter 5 is incident to the relay lens system wherein the relay lens 6 and the relay lens 7 are disposed in this order. As shown in the figure, the light flux of the laser light transmitting the polarized beam splitter 5 are condensed to the predetermined focus position by the relay lens 6, and the light flux of the laser light at the spreading light after the condensation are converted so as to be parallel to each other by the relay lens 7.

The laser light through the relay lens system is incident to the dichroic mirror 8. The dichroic mirror 8 is configured to selectively reflect the light in the predetermined wavelength band. In this case, the dichroic mirror 8 is also configured to selectively reflect the light in the wavelength band of the recording/reproducing laser light having a wavelength λ of about 405 nm, so that the recording/reproducing laser light that is incident through the relay lens system is reflected by the dichroic mirror 8.

The recording/reproducing laser light reflected by the dichroic mirror 8 is incident to the objective lens 11 through the partial diffraction device 9→the ¼ wavelength plate 10. In this case, the partial diffraction device 9 is constructed by forming a polarization selective diffraction device having selective diffraction characteristics (of refracting the one linearly-polarized component and transmitting the other linearly-polarized component) according to the polarization state of the linear polarization such as a liquid crystal diffraction device in an area, to which the reference light is incident. More specifically, in this case, the polarization selective diffraction device included in the partial diffraction device 9 is configured to transmit the p polarization and to refract the s polarization. In addition, the ¼ wavelength plate 10 is disposed in the state where a reference optical axis thereof is inclined by 45° with respect to the polarization direction axis of the incident light (in the case, the p polarization) so as to function as a linear polarization/circular polarization converting device.

By the partial diffraction device 9 and the ¼ wavelength plate 10, deterioration in SN ratio (S/N) caused by the backward-path reference light (reflected reference light) that is obtained as the reflected light from the hologram recording medium HM may be prevented. In other words, the forward-path reference light incident as the p polarization is allowed to transmit the partial diffraction device 9. In addition, the backward-path reference light (reflected reference light) incident as the s polarization through the hologram recording medium HM (reflecting layer L3)→the objective lens 11→the ¼ wavelength plate 10 is allowed to be diffracted (suppressed) by the partial diffraction device 9. As described above, the reflected reference light becomes light having a much stronger intensity that the reproduced light of the hologram, which may be obtained by using a diffraction phenomenon. Therefore, the reflected reference light becomes a non-negligible noise component with respect to the reproduced image. If the reflected reference light is guided into the image sensor 13, the SN ratio is greatly decreased. By suppressing the reflected reference light by using the partial diffraction device 9 and the ¼ wavelength plate 10, the decrease in the SN ratio may be effectively prevented. In addition, in this case, the area of the partial diffraction device 9 to which the signal light is incident (that is, the area to which the reproduced image is incident) is constructed with, for example, a transparent material. Alternatively, the area may be configured to have hole portions so as to transmit the forward-path light and the backward-path light. In other words, therefore, at the time of recording, the signal light is allowed to properly illuminate the hologram recording medium HM, and at the time of reproducing, the reproduced image is allowed to be properly guided into the image sensor 13.

The objective lens 11 is supported to be moved in the contacting and separating direction (focusing direction) with respect to the hologram recording medium HM and in the radial direction (tracking direction) of the hologram recording medium HM by the two-axis mechanism 12 shown in the figure. The position controller 19 described later controls the operation of the two-axis mechanism 12 for driving the objective lens 11, so that the spot position of the laser light is controlled.

The recording/reproducing laser light is condensed by the objective lens 11 to illuminate the hologram recording medium HM. Herein, as described above, at the time of recording, based on the control of the modulation controller 20, the intensity modulator (SLM 4 and polarized beam splitter 3) generates the signal light and the reference light by the intensity modulation. Next, the signal light and the reference light are allowed to illuminate the hologram recording medium HM through the aforementioned path. Therefore, the hologram having the recorded data is formed on the recording layer L2 by the interference fringe of the signal light and the reference light. In other words, the recording of the data is performed.

In addition, at the time of reproducing, based on the control of the modulation controller 20, the intensity modulator generates only the reference light, and the reference light is allowed to illuminate the hologram recording medium HM through the aforementioned path. Due to the illumination of the reference light, the reproduced image according to the hologram formed on the recording layer L2 may be obtained as the reflected light from the reflecting layer L3. The reproduced image is allowed to return to the apparatus side through the objective lens 11.

As described above, in the partial diffraction device 9, the incidence area of the signal light is configured to be a transmission area. Therefore, the reproduced image that is obtained from the hologram recording medium HM and passes through the objective lens 11→the ¼ wavelength plate 10 is allowed to transmit the partial diffraction device 9. After the reproduced image that transmits the partial diffraction device 9 is reflected by the dichroic mirror 8, the reproduced image is incident to the polarized beam splitter 5 through the aforementioned relay lens system (relay lens 7→relay lens 6). Since the reflected light from the hologram recording medium HM is converted into the polarization by the function of the ¼ wavelength plate 10, the reproduced image that is incident to the polarized beam splitter 5 is reflected by the polarized beam splitter 5 to be incident to the image sensor 13.

The image sensor 13 is constructed with, for example, a CCD (charge coupled device) sensor, a CMOS (complementary metal oxide semiconductor) or the like to receive the guided reproduced image from the hologram recording medium HM and to convert the reproduced image into an electric signal, so that an image signal is obtained. The obtained image signal has the ON/OFF pattern (that is, data pattern of “0” and “1”) applied to the signal light at the time of the recording. In other words, the image signal that is detected by the image sensor 13 becomes a read signal of the data recorded in the hologram recording medium HM.

The image signal as the read signal obtained by the image sensor 13 is supplied to the data reproducing unit 21. The data reproducing unit 21 performs data identification of “0” and “1”, if necessary, the demodulation process of the recording modulator or the like for each value included the image signal from the image sensor 13 in units of pixels of the SLM 4 so as to reproduce the recorded data.

By the configuration described hereinbefore, the operations of recording and reproducing the hologram by the illumination of the recording/reproduced light from the first laser 1 as the light source are implemented.

In addition, in the recording and reproducing apparatus shown in FIG. 1, in addition to the aforementioned optic system of recording and reproducing the hologram, as an optic system (position control optic system) for controlling the recording and reproducing positions of the hologram, a second laser 14, a collimation lens 15, a polarized beam splitter 16, a condensing lens 17, and a photodetector (PD) 18 are provided.

In the position control optic system, the second laser 14 outputs the aforementioned red laser light having a wavelength λ, of about 650 nm as the position-control laser light. The light emitted from the second laser 14 is incident to the dichroic mirror 8 through the collimation lens 15→the polarized beam splitter 16. Herein, the polarized beam splitter 16 is also configured to transmit the p polarization and to reflect the s polarization.

As described above, the dichroic mirror 8 is configured to selectively reflect the light in the wavelength band of the recording/reproducing laser light (in the case λ=about 405 nm), so that the position-control laser light from the second laser 14 may be transmitted. Similarly to the recording/reproducing laser light, the position-control laser light that transmits the dichroic mirror 8 is allowed to illuminate the hologram recording medium HM through the partial diffraction device 9→the ¼ wavelength plate 10→the objective lens 11.

In addition, as described for the better understanding, the dichroic mirror 8 is disposed, so that the position-control laser light and the recording/reproducing laser light are combined in the same optical axis and the combined light is allowed to illuminate the hologram recording medium HM through the common objective lens 11. In other words, therefore, the beam spot of the position-control laser light and the beam spot of the recording/reproducing laser light are designed to be formed at the same position in the inward direction of the recording surface, so that the hologram recording and reproducing positions are controlled to be a position in the track by performing the position control operation based on the position-control laser light described later.

In addition, in this case, a difference in wavelength between the recording/reproducing laser light and the position-control laser light is about 250 nm. Since such a sufficient difference in wavelength is provided, the sensitivity of the position-control laser light for the recording layer L2 of the hologram recording medium HM is equal to almost zero.

Due to the illumination of the position-control laser light, the reflected light may be obtained from the hologram recording medium HM according to information recorded on the reflecting layer L5. The reflected light (that is, the position control information representing light) is incident to the polarized beam splitter 16 through the objective lens 11→the ¼ wavelength plate 10→the partial diffraction device 9→the dichroic mirror 8. The polarized beam splitter 16 is allowed to reflect the reflected light of the position-control laser light that is incident through the dichroic mirror 8 (the position-control laser light reflected by the hologram recording medium HM is converted into the s polarization by the function of the ¼ wavelength plate 10). The reflected light of the position-control laser light reflected by the polarized beam splitter 16 is condensed on the detection plane of the photodetector 18 through the condensing lens 17 so as to illuminate.

The photodetector 18 includes a plurality of light receiving devices to receive the position control information representing light from the hologram recording medium HM illuminated through the condensing lens 17 and to obtain an electrical signal corresponding to a result of the receiving of the light. In other words, therefore, the reflected light information (reflected light signal) representing a convex-concave sectional shape formed on the substrate L6 (on the reflecting layer L5) is detected.

A position controller 19 is provided as a configuration for performing various types of position control for the hologram recording and reproducing positions such as focus servo control, tracking servo control, predetermined address access control based on the aforementioned reflected light information obtained by the photodetector 17.

The position controller 19 is configured to include a matrix circuit, which performs matrix calculation to generate a reproducing signal (RF signal) for pit columns formed on the reflecting layer L5 or various types of signals necessary for the position control such as a tracking error signal and a focus error signal, a calculation circuit for performing servo calculation or the like, and a driving controller for controlling the driving of necessary elements such as two-axis mechanism 12.

Although not shown, in the recording and reproducing apparatus shown in FIG. 1, an address detection circuit which detects address information based on the reproduced signal or a clock generation circuit which generates clocks based on the reproduced signal is provided. In addition, for example, a slide driver which movably supports the hologram recording medium HM in the tracking direction is provided.

The position controller 19 controls the two-axis mechanism 12 or the slide driver based on the address information or the tracking error signal, so that the position control of the beam spot of the position-control laser light is performed. By the position control of the beam spot, the position of the beam spot of the recording/reproducing laser light may be moved to a necessary address or be allowed to trace the position along the track (tracking servo control). In other words, therefore, the control of the hologram recording and reproducing positions is performed.

In addition, the position controller 19 also performs the focus servo control for allowing the focus position of the position-control laser light to track on the reflecting layer L5 by controlling the operation of driving the objective lens 11 in the focus direction by the two-axis mechanism 12 based on the focus error signal. Therefore, the focus position of the recording/reproducing laser light that is allowed to illuminate through the common objective lens 11 may be maintained at a predetermined position.

### 1-2. Suppression of Coma Aberration Caused by Tilt

### 1-2-1. Detailed Method of Suppressing Coma Aberration

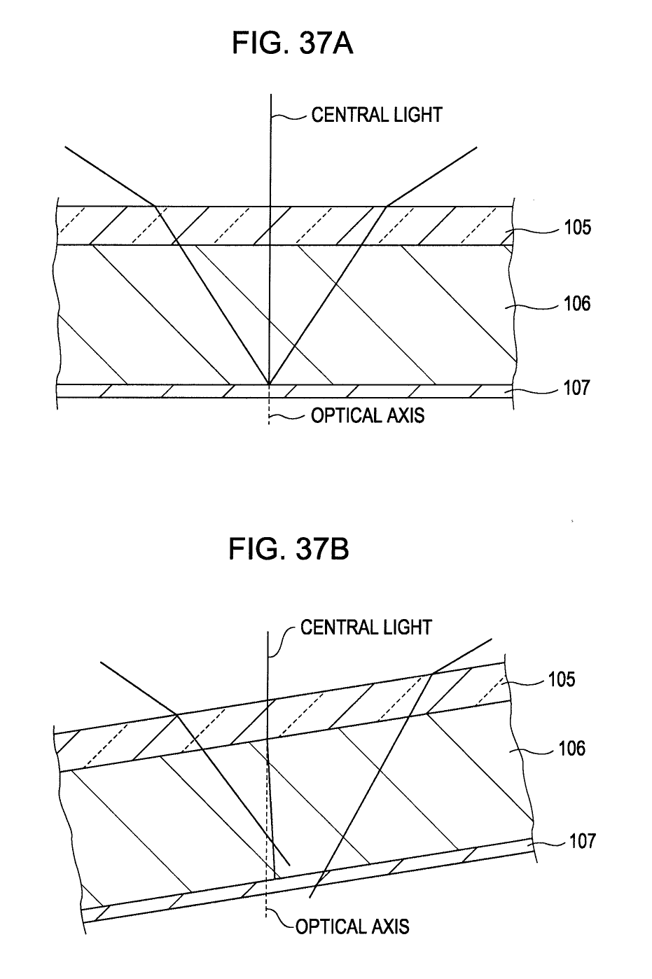

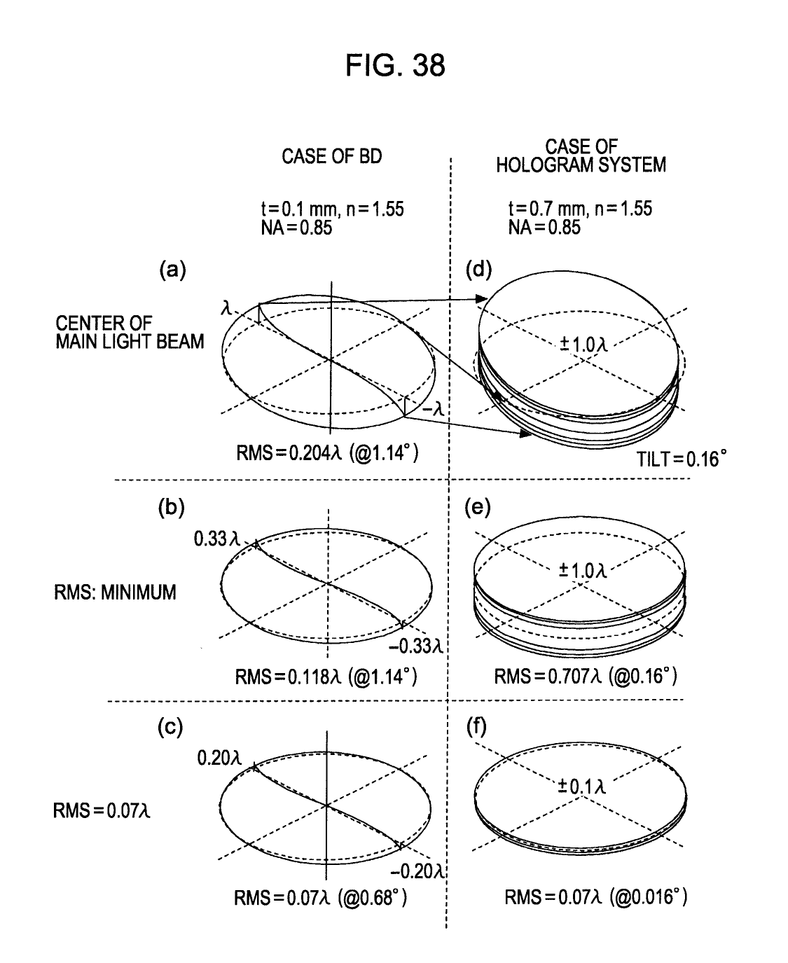

As described above with reference to FIGS. 37A and 37B, in a general optical disc system, the coma aberration caused by the occurrence of the tilt occurs. Particularly, in the hologram recording and reproducing system employing the coaxial type, as described with reference to FIGS. 38A to 38F, according to the principle of the recording and reproducing, the deterioration in the reproduced signal due to the occurrence of the coma aberration caused by the tilt is much greater than the case of the current optical disc system. In other words, in comparison with the optical disc system in the related art, the hologram recording and reproducing system employing the coaxial type has a problem in that the tilt tolerance is very narrow.

Herein, if a numerical aperture of the objective lens that is the output stage of the laser light that is allowed to illuminate the recording medium is denoted by NA, and if a separation distance from the surface of the recording medium to the focus position of the laser light is denoted by t, the occurrence amount W of the coma aberration is expressed by W∝NA³·t.

In other words, the occurrence amount W of the coma aberration may be suppressed by allowing the NA of the objective lens to be small or by allowing the separation distance t from the surface of the recording medium to the focus position to be small.

In the embodiment, by taking into consideration the principle of recording and reproducing the hologram, the method of suppressing the occurrence amount W of the coma aberration caused by the tilt by allowing the value of t to be small is employed.

Herein, as described above with reference to FIG. 34, in the related art, the focus position of the recording/reproduced light is located on the reflecting plane of the reflecting layer disposed on the hologram recording layer (the upper layer side surface of the reflecting layer L3, that is, the lower layer side surface of the recording layer L2). In other words, since the value of the “t” is the distance from the surface of the hologram recording medium HM to the reflecting plane of the reflecting layer L3, the value of the “t”, which includes the thickness of the cover layer L1 and the thickness of the recording layer L2, becomes a relatively large value. Therefore, in the hologram recording and reproducing system in the related art, the occurrence amount W of the coma aberration caused by the tilt tends to be relatively large, so that the tilt tolerance may be greatly narrowed.

By taking into consideration this point, in the embodiment, the value of t is set to be smaller than the case in the related art. In other words, the value of t is set to be smaller than “the distance from the surface of the hologram recording medium HM to the reflecting plane of the reflecting layer L3” in the case in the related art. More specifically, by shifting the focus position of the recording/reproducing laser light to the vicinity of the surface of the hologram recording medium HM, the value of t is set to be much smaller than the case in the related art.

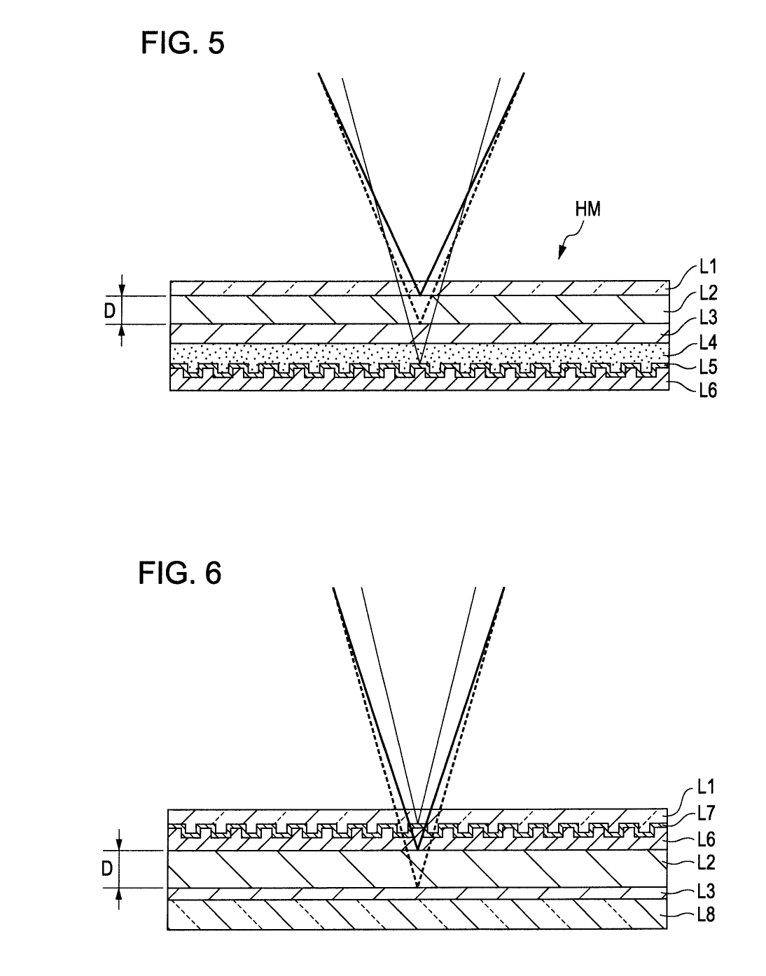

FIG. 5, as a diagram illustrating the focus position of the recording/reproducing laser light that is set according to the embodiment, illustrates a sectional structure of the hologram recording medium HM and a position-control laser light (thin solid line in the figure) and a recording/reproducing laser light (thick solid line in the figure) which are allowed to illuminate the hologram recording medium HM. In addition, FIG. 5 also illustrates a recording/reproducing laser light by a thick dotted line in the case in the related art as a comparison.

As shown in FIG. 5, in the embodiment, the focus position of the recording/reproducing laser light is set to be on an interfacial surface of the cover layer L1 and the recording layer L2. In other words, the upper layer side surface of the recording layer L2 is set as the focus position.

In this case, the value of the distance t may be decreased by a distance corresponding to the thickness of the recording layer L2, which is denoted by “D” in the figure. Herein, in the embodiment, if the thickness of the cover layer L1 is set to 0.1 mm and if the thickness of the recording layer L2 is set to 0.6 mm similarly to the case in the related art, the value of the distance t may be decreased such that t=0.1 mm in comparison with t=0.7 mm in the case in the related art where the focus position is set to be on the reflecting plane of the reflecting layer L3.

In addition, FIG. 6 illustrates an example of the focus position in the case where the hologram recording medium having the structure shown in FIG. 3 is used.

In addition to the sectional structure of the hologram recording medium shown in FIG. 3, FIG. 6 illustrates a position-control laser light (thin solid line) and a recording/reproducing laser light (thick solid line) and a recording/reproducing laser light (thick dotted line) in the case of the recording reproducing system in the related art.

In this case, the focus position recording/reproducing laser light of the case in the related art is also set to be on the reflecting plane of the reflecting layer L3. However, in the embodiment, the focus position of the recording/reproducing laser light is set to be located on the upper layer side surface of the recording layer L2. Therefore, in this case, the value of t may also be decreased by the value corresponding to the thickness of the recording layer L2 (“D” in the figure).

In this manner, by further shifting the focus position of the recording/reproducing laser light to the surface of the recording medium in comparison with the case in the related art, the value of t is set to be small, so that occurrence amount W of the coma aberration caused by the tilt may be effectively suppressed. As a result, the tilt tolerance may be further improved (increased) in comparison with the case in the related art.

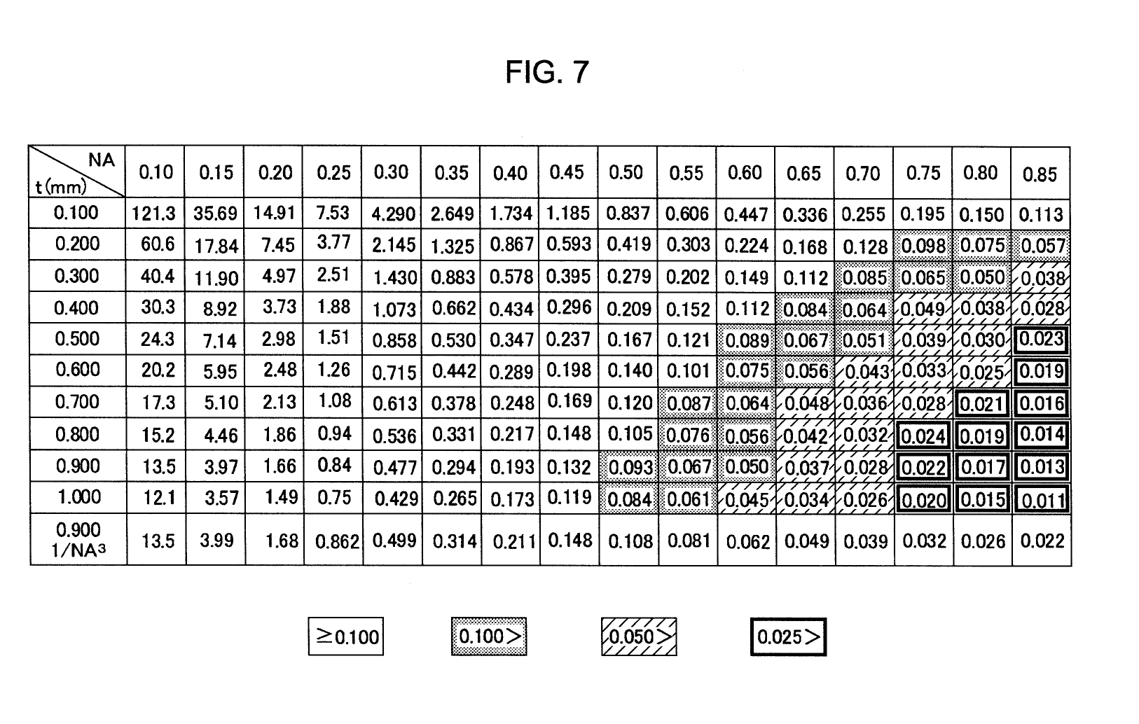

FIG. 7 illustrates a result of the simulation with respect to the relationship among the setting values of the NA of the objective lens 11 and the distance t and the reproduction tilt tolerance. In addition, in FIG. 7, the refractive index n of the hologram recording medium HM is set to n=1.55. In addition, the tilt tolerance is expressed by the tilt angle at the time that the Marechal criterion (λ=0.07) is satisfied. In addition, although the tilt tolerance is to be represented by using a sign +/−, for the convenience of drawing FIG. 7, the sign +/− is omitted.

As clearly understood from the result of the simulation shown in FIG. 7, in the coaxial-type hologram recording and reproducing system, the NA and the t also greatly influence the tilt tolerance (the occurrence amount W of the coma aberration). In addition, as shown in FIG. 7, it may understood that the tilt tolerance is increased (that is, the occurrence amount W of the coma aberration is suppressed) as the value of NA is large and as the value of t is small. On the contrary, the tilt tolerance is decreased (that is, the occurrence amount W of the coma aberration is increased) as the value of NA is small and as the value of t is large.

In addition, as described above with reference to FIG. 38, in the hologram recording and reproducing system in the related art, NA=0.85 and t=0.7 mm. According to FIG. 7, in this case, the tilt tolerance becomes +/−0.016°. However, in the embodiment where t=0.1 mm, the tilt tolerance becomes +/−0.113°. Therefore, according to the result of simulation of FIG. 7, it may be understood that the tilt tolerance of the embodiment is seven times larger than the tilt tolerance in the related art.

Herein, as clearly understood from the result of the simulation shown in FIG. 7 or from the aforementioned relational equation “W∝NA³·t”, in order to suppress the occurrence amount W of the coma aberration, a method of allowing the NA of the objective lens 11 to be small may be considered. However, in the case where the NA is set to be small, the information recording/reproducing density is sacrificed. If the method of allowing the value of t to be small by adjusting the focus position is employed like the example of the embodiment, the tilt tolerance may be improved without deterioration in the information recording/reproducing density.

In addition, the most important point is that the method of shifting the focus position is not employed by an optical disc system in the related art. In other words, for example, in the optical disc system in the related art such as a DVD (digital versatile disc) or BD (Blu-Ray Disc, a registered trade mark), if the focus position of the recording/reproduced light is shifted, the data recording/reproducing may not be properly performed. However, in the hologram recording and reproducing system, due to the principle of the recording and reproducing, although the focus position of the recording/reproduced light is shifted, the hologram may be properly recorded on the recording layer, and the recorded hologram may be properly reproduced. In other words, in the invention, by taking into consideration the principle of the recording and reproducing that is unique to the hologram recording and reproducing system, the method of suppressing the coma aberration by shifting the focus position is employed.

### 1-2-2. Detailed Method of Shifting Focus Position

Due to the aforementioned shifting of the focus position of the recording/reproducing laser light, the separation distance between the objective lens and the hologram recording medium may be further increased in comparison with the case in the related art.

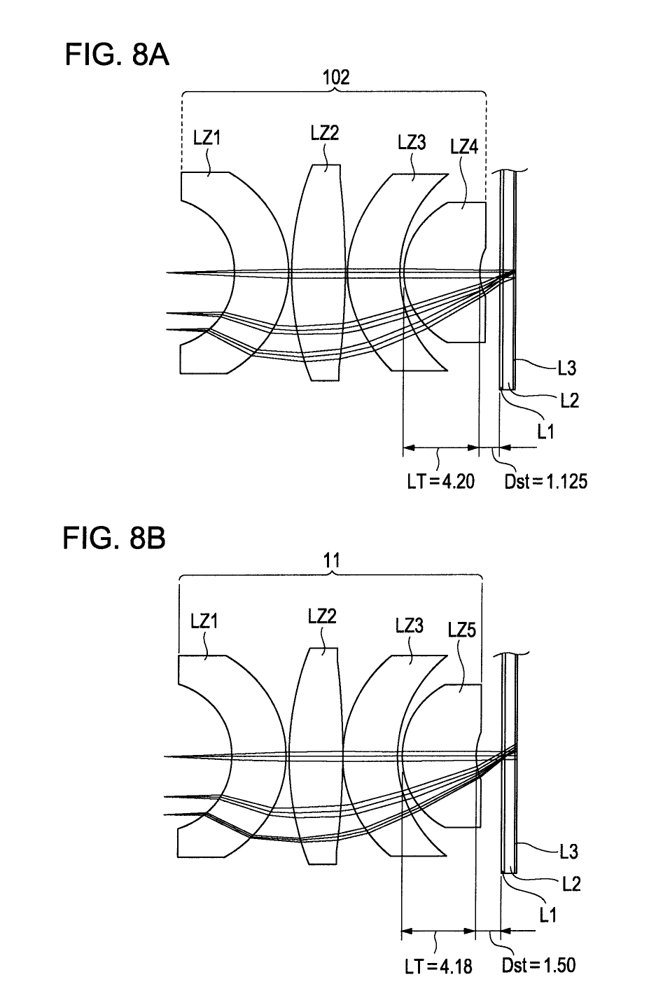

FIGS. 8A and 8B are diagrams illustrating the examples of setting the separation distance between the objective lens and the hologram recording medium according to the change in the focus position of the recording/reproduced light. In FIGS. 8A and 8B, FIG. 8A illustrates examples in the case in the related art where the objective lens 102 is used, and FIG. 8B illustrates an example of the embodiment where the objective lens 11 is used.

In each figure, only the objective lens 102 in the case in the related art, the objective lens 11 in the example of the embodiment, the light rays of the recording/reproducing laser light that is allowed to illuminate the hologram recording medium through the objective lenses, and the cover layer L1, the recording layer L2, and the reflecting layer L3 of the hologram recording medium are extracted and illustrated.

As shown in FIG. 8A, in the case in the related art, the objective lens 102 is configured to include a lens LZ 1, a lens LZ 2, a lens LZ 3, and a lens LZ 4 in this order from the light source side. In this case, a thickness (Dst in the figure) of the lens LZ 4 having the largest curvature is set to Dst=4.20 mm. In the recording and reproducing apparatus in the related art, by using the objective lens 102, the separation distance LT from the emitting surface of the objective lens 102 to the hologram recording medium (surface) is set to LT=1.125 mm as shown in the figure, so that the focus position of the recording/reproducing laser light is located on the reflecting layer L3.

On the other hand, in FIG. 8B, in the embodiment, the objective lens 11 is configured to include a lens LZ 1, a lens LZ 2, and a lens LZ 3 in this order from the light source side similarly to the objective lens 102 in the case in the related art. However, as the lens having the largest curvature corresponding to the lens LZ 4 of the objective lens 102, a lens LZ 5 having a thickness LT if 4.18 mm, which is smaller by 0.02 mm than the thickness LT of 4.20 mm of the lens LZ 4, is used.

In the example of the embodiment, the thickness LT is configured to be small so as to suppress the spherical aberration caused by the shifting of the focus position.

In addition, in the embodiment, the distance Dst from the emitting surface of the objective lens 11 to the hologram recording medium HM is set such that Dst=1.50 mm as shown in the figure, which is increased by about 0.375 mm from the distance Dst of 1.125 mm in the case in the related art.

Due to the aforementioned configuration of the objective lens 11 and the setting of the separation distance Dst from the emitting surface of the objective lens to the hologram recording medium, the focus position of the recording/reproducing laser light, which is set to be on the reflecting layer L3 in the case in the related art, may be shifted to the upper layer side surface of the recording layer L2 (interfacial surface of the cover layer L1 and the recording layer L2. More specifically, the focus position of the recording/reproducing laser light may be shifted to the upper layer side by 0.6 mm in comparison with the case in the related art.

Herein, the adjusting of the separation distance Dst may be implemented, for example, by adjusting the installation position of a medium supporting member of a spindle motor of rotatably supporting the hologram recording medium. In the recording and reproducing apparatus according to the embodiment, the installation position of the medium supporting member is offset to the side that is separated from the objective lens in comparison with the case in the related art. Therefore, the focus position of the recording/reproduced light is set to the position of the upper layer side that is above the lower layer side surface of the recording layer L2.

In addition, according to the method of adjusting the separation distance Dst in the embodiment, the focus position of the recording/reproducing laser light is shifted, and the focus position of the position-control laser light is also shifted. As described with reference to FIG. 5, in the case of the embodiment, it is necessary to set the focus position of the position-control laser light on the reflecting layer L5 (reflecting layer L7 in FIG. 3) similarly to the case in the related art. In other words, in the case where the focus position of the recording/reproducing laser light is set to be on the upper layer side surface of the recording layer L2 like the example of the embodiment, it is necessary to set the separation distance between the focus position of the position-control laser light and the focus position of the recording/reproducing laser light to the distance “between the upper layer side surface of the recording layer L2 and the reflecting plane of the reflecting layer L5 (L7)”.

By taking into consideration this point, in the embodiment, the optic system is configured to be adjusted (for example, the position of the collimation lens 15 is adjusted) by changing the collimation at the time when the position-control laser light is incident to the objective lens 11 so that the separation distance between the focus position of the position-control laser light and the focus position of the recording/reproducing laser light is set to the distance “between the upper layer side surface of the recording layer L2 and the reflecting plane of the reflecting layer L5 (L7)”.

In addition, as the method of shifting the focus position of the recording/reproduced light, various methods including the aforementioned exemplary method may be considered. For example, a method may be implemented by changing a design of the objective lens (102). In the invention, the detailed method of shifting the focus position of the recording/reproduced light is not limited to a specific one, but optimal methods suitable for actual embodiments may be employed.

### 1-2-3. Change in the Behavior of Light Due to Shifting of Focus Position

Herein, as described above, in the case where the focus position of the recording/reproduced light is shifted from the reflecting plane of the reflecting layer L3, the behavior of light is different from that of the case in the related art.

Change in Recorded Hologram

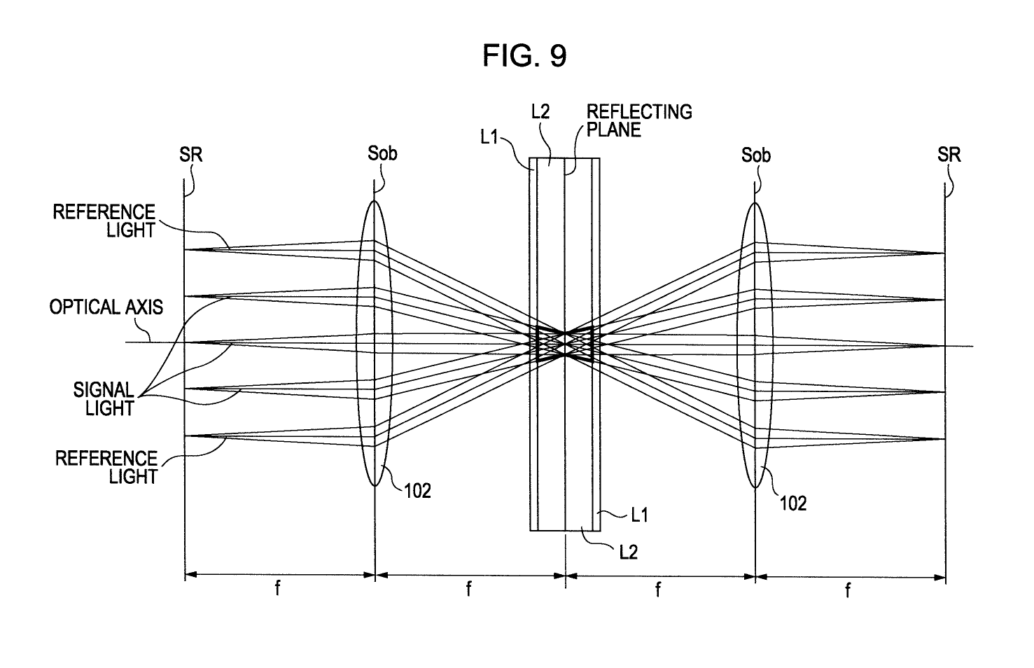

Due to the shifting of the focus position, the shape of the hologram recorded on the recording layer L2 is different from that of the case in the related art. This is described with reference to FIGS. 9 to 12.

Herein, the same configurations in FIGS. 9 to 12 are described.

In each of FIGS. 9 to 12, only the objective lens 11 (the objective lens 102 in the case of FIG. 9), the cover layer L1, the recording layer L2, and the reflecting plane of the reflecting layer L3 of the hologram recording medium HM are extracted and illustrated, and the behavior of the light rays of the recording light and reproduced light that are allowed to illuminate the hologram recording medium HM are also illustrated.

As clearly understood from the description of FIG. 1, although the light (backward-path light) reflected from the reflecting plane of the reflecting layer L3 actually returns to the side to which the forward-path light is incident, for the convenience of drawing FIGS. 9 to 12, the backward-path light together with the recording layer L2, the cover layer L1, and the objective lens 11 or 102 are also illustrated in a folding manner at the side opposite to the side to which the forward-path light is incident, with the reflecting plane as a boundary.

In addition, in FIGS. 9 to 12, the plane SR denotes a real image plane (an object plane of the objective lens) of the SLM 4, which is formed by a relay lens system (6, 7). In addition, in the figure, the plane Sob denotes a pupil plane of the objective lens 11 (the objective lens 102 in FIG. 9).

In addition, in FIGS. 9 to 12, with respect to the signal light, only the light rays corresponding to three pixels, which is a sum of the light rays corresponding to the central one pixel coincident with the optical axis and the light rays corresponding to the other two pixels, among the pixels in the signal light area A2 are extracted and illustrated. In addition, with respect to the reference light, only the light rays corresponding to the two pixels that are located in the outermost circumferential portion in the reference light area A1 are extracted and illustrated.

First, the shape of the hologram that is formed on the hologram recording medium 100 (HM) by the recording reproducing system in the case in the related art is described with reference to FIG. 9.

In the case in the related art, the focus position of the recording/reproduced light is set to be on the reflecting plane. In addition, therefore, it the recording and reproducing apparatus in the related art, the focus distance f of the objective lens 102 becomes the distance from the pupil plane Sob of the objective lens to the reflecting plane.

In this case, the light rays of the signal light and light rays of the reference light are condensed at one point of the reflecting plane as shown in the figure. In this case, after the light rays of the signal light and the reference light (light rays of pixels) are condensed to the real image plane SR, the light rays are incident to the objective lens 102 in the spreading light state. Next, the light rays that are incident to the objective lens 102 are condensed at one point of the reflecting plane of the hologram recording medium 100 in the state of a parallel light.

In the case in the related art where the focus position of the recording/reproduced light is set to be on the reflecting plane, the path lengths of the backward-path light and the forward-path light are equal to each other, so that the light rays of the forward-path light and the backward-path light have symmetry with respect to the reflecting plane as a central axis as shown in the figure. Accordingly, the hologram formed on the recording layer L2 are also formed in a shape having symmetry with respect to the reflecting plane as a central axis so that it is surrounded by a frame in the figure.

In addition, as described for the better understanding, the hologram is generated by the interference of the signal light and the reference light. Therefore, the hologram is formed in the overlapped portion of the signal light and the reference light in the recording layer L2. In the coaxial type, since the signal light and the reference light are allowed to illuminate the recording medium so that the light flux thereof are allowed to converge into one point (the reflecting plane in this case), the shape of the hologram formed in this case become a shape of a sandglass as shown in the figure.

In addition, in FIG. 9, in the embodiment, since the reflected light returning to the side of the forward-path light is illustrated in a folding manner at the opposite side, the shape of the hologram is illustrated by the aforementioned shape of a sandglass. However, actually, the hologram (trapezoidal shape) of the right half portion of the figure is formed to overlap with the hologram of the left half portion of the figure.

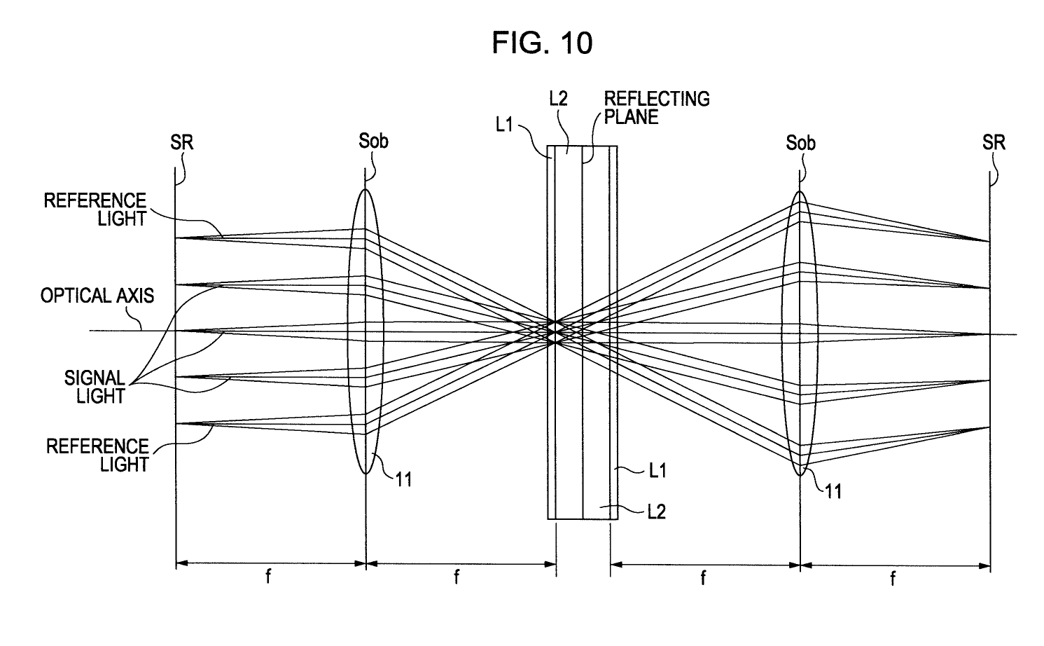

FIG. 10 illustrates the behavior of the light rays of the signal light and the reference light that are allowed to illuminate the hologram recording medium HM and the light rays of the backward-path light in the case of the embodiment where the focus position of the recording/reproduced light is set to be on the upper layer side surface of the recording layer L2.

First, in the case where the focus position is set to be on the upper layer side surface of the recording layer L2, as clearly understood from the figure, the focus distance f of the objective lens 11 becomes the distance from the pupil plane Sob to the upper layer side surface of the recording layer L2.

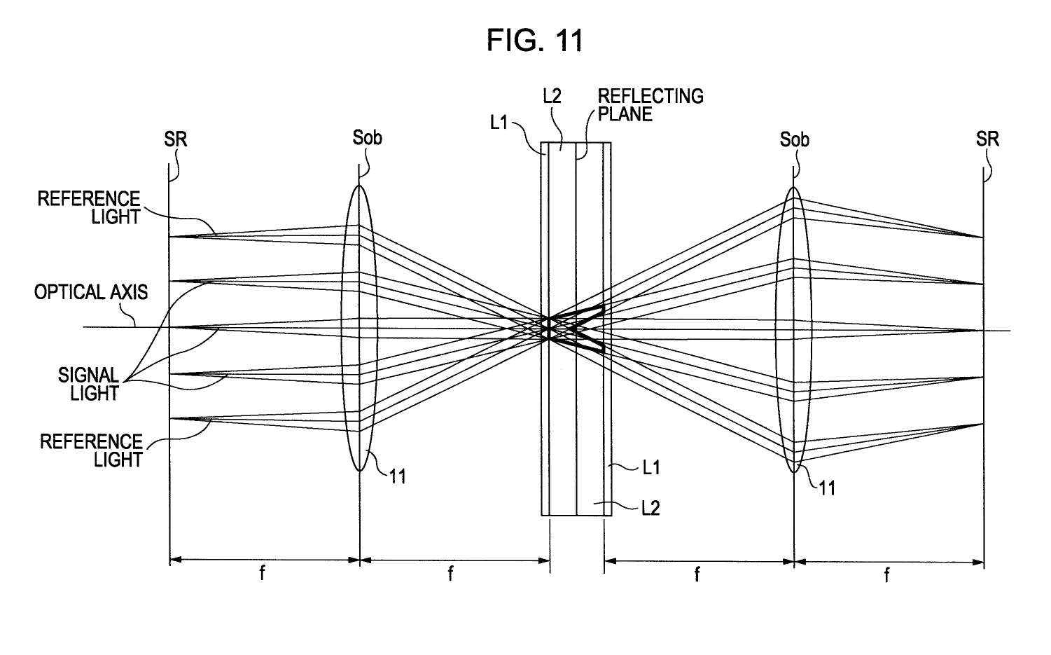

Next, in this case shown in the figure, as the spreading light after the condensing thereof, the signal light and the reference light are allowed to illuminate the recording layer L2. Therefore, in this case, the shape of the hologram formed on the recording layer L2 becomes a shape as shown by a frame in FIG. 11.

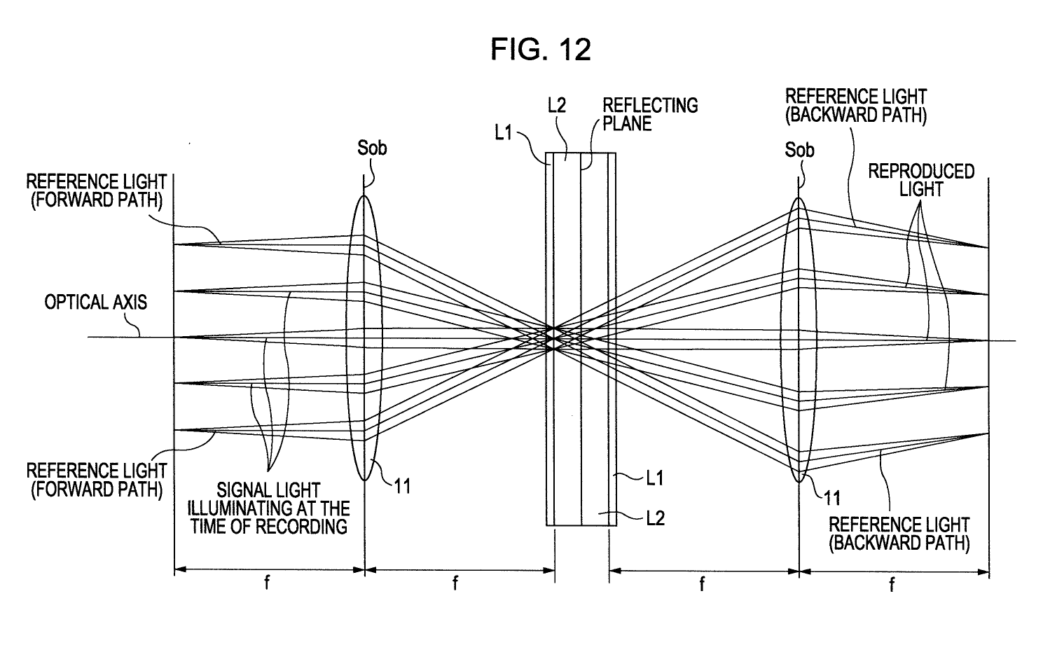

FIG. 12 illustrates the behavior of the reproducing of the recorded hologram. As understood from the description hereinbefore, by allowing the reference light to illuminate the hologram formed on the recording layer L2, a reproduced light (reproduced image) corresponding to the recorded signal light is output. FIG. 12, illustrates the light rays of the reference light (forward path) that is allowed to illuminate at the time of reproducing, the reproduced light according to the illumination of the reference light, and the reference light (reflected reference light: backward-path reference light) reflected from the reflecting plane. In addition, the figure also illustrates trajectories of the light rays of the signal light that is allowed to illuminate at the time of recording.

Change in Position of Light Ray of Backward-Path Light

Herein, as clearly seen in comparison of FIGS. 9, 10 to 12, in the case of the example of the embodiment where the focus position is allowed to be shifted from the reflecting plane, a difference between the positions of the light rays of the forward-path light and the backward-path light occurs.

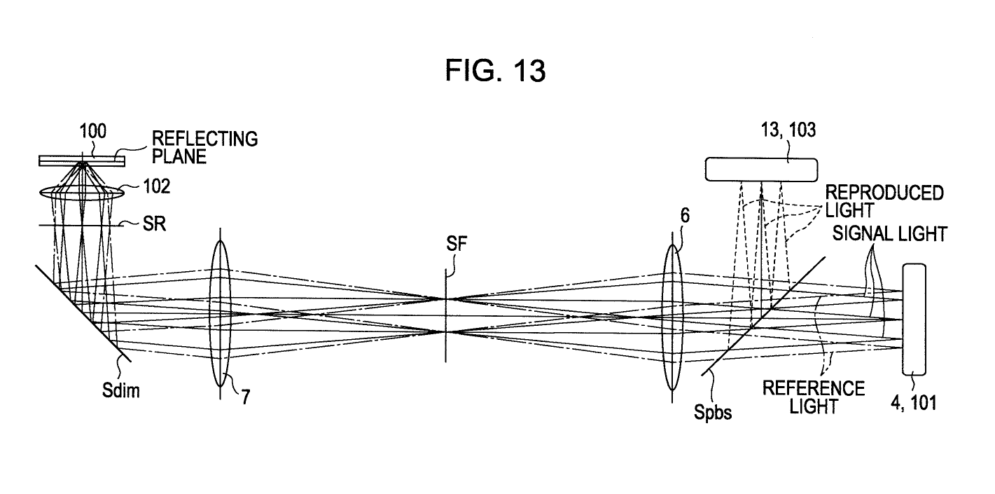

The behavior of the light in the entire optic system in the case of the related art and the case of the embodiment is checked with reference to FIGS. 13 to 15.

In addition, in FIGS. 13 to 15, only the light rays of the signal light corresponding to three pixels and only the light rays of the reference light corresponding to two pixels are representatively illustrated.

In addition, FIGS. 13 to 15 illustrate only the SLM 4, the relay lenses 6 and 7, and the objective lens (11 or 102) extracted among the entire configuration of the optic system. In addition, in the figures, the hologram recording medium (HM or 100) is also illustrated. In addition, in the figures, the plane Spbs denotes the reflecting plane of the polarized beam splitter 5, and the plane Sdim denotes the reflecting plane of the dichroic mirror 8.

FIG. 13 illustrates the behavior of the light in the case in the related art. In addition, in the case in the related art, the positions which the light rays pass through in the forward path and the backward path are the same, these configurations are commonly illustrated in one figure.

As shown in the figure, the light rays emitted from the pixels of the SLM 4 are incident to the relay lens 6 through the plane Spbs (polarized beam splitter 5) in the spreading light state. In this case, the light rays emitted from the pixels are in the state where the optical axes thereof are parallel to each other.

The light rays of the pixels that are incident to the relay lens 6 are converted from the spreading light into the parallel light as shown in the figure, and the optical axes of the light rays excluding the light rays in the optical axis of the laser light (the optical axis of the entire laser light flux) are bent toward the optical axis of the laser light. Therefore, with respect to the plane SF, the light rays are condensed in the optical axis of the laser light in the state of the parallel light. Herein, similarly to the focus plane by the objective lens, the plane SF is a plane, on which the light rays of the pixels from the parallel are condensed in the optical axis of the laser light and referred to as a Fourier plane (frequency plane).

Although the light rays that are condensed in the optical axis of the laser light on the Fourier plane SF are incident to the relay lens 7, at this time, the light rays emitted from the relay lens 6 (excluding the light rays of the central pixels including the optical axis of the laser light) intersects the optical axis of the laser light on the Fourier plane SF. Therefore, in the relay lens 6 and the relay lens 7, the incident positions and the emitting positions of the light rays has a relationship of axial symmetry with respect to the optical axis of the laser light as the center thereof.

The light rays are converted into the converging light through the relay lens 7 as shown in the figure, and the optical axes of the light rays are parallel to each other. The light rays that pass through the relay lens 7 are reflected on the plane Sdim (dichroic mirror 8) and condensed at the positions on the real image plane SR shown in FIG. 9. In this case, since the light rays that pass through the relay lens 7 are considered to be in the state where the optical axes thereof are parallel to each other, the condensing positions of the light rays on the real image plane SR are different from each other without overlapping with each other. In addition, the behavior of the light after the real image plane SR are the same as that described with reference to FIG. 9.

Herein, in FIG. 13, although the light rays of the reproduced light that are reflected on the plane Spbs and guided into the image sensor 13 (130) are illustrated, only the reproduced light is guided into the image sensor 13 as shown in the figure because the reflected reference light is suppressed by the aforementioned partial diffraction device 9 (and ¼ wavelength plate 10). In addition, as described for the better understanding, the partial diffraction device 9 is disposed on the real image plane SR or in the vicinity thereof. This configuration is provided for the following reason. Since it is necessary to selectively transmit/diffract the light by the area of the signal light and the area of the reference light as described above, if the partial diffraction device 9 is not disposed at the position where the same image as that of the SLM 4 (image generating plane) is obtained, selective transmission/diffraction functions may not properly obtained.

In addition, at the time of reproducing, the reproduced light may be obtained at the light ray positions that are the same as the light ray positions of the signal light of the time of recording. In other words, the light rays of the reproduced light trace the same positions as those of the light rays of the signal light in the figure to reach the plane Spbs to be reflected by the plane Spbs to be guided into the image sensor 13. In this case, the light rays of the reproduced light emitted from the relay lens 6 to the plane Spbs are in the state of the converging light in the figure and in the state where the optical axes are parallel to each other; and the light rays are condensed to different position of the detecting surface of the image sensor 13. Therefore, on the detecting surface of the image sensor 13, the same image as that of the real image plane SR may be obtained.

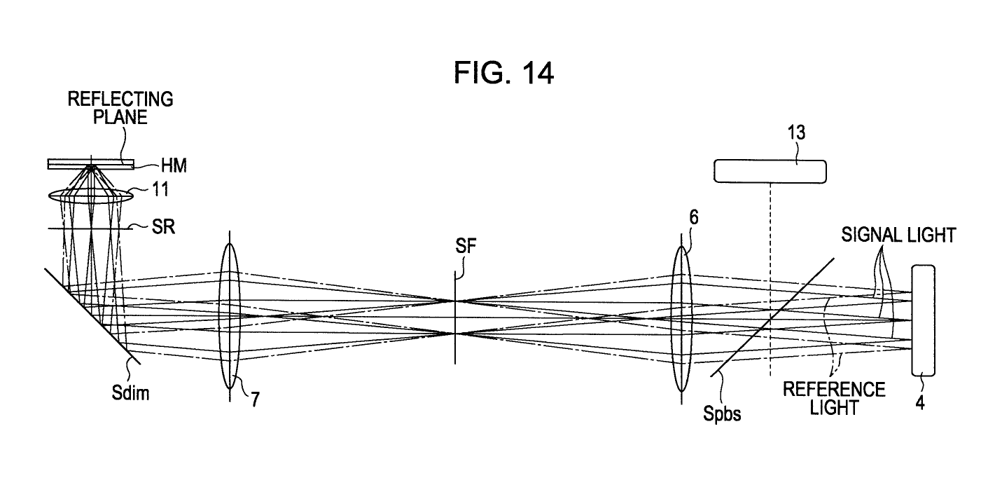

FIG. 14 illustrates the behavior of the forward-path light at the time of recording, as the behavior of the light in the case of the embodiment.

In this case, the behavior of the light from the SLM 4 to the objective lens 11 is the same as that of the case in the related art. The different points in comparison with the case in the related art are as follows. As described with reference to FIG. 10, the focus position of the recording/reproduced light (that is, the condensing position of the light rays of the signal light and the reference light through the objective lens 11 in the figure) is not on the reflecting plane of the reflecting layer L3 but shifted to the interfacial surface of the cover layer L1 and the recording layer L2.

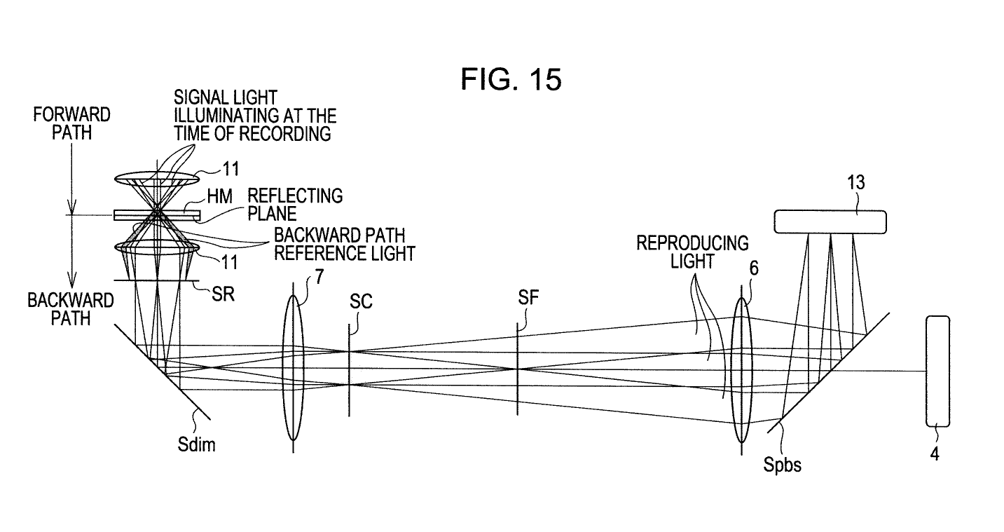

FIG. 15 illustrates the behavior of the backward-path light at the time of reproducing in the case of the embodiment.

In addition, in FIG. 15, the two forward-path light, that is the reference light, as a forward-path light that is allowed to illuminate the hologram recording medium HM through the objective lens 11 at the time of reproducing, and the signal light (non-colored light ray) that is allowed to illuminate at the time of recording are illustrated in a folding manner at the opposite side with the reflecting plane of the hologram recording medium HM as a boundary.

As shown in FIGS. 10 to 12, in the case of the embodiment where the focus position is shifted from the reflecting plane to the upper layer side, the incident positions of the light rays (excluding the light rays of the central pixel including the optical axis of the laser light) to the pupil plane Sob of the objective lens 11 are different between the forward-path light and the backward-path light. More specifically, the incident position of the backward-path light is shifted to the outer side with respect to the incident position of the forward-path light. Therefore, in the case of the embodiment, the positions of the light rays of the backward-path light shown in FIG. 15 and the forward-path light shown in FIG. 14 are not coincident with each other.

In addition, since the incident positions of the forward-path light and the backward-path light to the pupil plane Sob of the objective lens 11 are different from each other, the incident positions of the light rays to the pupil plane of the relay lens 7 or the pupil plane of the relay lens 6 are also different between the forward-path light and the backward-path light. Accordingly, even on the condensing plane of the light rays that is formed by the relay lens system constructed with the relay lenses 6 and 7, the positions are different between the forward-path light and the backward-path light.

More specifically, as described above, if the incident positions of the light rays of the backward-path light to the pupil plane Sob are shifted to the outer side, the incident positions of the light rays to the pupil plane of the relay lens 7 are shifted to the inner side with respect to the incident positions of the forward-path light, so that the condensing plane of the backward-path light (referred to as a backward-path conjugating plane SC) is shifted to a position that is at the side of the relay lens 7 rather than the condensing plane, that is, the Fourier plane SF.

However, it should be noted that the condensing positions of the light rays on the real image plane SR (and the detecting plane of the image sensor 13) are the same as those in the cases of FIGS. 13 and 14. In other words, since the condensing positions of the light rays on the real image plane SR are coincident with each other, at the time of reproducing, the reproduced image may be properly detected by the image sensor 13, similarly to the case in the related art.

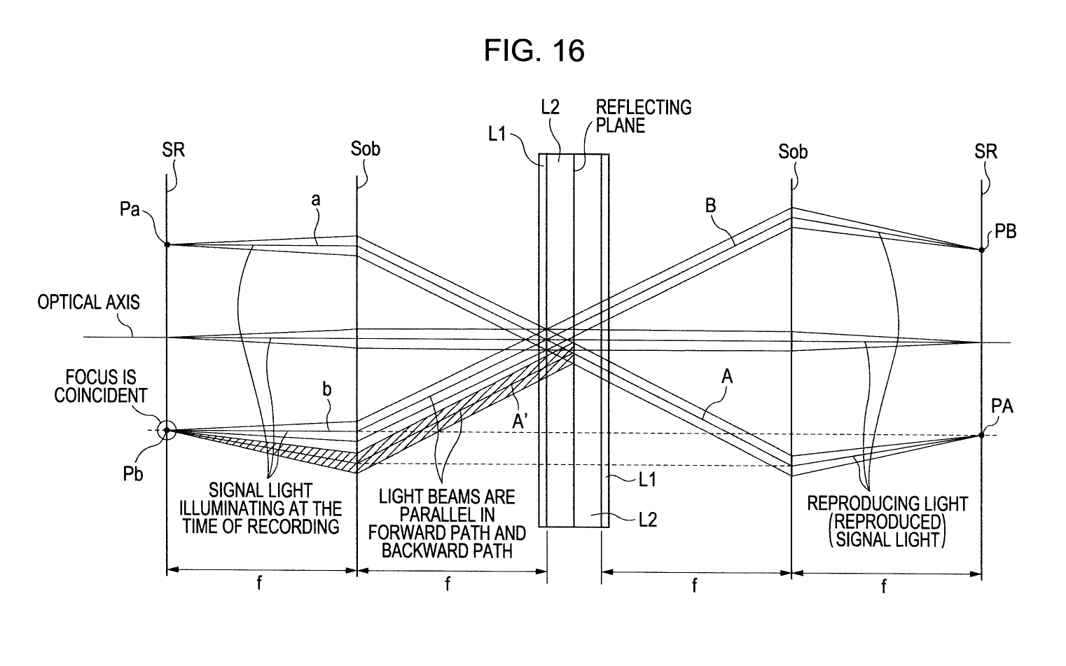

Herein, the reason that the positions of the light rays of the forward-path light and the backward-path light on the real image plane SR are coincident with each other is described with reference to FIG. 16.

In addition, similarly to FIGS. 10 to 12, in FIG. 16, only the real image plane SR, the pupil plane Sob of the objective lens 11, the cover layer L1, the recording layer L2, and the reflecting plane of the reflecting layer L3 of the hologram recording medium HM are extracted and illustrated, and the light rays of the reproduced light output from the hologram recording medium HM at the time of reproducing are also illustrated. With respect to the light rays of the reproduced light, three light rays, that is, the light ray of the central pixel and two light rays of the two pixels located at outermost circumferential portion are representatively illustrated. In addition, in FIG. 16, the light rays of the signal light, as the forward-path light, that is allowed to illuminate at the time of recording (non-colored light rays in the figure, only three light rays corresponding to three pixels including the central pixel and the two outermost circumferential pixels) are illustrated, and similarly to FIGS. 10 to 12, the backward-path light (in this case, the reproduced light) together with the cover layer L1 and the recording layer L2 are illustrated in a folding manner at the opposite side with the reflecting plane as a boundary.

Herein, with respect to the light rays of the signal light that is allowed to illuminate at the time of recording, the light ray located at the uppermost portion in the figure is denoted by a, and the light ray located at the lowermost portion is denoted by b. In addition, with respect to the light rays of the reproduced light, the light ray located at the uppermost portion is denoted by B, and the light ray located at the lowermost portion is denoted by A.

In addition, on the real image plane SR, the condensing position (focus position) of the light ray a of the signal light is denoted by Pa, and the condensing position of the light ray b is denoted by Pb. Similarly, on the real image plane SR, the condensing position of the light ray A of the reproduced light is denoted by PA, and the condensing position of the light ray B is denoted by PB.

In FIG. 16, the light ray A′ in the figure denotes that the light ray A of the reproduced light is illustrated in an unfolded manner. Herein, the light ray A is a light ray that is parallel to the light ray a. In addition, in the coaxial type, the light ray a and the light ray b are allowed to illuminate the hologram recording medium HM at the same incident angle with the optical axis as a boundary. Therefore, the light ray A′ becomes a light ray that is parallel to the light ray b.

Herein, due to the property of the objective lens (convex lens), if the two parallel light rays pass through the objective lens 11, on the focus plane (herein, the real image plane SR) that are separated by the focus distance f, the condensing positions of the two light rays are coincident with each other. In other words, therefore, the condensing position Pb of the light ray b on the real image plane SR and the condensing position PA of the light ray A on the real image plane SR are coincident with each other.

In addition, this relationship is satisfied for the light ray a and the light ray B, so that the condensing position Pa of the light ray a on the real image plane SR and the condensing position PB of the light ray B on the real image plane SR are also coincident with each other.

According to this principle, even in the case where the focus position of the recording/reproduced light is shifted from the reflecting plane, the condensing position of the light rays of the backward-path light and the condensing position of the light rays of the forward-path light are coincident with each other on the real image plane SR.

The description is made with reference to FIG. 15 again.

The state where the condensing positions of the light rays of the backward-path light and the condensing positions of the light rays of the forward-path light are coincident with each other on the real image plane SR denotes that the condensing positions of the light rays on the real image plane SR are the same as those in the case in the related art.

Therefore, the reproduced image that is obtained on the real image plane SR at the time of reproducing is the same as that in the case in the related art (that is, the case where the focus position is set to be on the reflecting plane), so that the image sensor 13 properly detects the reproduced light like the case in the related art. In other words, there is no problem in that irregularity or a lack of sharpness of the reproduced image occurs due to non-coincidence of the light ray positions of the forward-path light and the backward-path light according to the shifting of the focus positions, and data reproducing may be properly performed.

In addition, as understood from the description hereinbefore, even in the case where the method of shifting the focus position is employed, as a configuration of the optic system for guiding the recording/reproduced light into the hologram recording medium HM and guiding the reproduced light obtained from the hologram recording medium HM into the image sensor 13, the configuration of the case in the related art is not necessarily changed except for the objective lens 11.

### 1-3. Result of Simulation

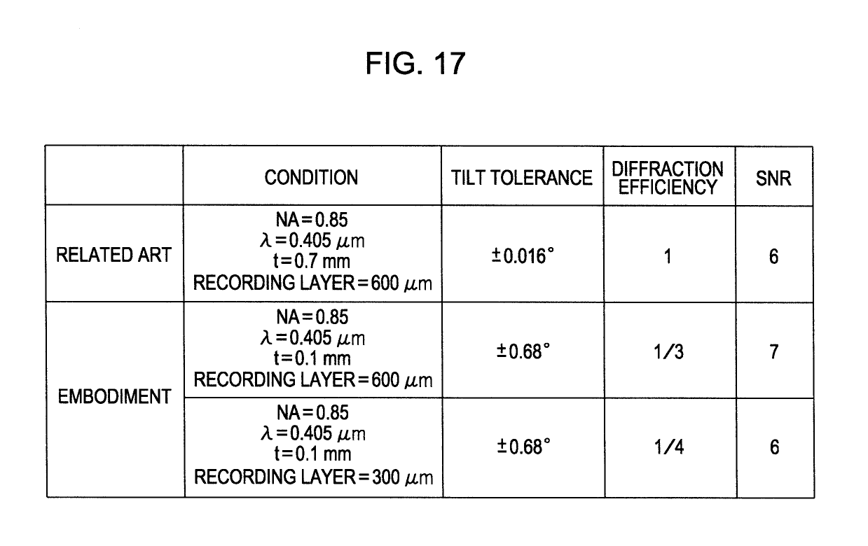

FIG. 17 illustrates a result of a simulation with respect to items of tilt tolerance, diffraction efficiency, and SNR (SN ratio) in the case where the shifting of the focus position according to the embodiment is performed.

In FIG. 17, in addition to the result of the simulation with respect to the items of the tilt tolerance, the diffraction efficiency, and the SNR (SN ratio) in the case where the shifting of the focus position according to the embodiment is performed, a result of the simulation with respect to the same items in the method in the related art where the focus position is set to be on the reflecting plane is illustrated as comparison.

Herein, in FIG. 17, with respect to the method according to the embodiment, the two results of the case where the thickness of the recording layer is set to 600 μm and the case where the thickness is set to a half thereof, that is, 300 μm are illustrated.

Detailed setting conditions of the NA of the objective lens and the wavelength λ, of the recording/reproduced light in the simulation are as follows.

NA=0.85

λ=0.405 μm,

The setting conditions of the case in the related art are the same as those of the embodiment.

In the case in the related art, a thickness of the cover layer L1 is 0.1 mm, and a thickness of the recording layer L2 is 0.6 mm, so that t=0.7 mm. However, in the case of the embodiment, the thickness of the cover layer L1 is 0.1 mm, but the focus position is located on the interfacial surface of the cover layer L1 and the recording layer L2, so that t=0.1 mm.

First, the tilt tolerance of the case in the related art is “+/−0.016°”, but the tilt tolerance in the embodiment is “+/−0.68°” in any of the case where the thickness of the recording layer L2 is set to 600 μm and the case where the thickness is set to 300 μm. Accordingly, the result that the tolerance is improved about 40 times in comparison with the case in the related art is obtained.

In addition, if the diffraction efficiency of the case in the related art is set to “1”, the diffraction efficiency of the case where the thickness of the recording layer L2 is set to 600 μm is “⅓”, and the diffraction efficiency of the case where the thickness of the recording layer L2 is set to 300 μm is “¼”.

Herein, the tendency that the diffraction efficiencies according to the embodiment deteriorate in comparison with the case in the related art is caused by the fact that the formed holograms are different from each other as compared in FIGS. 9 and 11. For example, as understood with reference to FIG. 9, in the case in the related art, the area of the recording layer L2 where the signal light and the reference light are overlapped with each other is set to be relatively large. In the case of the embodiment, as shown in FIGS. 10 and 11, for example, the area where the signal light and the reference light are overlapped with each other is set to be relatively small. Particularly, with respect to the backward path portion after the reflecting plane, since the signal light and the reference light are overlapped with each other in small portions, the diffraction efficiency deteriorates.

In addition, the deterioration in the diffraction efficiency according to the decrease in thickness of the recording layer L2 is caused by the fact that the thickness of the hologram is also decreased according to the decrease in the thickness of the recording layer L2.

However, with respect to the comparison of SNR, the performance thereof according to the embodiment is equal to or better than that of the case in the related art. More specifically, the SNR of the case in the related art is “6”, but the SNR of the case of the embodiment where the thickness of the recording layer L2 is set to 600 μm is “7”. In addition, even in the case where the thickness of the recording layer L2 is set to 300 μm, the SNR is “6”, so that the value thereof is equal to that of the case in the related art.

Herein, in the case in the related art, as shown in FIG. 9, the light flux of the signal light and the reference light are condensed on the reflecting plane. Next, the light flux condensed on the reflecting plane is allowed to return to the light ray area like the forward path. In other words, in the case in the related art, the same holograms at the forward path and the backward path are formed on the recording layer L2, and the depths of the holograms are equal to each other in the range from 0 to 0 to 600 μm in the embodiment.

On the other hand, in the case of the embodiment where the focus position is located on the upper layer side surface of the recording layer L2, as understood with reference to FIG. 10 or the like, the light flux of the signal light and the reference light continue to extend in the recording layer L2 though the forward path→the backward path. In other words, therefore, the depth of the hologram may be increased in comparison with the case in the related art (comparison of FIGS. 9 and 11). More specifically, in the case where the recording layer L2 is set to have a thickness of 600 μm, a hologram having a depth of 0 to 1200 μm may be recorded. In addition, in the case where the recording layer L2 is set to have a thickness of 300 μm, a hologram having a depth of 0 to 600 μm may be recorded.

In this case, high band information is contained in the portion separated from the focus position in the hologram formed on the recording layer. Therefore, if compared in terms of the condition of the same recording layer L2 having the thickness of 600 μm, in the case of the embodiment where a deeper hologram may be formed (that is, a hologram further separated from the focus position may be formed), higher band information may be recorded. In addition, in the case where the thickness of the recording layer L2 is set to 300 μm, high band information the same as that of the case in the related art may be recorded. As higher band information is recorded, clearer reproduced image may be formed.

Therefore, if the condition of the thickness of the recording layer is the same, the SNR of the case of the embodiment may be further improved in comparison with the case in the related art, and although the thickness of the recording layer is decreased by half, the SNR may be equal to that of the case in the related art.

### 1-4. Statistics

As described hereinbefore, according to the first embodiment, since the value of t that is defined as the “distance from the surface of the recording medium to the focus position of the recording/reproduced light” is configured to smaller than that of the case in the related art, the focus position of the recording/reproduced light is shifted, so that the occurrence amount W of coma aberration caused by the tilt may be suppressed. In other words, as a result, the tilt tolerance may be improved.

In addition, in the embodiment, since the occurrence amount W of coma aberration caused by the tilt is suppressed and since the method of allowing the value of NA is not employed, the tilt tolerance may be improved without a sacrifice of the recording/reproducing density of information.

In addition, in the embodiment, although the focus position of the recording/reproduced light is set to be on the interfacial surface of the cover layer L1 and the recording layer L2 (the upper layer side surface of the recording layer L2), the portion having a strong light intensity, where the light flux of the signal light and the reference light are narrowest, may be formed on the recording layer L2, so that there is an advantage in terms of the diffraction efficiency.

In addition, according to the aforementioned result of the simulation shown in FIG. 17, in the case where the thickness of the recording layer L2 according to the embodiment is set to 300 μm, the SNR has the same value as that of the case in the related art. In other words, even in the case where the thickness of the recording layer L2 is set to be smaller than that of the case in the related art (in the embodiment, the thickness is set to a half), the deterioration in the reproduction performance may be suppressed by shifting the focus position according to the embodiment.

As understood therefrom, according to the method of the embodiment, the thickness of the recording layer L2 may be smaller than that of the case in the related art (according to the result of the simulation, the thickness may be decreased by half). AS the thickness of the recording layer L2 may be decreased, the production costs for the hologram recording medium HM may be reduced according to the decrease in the thickness.

### 2. Second Embodiment

Now, a second embodiment is described. In the second embodiment, a configuration corresponding to the aperture 104 included in the recording and reproducing apparatus of the related art is added to the recording and reproducing apparatus according to the first embodiment shown in FIG. 1. More specifically, a configuration for implementing a hologram size reducing function for obtaining a high recording density at the time of recoding and a scattered light mixing detecting suppression function at the time of reproducing is also provided.

In addition, as described for the understanding, the hologram size contraction function for obtaining a high recording density by the aperture 104 denotes a function for reducing a size of a hologram by reducing a size of a spot on a focus plane by limiting an area of transmitting light with respect to the Fourier plane SF. In other words, by the hologram size reducing function, a recording density of the hologram may be improved. In addition, the scattered light mixing detecting suppression function at the time of reproducing is a function for suppressing a scattered light component detected by the image sensor 13 in order to solve the problem in that the scattered light component occurring from the hologram recording medium HM at the time of reproducing together with the reproduced light is guided into the image sensor 13 to be detected as a noise component. In other words, in the configuration of the related art, due to the aperture 104, the backward-path light passing through the Fourier plane SF may be only the light (most thereof is the component of the reproduced light) in the vicinity of the optical axes of the laser light. In other words, therefore, the component of the scattered light that is generated from the hologram recording medium HM and detected by the image sensor 13 may be greatly suppressed by the aperture 104.

Herein, in the recording and reproducing apparatus of the related art, as shown above in FIG. 13, since the forward-path light and the backward-path light are obtained at the light ray position, the Fourier plane SF and the backward-path conjugating plane SC that are formed by a relay lens system of the relay lenses 6 and 7 are formed at the same position in the forward path and the backward path, and the aperture 104 is merely inserted at the common position (or in the vicinity thereof), so that the hologram size contraction function at the time of recording and the scattered light mixing detecting suppression function at the time of reproducing may be implemented.

However, in the case of the embodiment where the focus position is shifted from the reflecting plane, as shown above in comparison with FIGS. 14 and 15, since the light ray positions of the forward-path light and the backward-path light are not completely coincident with each other, the Fourier plane SF and the backward-path conjugating plane SC are not formed at the same position. In this case, for example, it is assumed that the aperture 104 is inserted into the Fourier plane SF like the case of the related art. In this case, at the time of recording, since the light in the portion excluding the vicinity of the optical axis of the laser light among the signal light and reference light that are allowed to illuminate the hologram recording medium HM may be blocked like the case of the related art, the recording density may be improved. However, at the time of reproducing, since the reproduced light is blocked by the aperture 104 (refer to the relationship between the reproduced light and the Fourier plane SF in FIG. 15), the data reproducing may not be properly performed. On the other hand, if the aperture 104 is inserted into the backward-path conjugating plane SC, the signal light and the reference light at the time of recording are blocked, so that the data recording may not be properly performed. In addition, at the time of reproducing, since the reference light is also blocked, the data reproducing may not be properly performed. As understood from the description, in the case of employing the method of shifting the focus position like the embodiment, if the configuration where the aperture 104 is merely inserted is used like the case of the related art, the recording and reproducing operations may not be properly performed.

In consideration of the problem, in the second embodiment, even in the case of employing the method of shifting the focus position from the reflecting plane so as to improve the tilt tolerance, there is proposed a method capable of implementing the band limiting function for obtaining a high recording density at the time of recording and the scattered light mixing detecting suppression function at the time of reproducing, which are implemented by the aperture 104 of the related art.

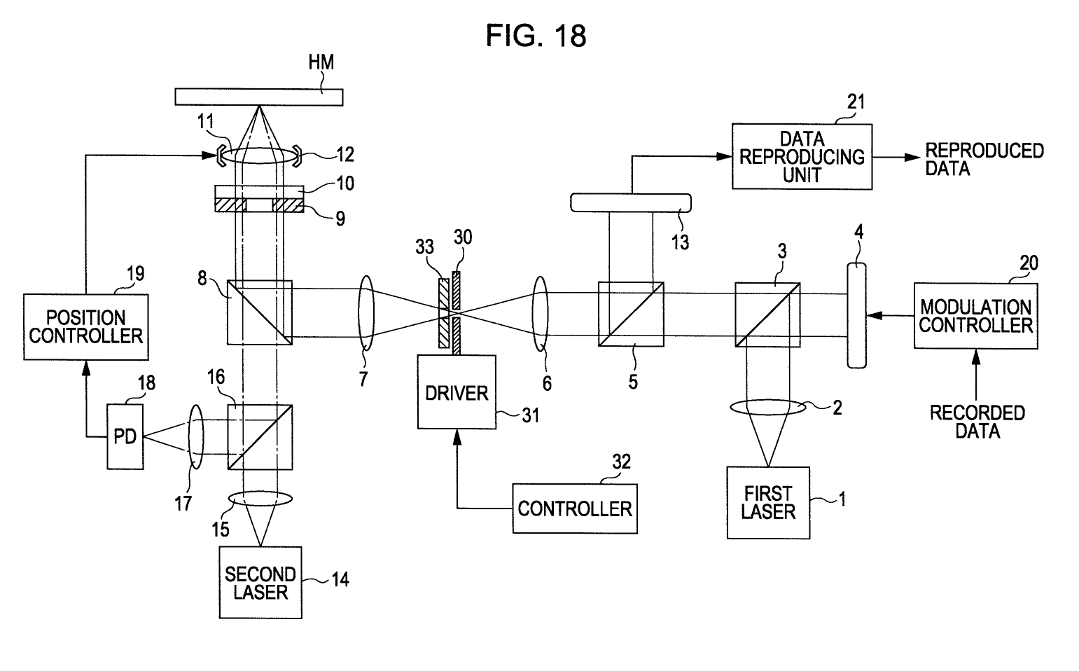

FIG. 18 illustrates an internal configuration of the recording and reproducing apparatus (light illuminating apparatus) according to the second embodiment. In addition, in FIG. 18, the same elements as those described above are denoted by the same reference numerals, and description thereof is omitted. As understood in comparison with FIG. 1 described above, in the recording and reproducing apparatus according to the second embodiment shown in FIG. 18, an aperture 30, a driver 31, and a controller 32, and a partial diffraction device 33 are added to the recording and reproducing apparatus according to the first embodiment.

The aperture 30 is constructed with a partial light-blocking device (partial light-transmitting device) where a hole portion (light transmitting hole) is formed in a predetermined area of a central portion thereof. The aperture 30 is supported so that the aperture may be inserted into the light path by the driver 31. The driver 31 is configured to include a driving force generator, for example, a motor or the like, which generates a driving force for inserting and drawing back the aperture 30 with respect to the light path and a driving mechanism unit which transmits the driving force generated by the driving force generator to the aperture 30. The driver 31 is driven to insert and draw back the aperture 30 with respect to the light path under the control of the controller 32.

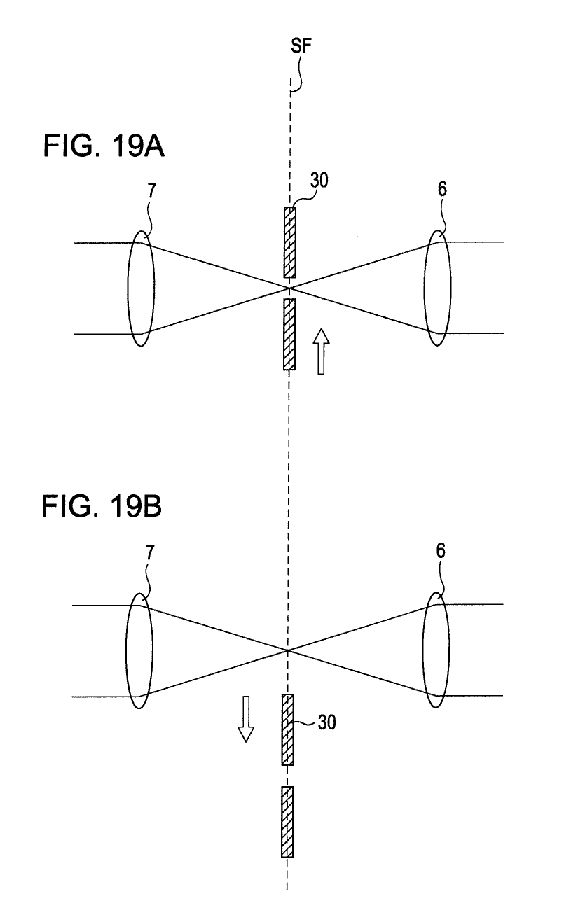

More specifically, as shown in FIGS. 19A and 19B, the driver 31 is driven to insert the aperture 30 into the light path at the time of recording and to drawn back the aperture from the light path at the time of reproducing. In this case, for example, the installation position of the driver 31 is adjusted so that an insertion position (insertion position in the direction parallel to the optical axis of the laser light) of the aperture 30 at the time of recording is on the Fourier plane SF (or a position in the vicinity thereof). Next, the controller 32 controls the driving direction or driving amount of the aperture 30 in the driver 31, so that the inserting operation and drawing-back operation for the aperture 30 at the time of recording and reproducing may be implemented. More specifically, the controller 32 controls the driving direction and driving amount of the aperture 30 so that the state where the center of the aperture 30 and the optical axis of the laser light are coincident with each other at the time of recording may be obtained. In addition, at the time of reproducing, by controlling the aperture 30 to be driven by a predetermined amount in a direction opposite to the driving direction of the time of recording, the state where the aperture 30 is drawn back from the light path may be obtained.

As shown in FIG. 19A, if the aperture 30 is inserted into the Fourier plane SF (or in the vicinity thereof) at the time of recording, the size of the recorded hologram (size of the bottom surface) may be reduced like the case of the related art, so that a high recording density may be implemented. In addition, in this case, at the time of reproducing, as shown in FIG. 19B, since the aperture 30 is drawn back from the light path, the aforementioned blocking of the reproduced light at the time of reproducing is prevented, so that the data reproducing may be properly performed.

In this manner, the configurations of the aperture 30, the driver 31, and the controller 32 are added, so that the data reproducing may be properly performed and so that the high recording density may be implemented due to the reduction in the hologram size at the time of recording.

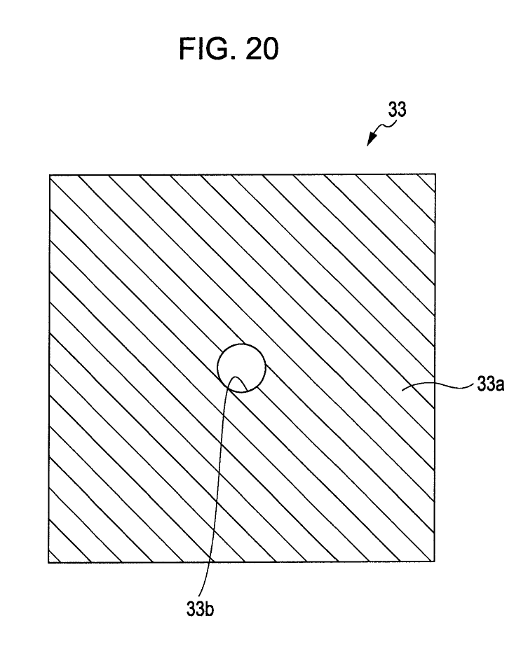

In addition, in the recording and reproducing apparatus according to the second embodiment, the scattered light mixing detecting suppression function at the time of reproducing is performed by the partial diffraction device 33 shown in FIG. 18. Similarly to the aforementioned partial diffraction device 9, partial diffraction device 33 is a device where a polarization selective diffraction device is partially formed. More specifically, as shown in FIG. 20, in the partial diffraction device 33, a predetermined area including the center thereof is a usual transmission area 33b, and the other area is a selective diffraction area 33a. The selective diffraction area 33a is constructed with the polarization selective diffraction device. In addition, the usual transmission area 33b is constructed with, for example, hole portions or the like as an area of transmitting the light irrespective of the polarization state of the incident light. The polarization selective diffraction device formed in the selective diffraction area 33a is also configured to transmit the p polarization and to diffract (suppress) the s polarization.

In the recording and reproducing apparatus according to the second embodiment, the partial diffraction device 33 is fixedly inserted into the backward-path conjugating plane SC (or a position in the vicinity thereof). In this case, the insertion position in the plane perpendicular to the optical axis of the laser light is set so that the center of the partial diffraction device 33 is coincident with the optical axis of the laser light.

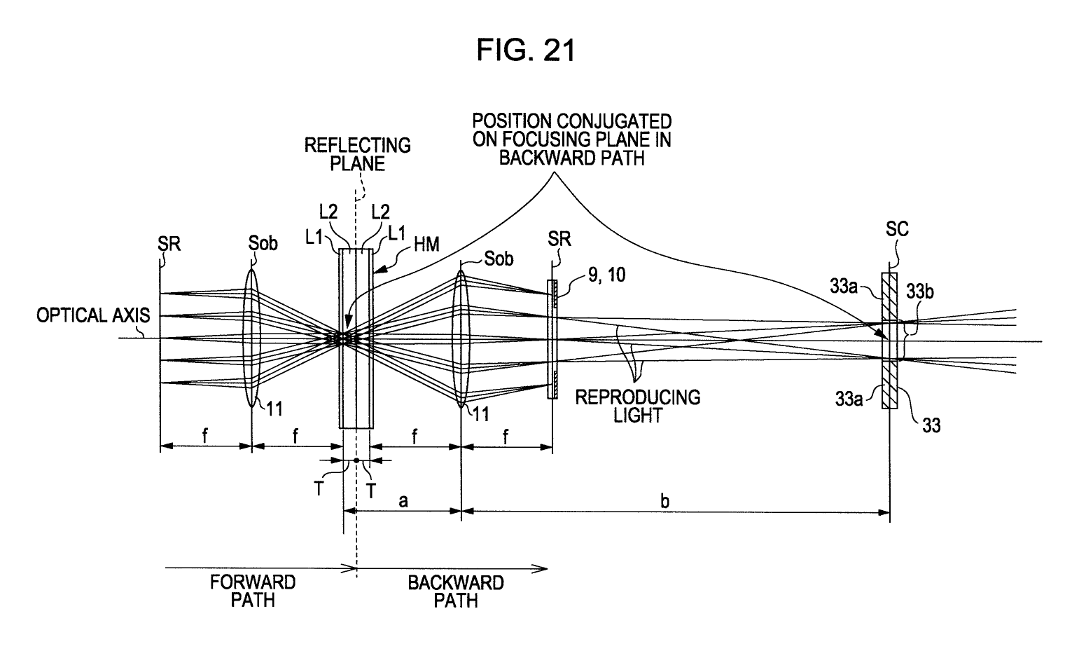

Herein, the “backward-path conjugating plane SC” is a plane defined by a “position conjugated with the focus plane in the backward path”. This is described with reference to FIG. 21 as follows. FIG. 21 illustrates the hologram recording medium HM (only the cover layer L1 and the recording layer L2 are extracted), the objective lens 11, the partial diffraction device 9, the ¼ wavelength plate 10, and the partial diffraction device 33, which are extracted from the configurations shown in FIG. 18, and the behavior of each light ray of the reference light and the reproduced light at the time of reproducing. In addition, in this case, the forward-path light (and the cover layer L1, the recording layer L2, and the objective lens 11) are repetitively illustrated in the opposite side at the reflecting plane as a boundary similarly to FIGS. 9 to 12 described above.

As shown in the figure, a distance from the focus plane (focus plane of the objective lens 11) of the recording/reproduced light to the reflecting plane of the hologram recording medium HM is set to T. In addition, after the recording/reproduced light is condensed on the focus plane, a distance that is taken by the light until the light is incident again to the objective lens 11 through the reflecting plane, as the distance from the focus plane to the pupil plane Sob of the objective lens 11 (the center of the objective lens 11), is set to a. In addition, a distance from the pupil plane Sob of the objective lens 11 to the backward-path conjugating plane SC is set to b. In addition, in this case, the focus distance of the objective lens 11 is also f.

Herein, since the backward-path conjugating plane SC has a relationship of conjugation to the focus plane of the recording/reproduced light, if the values of the a, b, and f are defined as described above, the lens formula shown in the following Equation 1 is satisfied.

$$\frac{1}{a} + \frac{1}{b} = \frac{1}{f} \qquad [ Equation 1 ]$$

Herein, if an refractive index of the hologram recording medium HM is set to n, as clearly understood from the figure, the distance a is obtained as follows.

$$a = f + \frac{2 T}{n} \qquad [ Equation 2 ]$$

By substituting Equation 2 into Equation 1, the following Equation 3 is obtained.

$$\frac{1}{f + \frac{2 T}{n}} + \frac{1}{b} = \frac{1}{f} \qquad [ Equation 3 ]$$

By solving Equation 3 with respect to the distance b, the following Equation 4 is obtained.

$$\begin{matrix}\frac{1}{b} = - \frac{1}{f + \frac{2 T}{n}} + \frac{1}{f} \\ = \frac{- f + f + \frac{2 T}{n}}{f ( f + \frac{2 T}{n} )} \\ = \frac{\frac{2 T}{n}}{f ( f + \frac{2 T}{n} )}\end{matrix} \qquad [ Equation 4 ]$$

Therefore, the value of the distance b is obtained by the following Equation 5.

$$b = \frac{f ( f + \frac{2 T}{n} )}{\frac{2 T}{n}} = \frac{{f}^{2}}{\frac{2 T}{n}} + f \qquad [ Equation 5 ]$$

In this manner, as the pupil plane Sob of the objective lens 11 is selected as the reference, the backward-path conjugating plane SC is formed at the position that may be defined by Equation 5 with respect to the relationship among the distance T from the reflecting plane of the hologram recording medium HM to the focus position (that is, the focus position shifting amount in the related art), the refractive index n of the hologram recording medium HM, and the focus distance f.

Herein, as shown in FIG. 21, the partial diffraction device 33 is configured so that the usual transmission area 33b formed at the center thereof allows each light ray to usually transmit only the portion of the backward-path conjugating plane SC where each light ray is condensed. In other words, the size of the usual transmission area 33b is set to be equal to the size of the spot formed by each light ray that is condensed on the backward-path conjugating plane SC. In addition, in the case where the partial diffraction device 33 is disposed at the position in the vicinity of the backward-path conjugating plane SC, the size of the usual transmission area 33b may be optimized according to the separation distance from the conjugating plane SC.

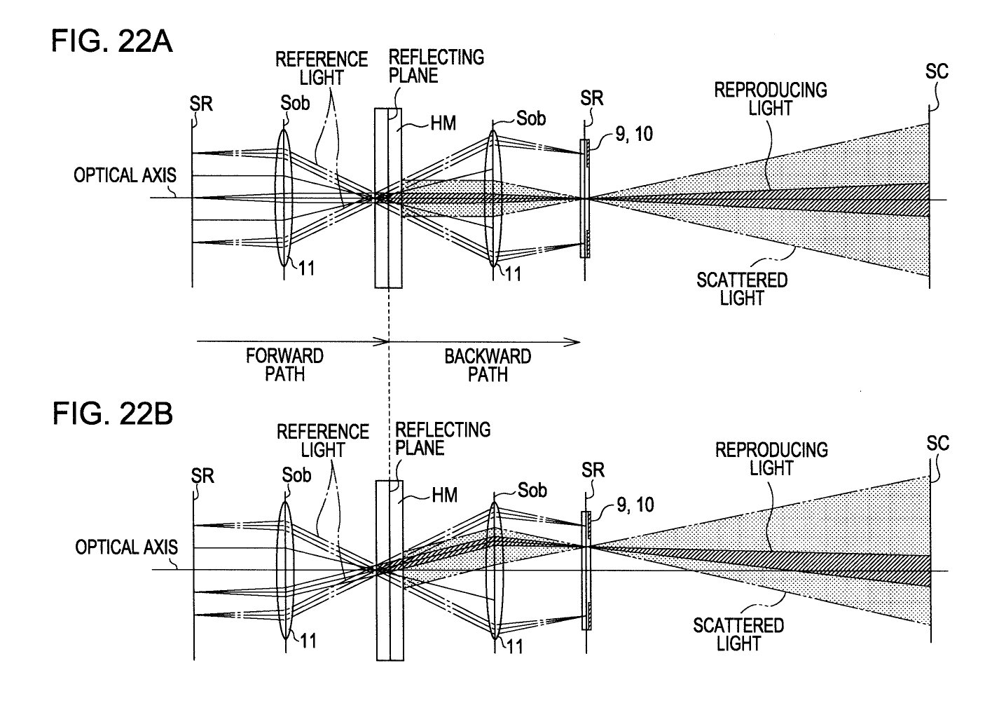

FIGS. 22A and 22B are diagrams exemplifying the occurrence behavior of the scattered light from the hologram recording medium HM. In addition, FIGS. 22A and 22B illustrate the objective lens 11, the hologram recording medium HM, the partial diffraction device 9, and the ¼ wavelength plate 10, which are extracted from FIG. 18 described above, and the behavior of the light rays of the reference light, which is allowed to illuminated at the time of reproducing, and the scattered light generated according to the illumination of the reference light. Similarly to FIG. 21 described above, the figure also repetitively illustrates the forward-path light in the opposite side at the reflecting plane as a boundary.

FIG. 22A illustrates the behavior of the reproduced light of the pixel at the central portion including the optical axis of the laser light and the scattered light proceeding in the same direction, and FIG. 22B illustrates the behavior of the reproduced light of the pixel in the outermost circumference portion and the scattered light proceeding in the same direction. As clearly understood from the figures, the scattered light generated in the light ray area of the reproduced light may not be suppressed by the partial diffraction device 9 for preventing the detection of the reflected reference light, so that the scattered light is guided through the backward-path conjugating plane SC into the image sensor 13 (not shown).

According to the aforementioned partial diffraction device 33, the amount of the scattered light that is guided into the image sensor 13 may be effectively suppressed. Similarly to the recording and reproducing apparatus shown above in FIG. 1, in the recording and reproducing apparatus shown in FIG. 18, the polarization direction of the backward-path light passing through the ¼ wavelength plate 10 becomes the s polarization. As described above, the selective diffraction area 33a of the partial diffraction device 33 is constructed with the polarization selective diffraction device of transmitting the p polarization and suppressing the s polarization. Therefore, most of the scattered light from the hologram recording medium HM (that is, the most of the portions excluding the portion overlapped with the reproduced light) is suppressed by the selective diffraction area 33a of the partial diffraction device 33, so that the scattered light may not be guided into the image sensor 13. As a result, the noise component caused by the scattered light may be greatly suppressed.

In addition, in this manner, since the selective diffraction area 33a of the partial diffraction device 33 is configured to selectively transmit the p polarization, the partial diffraction device 33 transmits the entire incident light of the forward path. Therefore, the signal light and the reference light at the time of recording and the reference light at the time of reproducing are allowed to properly illuminate the hologram recording medium HM, so that the recording and reproducing operations may properly performed.

In this manner, due to the partial diffraction device 33, the signal light and the reference light at the time of recording and the reference light at the time of reproducing are allowed to properly illuminate the hologram recording medium HM, so that the recording and reproducing operations may properly performed; and the amount of the scattered light that is guided into the image sensor 13 may be effectively suppressed.

As described above, in the recording and reproducing apparatus according to the second embodiment, by inserting and drawing back the aperture 30 with respect to the Fourier plane SF at the time of recording and reproducing in response to the shifting of the focus position, the recording and reproducing operations may be properly performed, and a high recording density due to the reduction in size of the hologram may be obtained.

In addition, by providing the partial diffraction device 33 for selectively suppressing only the light in the portion excluding the central portion of the backward-path light on the backward-path conjugating plane SC (or in the vicinity thereof), the noise component caused by the scattered light may be effectively suppressed, so that the performance of reproducing may be improved. Due to the suppression of the noise component, the laser power of the first laser 1 is designed to be small. Accordingly, advantages of a reduction in the power consumption or a reduction in product costs of the apparatus due to the implementation of a small-sized laser may be expected. In addition, due to the suppression of the noise component, data transmission rate may be improved.

### 3. Third Embodiment

A third embodiment is to further improve tolerance. Herein, in a recording and reproducing apparatus according to the third embodiment, since the elements illustrated in the block diagram are the same as those in FIG. 1, the description thereof is omitted.

### 3-1. Extension of Minimum Modulation Unit of Reference Light

In the recording and reproducing apparatus according to the third embodiment, with respect to the spatial light modulation (intensity modulation) for generating the reference light in the first embodiment described above, the minimum modulation unit is further extended in comparison with the case of the first embodiment. In other words, in the first embodiment, both of the signal light area A2 and the reference light area A1 are allocated with ON/OFF patterns (patterns having a change in polarization direction of 90°/0° with respect to the SLM 4) in units of pixels, and the minimum modulation unit for the spatial light modulation is set to the 1×1 pixel. However, in the third embodiment, only with respect to the reference light area A1, the minimum modulation unit of the spatial light modulation is extended to be larger than the 1×1 pixel.

### DETAILED EXAMPLES OF EXTENSION METHOD

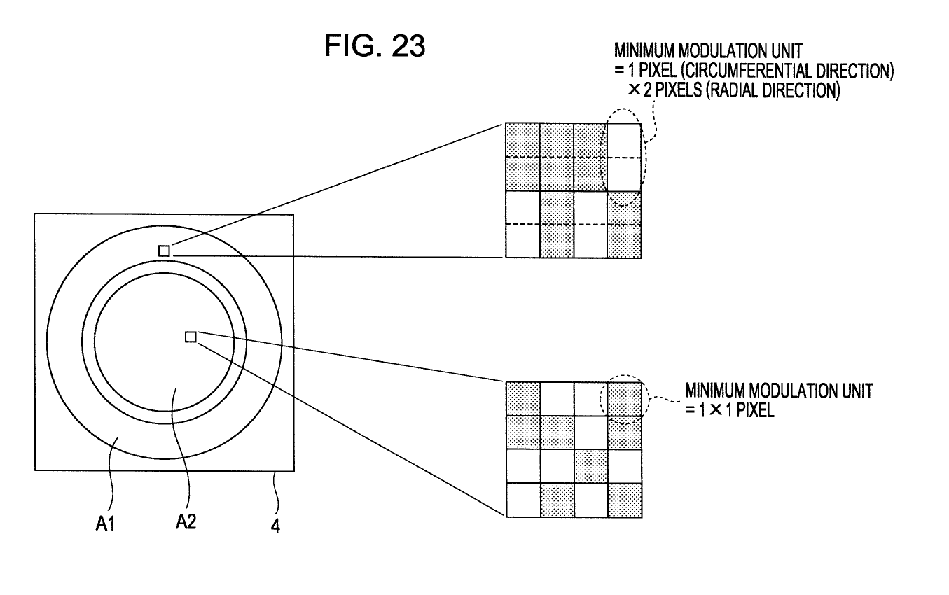

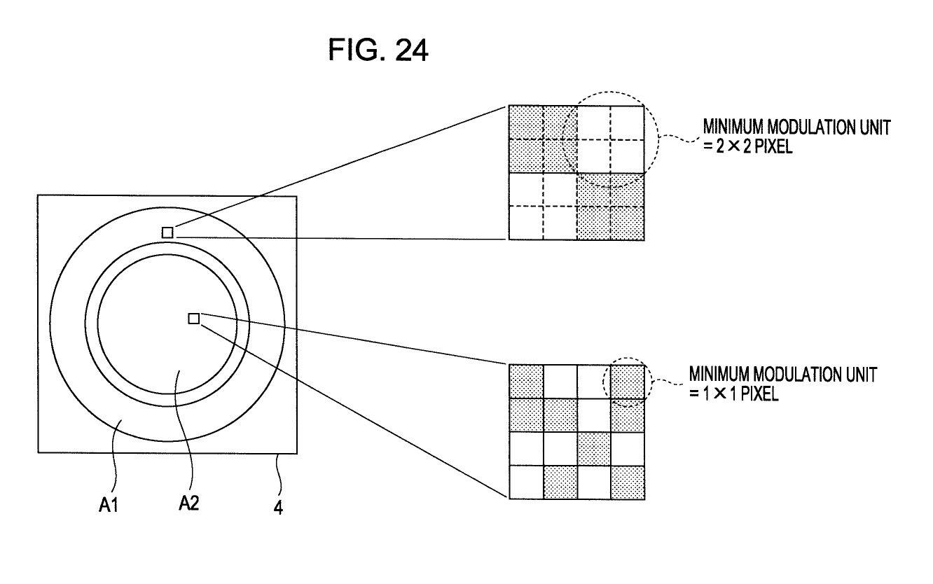

FIGS. 23 and 24 illustrate examples of extension of the minimum modulation unit. FIG. 23 illustrates an example of the case where the minimum modulation unit is allowed to extend only in the radial direction, and FIG. 24 illustrates an example of the case where the minimum modulation unit is allowed to extend in the radial direction and in the circumferential direction. In addition, in the figures, the SLM 4 and the reference light area A1, the signal light area A2 are illustrated, and the enlarged diagram of the 4×4 pixel area in each of the reference light area A1 and the signal light area A2 are also illustrated.

In the aforementioned cases, in the signal light area A2, as shown in FIGS. 23 and 24, the minimum modulation unit of the spatial light modulation is set to the 1×1 pixel. FIG. 23 illustrates the example where the minimum modulation unit of the spatial light modulation in the reference light area A1 is set so that (number of radial direction pixels)×(number of circumferential direction pixels)=2×1 as an example of extending the minimum modulation unit only in the radial direction. In addition, as described for the better understanding, the aforementioned “radial direction” and “circumferential direction” denote the radial direction and the circumferential direction of the modulation area in the case where the area (a substantially circular area) extending from the signal light area A2 into the reference light area A1 in the SLM 4 is treated as the modulation area.

In addition, FIG. 24 illustrates the example where the minimum modulation unit of the spatial light modulation in the reference light area A1 is set so that (number of radial direction pixels)×(number of circumferential direction pixels)=2×2 as an example of extending the minimum modulation unit in the radial direction and the circumferential direction.

In addition, alternatively, the direction of extending the minimum modulation unit may be set to only the circumferential direction.

Herein, in the case where the extension of the minimum modulation unit is performed only in one of the radial direction and the circumferential direction, it is necessary to take into consideration that an area, where the pixel arrangement direction in the SLM 4 is not coincident with the “radial direction” or the “circumferential direction”, exists. In other words, although FIG. 23 illustrates only the enlarged diagram of the area where the pixel arrangement direction in the SLM 4 is coincident with the “radial direction” or the “circumferential direction”, for example, at the position or the like proceeding at the angle of 45° from the extending area in the circumferential direction, the pixel arrangement direction is not coincident with the “radial direction” or the “circumferential direction”. In such a portion, as shown in the enlarged view of FIG. 23, although a plurality of the pixels adjacent to each other in the longitudinal direction is set as the minimum modulation unit, the minimum modulation unit is not allowed to extend in the radial direction. In addition, this description is the same with respect to the circumferential direction. In this manner, in the area where the pixel arrangement direction in the SLM 4 is not coincident with the “radial direction” or the “circumferential direction”, for example, by using the pixels adjacent to each other in the tilt direction, the extending direction of the minimum modulation unit may be coincident with the “radial direction” or the “circumferential direction” in a pseudo manner.

For example, as shown in FIGS. 23 and 24, the extension of the minimum modulation unit of the reference light according to the third embodiment is implemented by the control of driving the SLM 4 by the modulation controller 20. In other words, in the third embodiment, the ON/OFF pattern allocated to the reference light area A1 is set to a predetermined pattern so that the minimum modulation unit is allowed to extend in the radial direction or the circumferential direction or in both of the radial direction and the circumferential direction. The modulation controller 20 controls driving each pixel of the reference light area A1 in the SLM 4 based on the predetermined pattern. Therefore, in response to the predetermined ON/OFF pattern, the minimum modulation unit of the spatial light modulation in the reference light area A1 is allowed to extend in the radial direction or the circumferential direction or in both the radial direction and the circumferential direction.

Functions and Effects of Extension of Minimum Modulation Unit

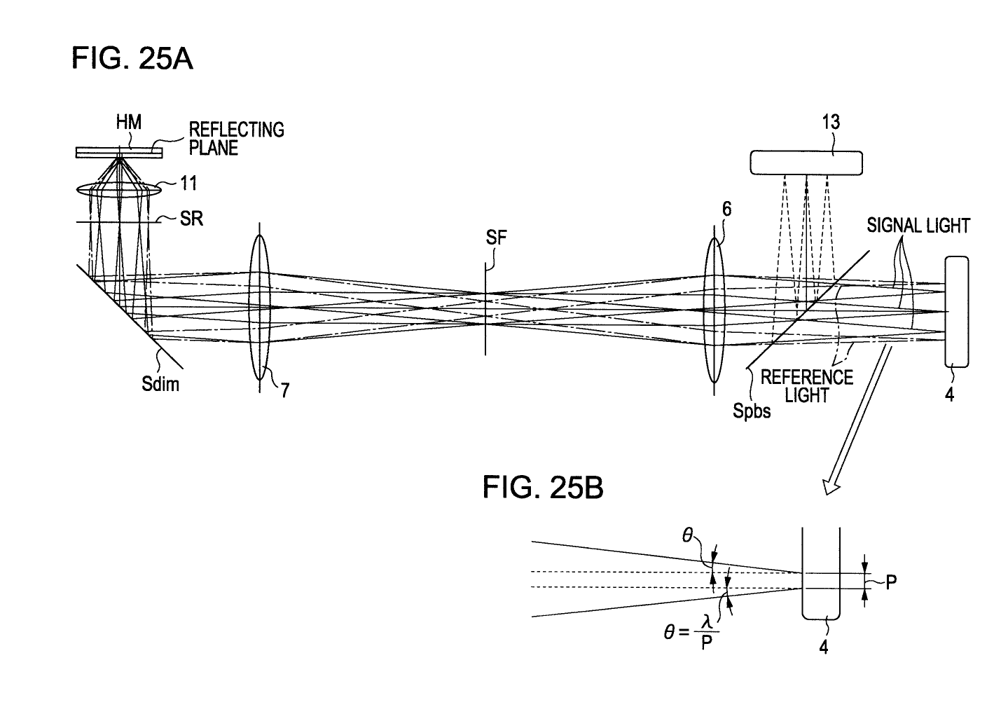

Now, functions that may be obtained by the extension of the minimum modulation unit of the spatial light modulation are described with reference to FIGS. 25A and 25B to 27. FIGS. 25A and 25B are diagrams illustrating the behavior of light in the entire optic system in the case where the minimum modulation unit of the reference light is allowed to extend. In FIG. 25A, similarly to FIG. 14 or the like, the SLM 4, the relay lenses 6 and 7, the objective lens 11, the hologram recording medium HM (and reflecting plane), the image sensor 13, and the planes Spbs, SF, Sbim, and SR are illustrated, and the behavior of the light ray of the signal light and the light rays of the reference light (all the light is the forward-path light) is illustrated. In addition, FIG. 25B illustrates the enlarged the behavior of the light ray emitted from one pixel of the SLM 4.

If the minimum modulation unit of the spatial light modulation in the SLM 4 is allowed to extend beyond the 1×1 pixel, an emitting angle θ shown in FIG. 25B is small. In other words, due to the extension of the minimum modulation unit, the spreading of each light ray emitted from the SLM 4 is small. Herein, as shown in FIG. 25B, if the pixel size of the spatial light modulator (in this case, the SLM 4) is denoted by P and if the wavelength of the incident light to the spatial light modulator is denoted by the λ, the emitting angle θ is expressed as “θ=λ/P”. Therefore, if the minimum modulation unit is allowed to extend (in other words, if the value of the P is large), the emitting angle θ is small.

As a result, due to the extension of only the minimum modulation unit of the reference light according to the example, as shown in FIG. 25A, the width of the light ray of the signal light in the optic system is equal to that of the case of the first embodiment, and the width of the light ray of the reference light is smaller than that of the case of the first embodiment.

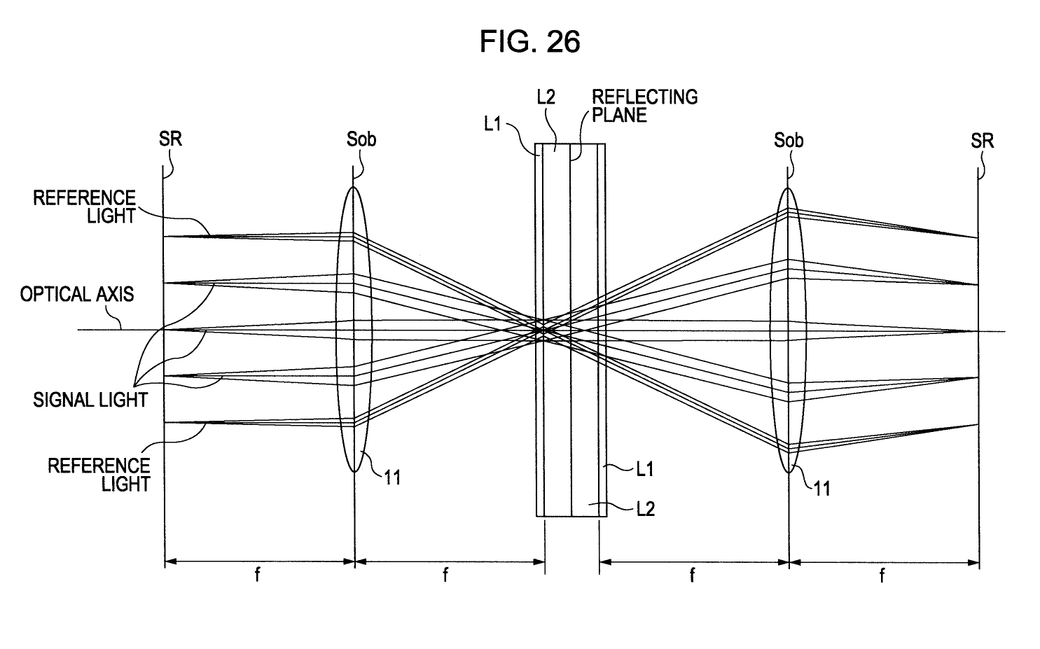

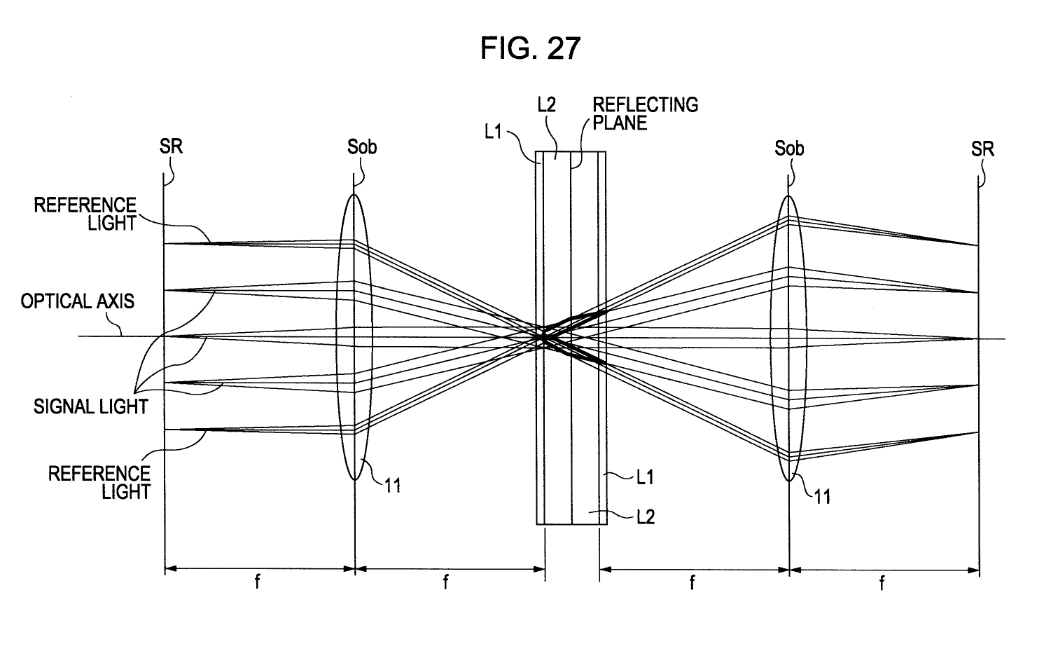

FIG. 26 is a diagram illustrating the behavior of each light ray of the signal light and the reference light that are allowed to illuminate the hologram recording medium HM in the case of the third embodiment, and FIG. 27 is a diagram illustrating a hologram formed in response to the illumination of the signal light and the reference light. In addition, similarly to FIGS. 10 and 11, FIGS. 26 and 27 illustrate the hologram recording medium HM (the cover layer L1, the recording layer L2, and the reflecting plane), the objective lens 11, the real image plane SR, and the pupil plane of the objective lens 11. In addition, in the description hereinafter, it is assumed that the extension of the minimum modulation unit of the reference light is performed in both of the radial direction and the circumferential direction.

First, as shown in FIG. 26, in this case, each light ray of the reference light is allowed to be thin, the size of the spot formed by condensing each light ray of the reference light on the focus plane is smaller than the size of the spot formed by condensing each light ray of the signal light. In addition, if each light ray of the reference light is allowed to be thin, the area of the recording layer L2, where the signal light and the reference light are overlapped with each other, is also small (comparing with FIG. 10).

Due to the factor, as shown in FIG. 27, the width of the hologram formed in this case is smaller than that in the case of the first embodiment (comparing with FIG. 11). In addition, as understood from the configuration that the area of the recording layer L2, where the signal light and the reference light are overlapped with each other, is small, the thickness of the hologram in this case is smaller than that in the case of the first embodiment.

Since the thickness of the hologram is small, the so-called Bragg's selectivity is improved. The improvement of the Bragg's selectivity denotes the improvement of the tilt tolerance.

In addition, if the Bragg's selectivity is improved, a temperature tolerance is also improved. The temperature tolerance denotes tolerance according to a change in temperature of the media. Herein, for example, as disclosed in Japanese Unexamined Patent Application Publication No 2006-349831 or the like, a change in volume (expansion/contraction) of the recording layer L2 occurs according to the change in temperature of the media. In this case, since the change in volume mainly occurs in the thickness direction, the change occurs according to the change in temperature in the direction of formation of the interference fringe as the hologram. Therefore, in the case where there is a difference in temperature of the media between the time of recording and the time of reproducing, although the same reference light as that of the time of recording is allowed to illuminate, since there is a relative difference between the direction of formation of the interference fringe and the incident angle of the reference light, the diffraction efficiency is lowered, so that the reproducing may not properly be performed.

If the Bragg's selectivity is improved, the range of allowing the relative difference between the direction of formation of the interference fringe and the incident angle of the reference light according to the change in the temperature is widened. Therefore, according to the third embodiment, the temperature tolerance is improved.

In addition, particularly, by extending the minimum modulation unit of the reference light in the circumferential direction, the eccentricity tolerance is also improved. Herein, in the case where the hologram recording medium HM has an eccentricity, the rotation of the hologram (the rotation about the optical axis) exists in response to the rotation of the medium. If the minimum modulation unit of the reference light (that is, each pattern in the reference light) is allowed to extend in the circumferential direction, the range capable of tracking each pattern according to the rotation of the hologram about the optical axis is widened. Accordingly, the eccentricity tolerance is improved.

In addition, as described for the better understanding, with respect to the improvement of the tilt tolerance, it is necessary to set the extension direction of the minimum modulation unit to both of the radial direction and the circumferential direction. This is because, in the case where the minimum modulation unit is allowed to extend only in one of the radial direction and the circumferential direction, the trackability to the tilt may be improved only by a portion of the pattern in the reference light. In other words, in this case, since the trackability of the pattern is improved only by the portion where the direction of extending the pattern and the direction of occurrence of the tilt correspond to each other, the improvement of the tilt tolerance denotes that the extension of the minimum modulation unit in the two-dimensional direction, that is, the extension in both of the radial direction and the circumferential direction is effective. In this case, the extension ratios in the radial direction and the circumferential direction may be equal to each other or different from each other.

On the other hand, with respect to the temperature tolerance, based on the relationship that the change in the direction of formation of the interference fringe according to the change in temperature from the time of recording occurs isotropically about the optical axis as the center thereof, the improvement of the tolerance may be implemented only by extending the minimum modulation unit in the radial direction.

Limitation in Extension Ratio

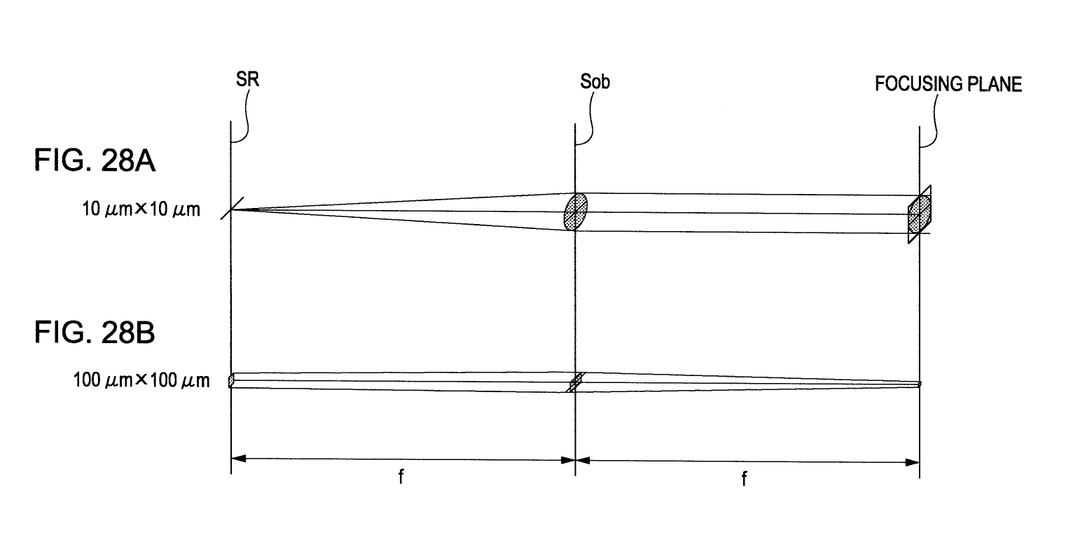

Herein, as understood from the description hereinbefore, as the extension ratio of the minimum modulation unit is larger, the tolerance may be further improved. However, if the extension ratio is set to be too large, the recording and reproducing of the hologram may not properly be performed. This relationship is described with reference to FIGS. 28A and 28B.

FIGS. 28A and 28B illustrate the behavior of light rays that proceed from the real image plane SR through the pupil plane Sob of the objective lens 11 to the focus plane. FIG. 28A illustrates the behavior of the light ray in the case where the pixel size in the SLM 4 is set to 10 μm×10 μm, and FIG. 28B illustrates the behavior of the light ray in the case where the pixel size in the SLM 4 is set to 100 μm×100 μm.

As described above, the emitting angle θ of each light ray from the SLM 4 is expressed by “θ=λ/P”. Therefore, in the case of FIG. 28B where the pixel size is set to be large, the light ray is less spread than the case of FIG. 28A where the pixel size is set to be small, and thus, in the case of FIG. 28B, the width of the light ray at the time of being incident to the objective lens 11 (the pupil plane Sob in the figure) is allowed to be small. In addition, accordingly, in the focus plane, the width of the light ray in the case of FIG. 28B is allowed to be small.

As clarified from the relational equation “θ=λ/P”, if the value of the P representing the pixel size is set to be too large, the spreading of the light ray almost disappears. For example, as shown in FIG. 28B, in the case where the pixel size is set to be too large, for example, 100 μm×100 μm, the light incident to the objective lens 11 becomes nearly in the state of a parallel light, and thus, the light ray proceeding through the objective lens 11 to the focus plane does not becomes a parallel light like the case of FIG. 28A, but it converges. As shown in FIGS. 10 to 12, in order to obtain the proper recording and reproducing operations, it is ideal that each light ray of the reference light (and signal light) condensed through the objective lens 11 is a parallel light. Therefore, in the case where the pixel size is set to be too large as shown in FIG. 28B, the recording and reproducing of the hologram may not properly be performed.

Herein, according to a simulation, it is found out that, if the value of the pixel size P is up to about 100 times the wavelength λ, the light ray that is allowed to illuminate the hologram recording medium HM through the objective lens 11 may maintain the state of the parallel light. In other words, like the example, in the case where the wavelength is set to λ=405 nm (0.405 μm), the limit of the value of the pixel size P is about 40 μm. For example, if one pixel of the SLM 4 has a size of 10.0 μm×10.0 μm, the limit of the extension ratio is about four times.

Based on this point, in a practical case, the extension of the minimum modulation unit of the reference light is performed within the range satisfying a condition that “P is equal to or less than about 100 times λ”. In other words, in the third embodiment, the ON/OFF pattern, which the modulation controller 20 uses to generate the reference light, is set so that the condition is satisfied.

### 3-2. Shifting Focus Position for Suppressing DC Concentration

As described above, according to the extension of the minimum modulation unit of the reference light, the size of the condensed spot of the reference light on the focus plane may be smaller than that of the case of the first embodiment. As understood from the description, the third embodiment is more advantageous than the first embodiment in terms of the diffraction efficiency.

However, since the size of the condensed spot is small, at the time of recording, a signal having a stronger light intensity than that of the first embodiment is recorded in the vicinity of the focus plane. This is the so-called DC concentration. In the case where such a DC concentration occurs, there is an advantage in terms of the diffraction efficiency, but the SN ratio tends to deteriorate. This is because, if the strong portion occurs in the light intensity as described above, unsharpness (noise) is formed in the reproduced image by the reproduced light.

As understood from the description, in the case where the method of extending the minimum modulation unit of the reference light is employed in order to further improve the tolerance, the diffraction efficiency is improved, but the SN ratio deteriorates. As a result, the reproduction performance deteriorates.

In consideration of this point, in the third embodiment, the method of extending the minimum modulation unit of the reference light is employed, and at the same time, a method of shifting the focus position of the recording/reproduced light to an upper layer side that is above the upper layer side surface of the recording layer L2.

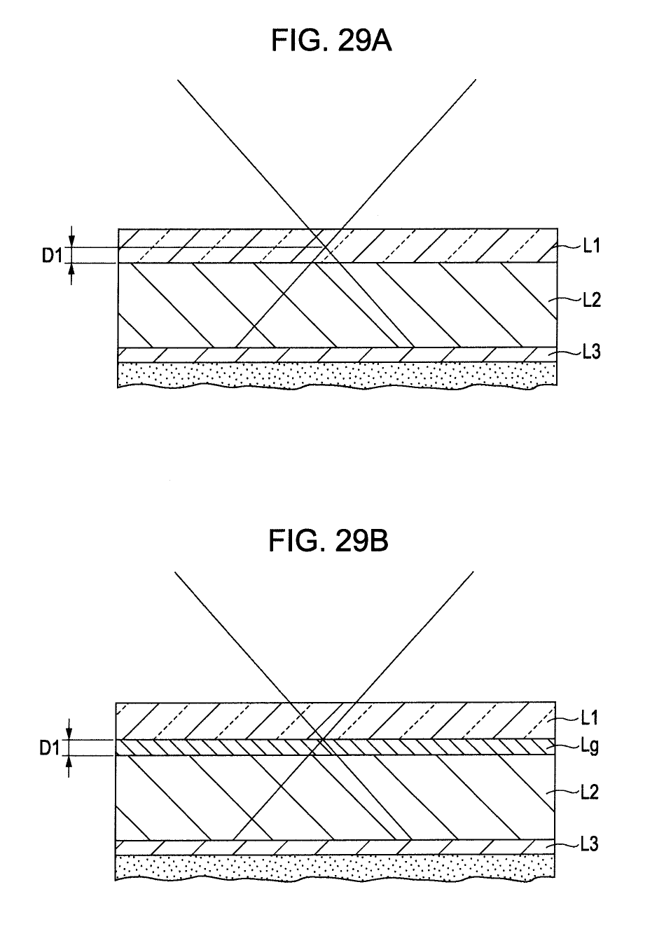

FIG. 29 illustrates an example of shifting the focus position in order to suppress the deterioration in the SN ratio caused by the DC concentration.

As an example, as shown in FIG. 29A, a position on the cover layer L1 that is separated by a predetermined distance D1 from the recording layer L2 is set to the focus position.

Alternatively, as shown in FIG. 29B, by inserting a gap layer Lg having a thickness D1 between the cover layer L1 and the recording layer L2 of the hologram recording medium HM, an interfacial surface of the gap layer Lg and the cover layer L1 may be set to the focus position.

In addition, as described for the better understanding, similarly to the first embodiment, the adjustment of the focus position of the recording/reproduced light may be performed, for example, by adjusting a separation distance between the objective lens and the hologram recording medium HM. In addition, in this case, if necessary, spherical aberration may be corrected by adjusting a thickness of a lens having the largest curvature (lens LZ 5 in FIG. 8B) of the objective lens.

For example, as shown in FIGS. 29A and 29B, by shifting the focus position of the recording/reproduced light to the upper layer side that is above the recording layer L2, the DC concentration in the recording layer L2 may be effectively suppressed. As a result, the deterioration in the SN ratio occurring according to the extension of the focus position of the recording/reproduced light may be suppressed.

Herein, since the shifting of the focus position to the upper layer side that is above the recording layer L2 lead to the weakening of the light intensity of the reference light in the recording layer L2, the diffraction efficiency deteriorates.

However, as described above, in the third embodiment, due to the extension of the minimum modulation unit of the reference light, the diffraction efficiency is improved in comparison with the first embodiment. Accordingly, the deterioration in the diffraction efficiency according to the shifting of the focus position is compensated for by the improvement of the diffraction efficiency according to the extension of the minimum modulation unit.

In addition, the same description is made for the SN ratio. In other words, as described above, the extension of the minimum modulation unit leads to the deterioration in the SN ratio, but the deterioration in the SN ratio is compensated for by the shifting of the focus position.

In this manner, according to the third embodiment combining the extension of the minimum modulation unit and the shifting of the focus position for suppressing the DC concentration, the deterioration in the diffraction efficiency and the deterioration in the SN ratio are compensated for each other, so that the diffraction efficiency and the SN ratio may be maintained at the same levels as those of the case of the first embodiment.

In other words, in comparison with the first embodiment, in the third embodiment, the diffraction efficiency and the SN ratio are maintained to be the same levels as those of the first embodiment, and the various tolerances may be further improved by the extension of the minimum modulation unit of the reference light.

Herein, as described for the better understanding, in the third embodiment, the SN ratio and the diffraction efficiency are determined by the value of the separation distance D1 between the focus position of the recording/reproduced light and the recording layer L1. In other words, in the third embodiment, a valance of the diffraction efficiency and the SN ratio is properly set according to the value of the D1.

### 3-3. Result of Simulation

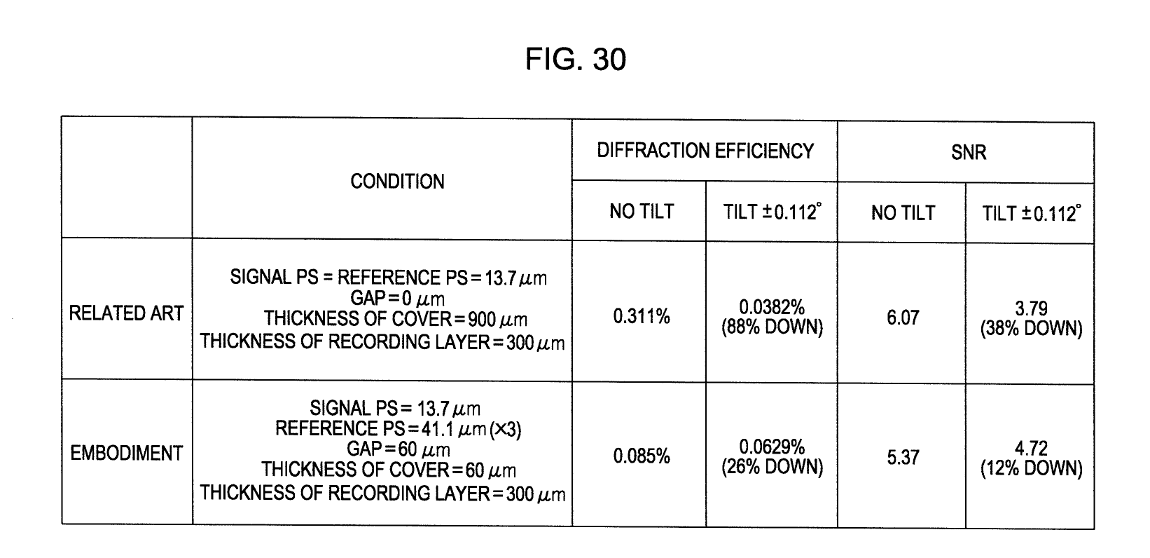

FIG. 30 illustrates a result of the simulation in the third embodiment.

As the items of the simulation, four items, that is, diffraction efficiency of the case where there is no tilt and diffraction efficiency of the case where there is a tilt) (TILT=+/−0.112°) and SNR of the case where there is not tilt and SNR of the case where there is a tilt are shown in the figure.

In addition, FIG. 30 also illustrates the result of the simulation of the items in the example of the related art as a comparison.

In addition, common parameters set for the simulation in the example of the related art and the example of the embodiment are as follows.
NA of Objective Lens, NA=0.64
Focus Distance, f=5 mm
Wavelength, λ=0.405 μm

In addition, parameters set in the example of the related art are as follows.
(Signal Light Pixel Size)=(Reference Light Pixel Size)=13.7 μm (in both of the radial direction and the circumferential direction)
(Thickness of Gap Layer Lg)=0 μm
(Thickness of Cover Layer L1)=900 μm
(Thickness of Recording Layer L2)=300 μm

Parameters set in the example of the embodiment are as follows.
(Signal Light Pixel Size)=13.7 μm (in both of the radial direction and the circumferential direction)
(Reference Light Pixel Size)=41.1 μm (in both of the radial direction and the circumferential direction)
(Thickness of Gap Layer Lg)=60 μm
(Thickness of Cover Layer L1)=60 μm
(Thickness of Recording Layer L2)=300 μm.
   In addition, in this case, the size of one pixel in the SLM 4 is 13.7 μm, so that the extension ratio of the minimum modulation unit in the simulation in the case of the example becomes 3×3 times. In addition, as shown in FIG. 29B, in the case where the gap layer Lg is provided, the focus position of the recording/reproduced light is set to be on the interfacial surface of the cover layer L2 and the gap layer Lg. Therefore, in this case, the separation distance D1 from the recording layer L2 to the focus position becomes 60 μm.

In FIG. 30, in the example of the related art, the diffraction efficiency of the case where there is no tilt is 0.311%, and the diffraction efficiency of the case where there is a tilt is 0.0382%, so that the diffraction efficiency with respect to the tilt of +/−0.112° deteriorates by 88%.

In addition, in the example of the related art, the SNR of the case where there is no tilt is 6.07, and the SNR of the case where there is a tilt is 3.79, so that the SNR with respect to the tilt of +/−0.112° deteriorates by 38%.

However, in the example of the embodiment, the diffraction efficiency of the case where there is no tilt is 0.085%, which is lower than that of the example of the related art, and the diffraction efficiency of the case where there is a tilt is 0.0629%, so that the deterioration in the diffraction efficiency with respect to the tilt of +/−0.112° is merely 26%.

In addition, the SNR of the case where there is no tilt is 5.37, which is lower than that of the example of the related art, and the SNR of the case where there is a tilt is 4.72, so that the deterioration in the SNR with respect to the tilt of +/−0.112° is merely 12%.

In this manner, the deterioration in the SNR at the time of occurrence of tilt is suppressed by about ⅓ in comparison with the relate art.

According to the result, it may be understood that, in the third embodiment, the tilt tolerance may be improved in comparison with the example of the related art.

### 3-4. Modified Example of Third Embodiment

Herein, in the third embodiment, the method of extending the minimum modulation unit for the reference light is employed, and the same time, the method of shifting the focus position of the recording/reproduced light to be separated from the recording layer L2 in order to suppress the deterioration in the SN ratio caused by the DC concentration occurring in association with the extension of the minimum modulation unit is adapted to the case where the focus position is set to be in the vicinity of the surface like the first embodiment. However, the aforementioned methods may also be very properly adapted to the case where the focus position is set to be on the reflecting plane like the case in the related art.

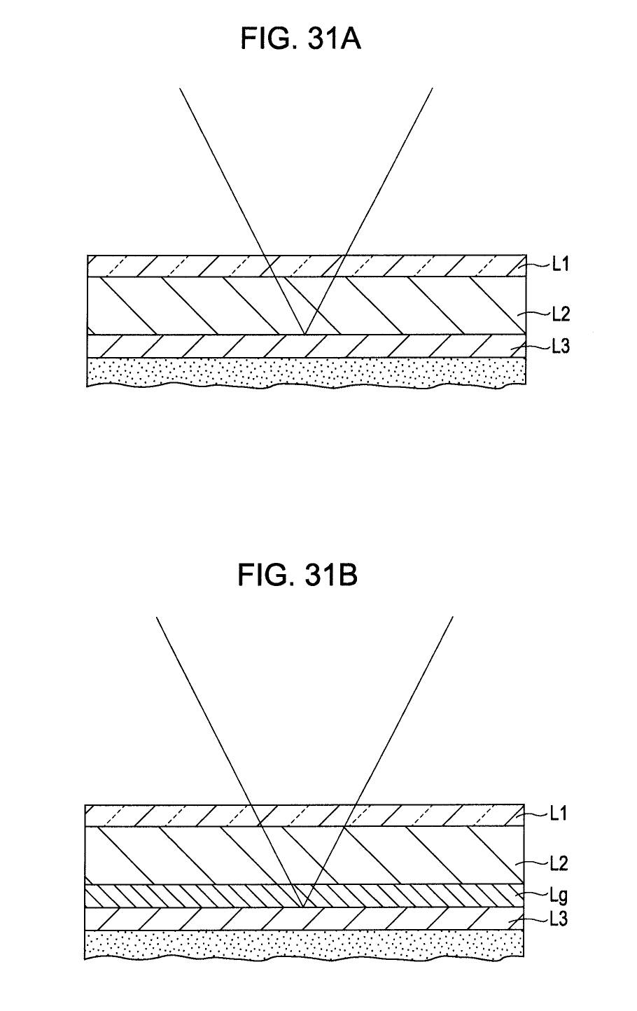

FIGS. 31A and 31B are diagrams illustrating a modified example of the third embodiment where the method of extending the minimum modulation unit and separating the focus position from the recording layer L2 is adapted to the case in the related art where the focus position is set to be on the reflecting plane.

First, in the related art, as shown in FIG. 31A, in the hologram recording medium, the cover layer L1, the recording layer L2, and the reflecting layer L3 are formed in this order from the upper layer side, and the focus position of the recording/reproduced light is configured to be coincident with the reflecting plane of the reflecting layer L3.

In this case, in the case where the focus position is to be separated from the recording layer L2, as shown in FIG. 31B, for example, the gap layer Lg is inserted between the recording layer L2 and the reflecting layer L3. Due to the insertion of the gap layer Lg, in the state that the focus position of the recording/reproduced light is set to be on the reflecting plane, the focus position may be separated from the recording layer L2 by a distance corresponding to the thickness of the gap layer Lg.

In this manner, even in the case where the method of extending the minimum modulation unit of the reference light and, at the same time, separating the focus position from the recording layer L2 is adapted to the recording and reproducing apparatus in the related art where the focus position is set to be on the reflecting plane, the decrease in the diffraction efficiency or the SN ratio may be suppressed, and the various types of tolerance may be improved by the extension of the minimum modulation unit of the reference light.

### 4. Modified Example

Hereinbefore, the exemplary embodiments of the invention are described, but the invention is not limited to the detailed embodiments described above.

For example, in the above description, although the focus position of the recording/reproduced light is set to be within the range from the surface of the hologram recording medium HM to the reflecting plane of the reflecting layer L3, according to the aforementioned relational equation with respect to the amount W of occurrence of coma aberration, that is, “W∝NA³·t”, in order to suppress the coma aberration caused by the tilt, the focus position may be set to the position of the objective lens 11 side rather than the surface of the recording medium (that is, the position where the value of t is negative).

In addition, according to the aforementioned relational equation, in terms of the suppression of the coma aberration, the best case is set such that t=0.

In any case, according to the invention, since the separation distance (|t|) between the surface of the recording medium and the focus position of the recording/reproduced light is set to be smaller than the separation distance between the surface of the recording medium and the lower layer side surface of the recording layer (that is, the distance between the surface and the focus position in the case of the related art), the coma aberration caused by the tilt may be suppressed in comparison with the case of the related art, so that the tilt tolerance may be improved.

In addition, in the above description, although the invention is exemplarily adapted to the case where the recording and the reproducing are performed on a reflection-type hologram recording medium HM, the invention may also be very suitably adapted to the case where the recording and the reproducing are performed on a transmission-type hologram recording medium HM, which has no reflecting layer.

Herein, in the transmission-type hologram recording medium, the focus position of the recording/reproduced light in the case of the related art is also designed to be coincident with a lower layer side surface of the recording layer. Therefore, in the case of employing the transmission-type hologram recording medium, as described above, “the separation distance (|t|) between the surface of the recording medium and the focus position of the recording/reproduced light is set to be smaller than the separation distance between the surface of the recording medium and the lower layer side surface of the recording layer”, so that the value of t is smaller than that of the case of the related art. As a result, similarly to the case of employing a reflection-type hologram recording medium, the coma aberration caused by the tilt may be suppressed.

In addition, in the above description, the invention is exemplarily adapted to the case where the recording and the reproducing are performed on the hologram recording medium, but the invention may also be very suitably adapted to the case where only the recording or only the reproducing is performed.

In the case where only the recording is performed, both of the signal light and the reference light are generated by the spatial light modulator, as a light illuminating apparatus. On the other hand, in the case where only the reproducing is performed, only the reference light may be generated by the spatial light modulator.

In addition, in the second embodiment, in the case where only the recording is performed, the partial diffraction device 33 is unnecessary. In addition to this configuration, in the aperture 30, a configuration for inserting and drawing back the aperture 30 is unnecessary, so that the aperture 30 may be disposed to be fixed on the Fourier plane SF (or in the vicinity thereof) similarly to the case of the related art.

In addition, in the second embodiment, the aperture 30 is configured to be inserted or drawn back with respect to the light path by slide driving, but the aperture 30 may be configured to be inserted or drawn back with respect to the light path by other driving methods such as a jump up/down driving method.

In addition, in the second embodiment, if the partial diffraction device 33 is disposed on the Fourier plane SF (or in the vicinity thereof) in the state where the partial diffraction device 33 is configured to rotate about the optical axis at an angle of 90° (that is, if the selective diffraction area 33a is disposed so as to selectively diffract only the p polarization), only the light outside the central portion of the forward path may be selectively diffracted (that is, the backward-path light or the light in the central portion of the forward path may be transmitted), so that a high recording density due to the reduction in size of the hologram may be obtained. In other words, according to this configuration, in the case where a high recording density is to be obtained, a configuration of inserting or drawing back the element at the time of recording or reproducing is unnecessary.

In addition, in the above description, for simplifying the description, spatial light phase modulation is not performed on the signal light and the reference light, but in order to improve the recording and reproduction performance, a random phase pattern such as a binary random phase pattern (a random phase pattern including “π” and “∘” with the same numbers thereof) may be allocated to the signal light and the reference light at the time of recording and the reference light at the time of reproducing. Such allocation of the phase pattern may be implemented, for example, by inserting an optical deices such as a so-called phase mask of performing phase modulation by providing a convex-concave shape thereto so as to generate an optical path difference to incidence.

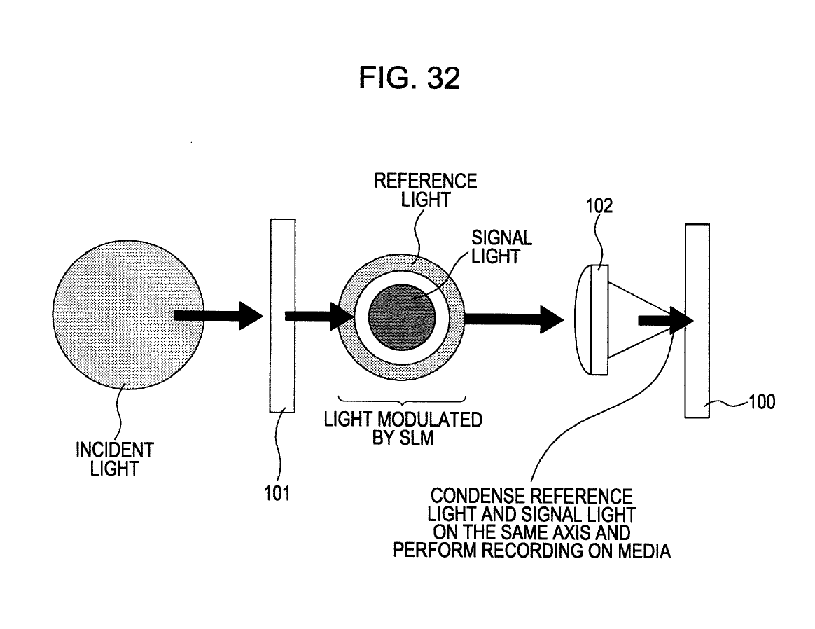

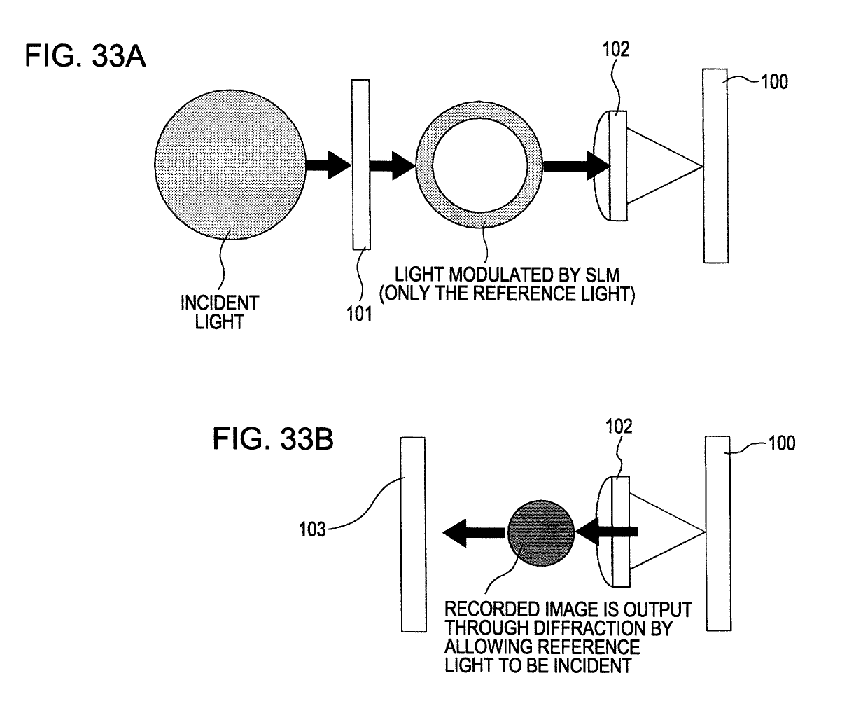

In addition, in the above description, the case where the intensity modulation for generating the signal light and the reference light is implemented by a combination of the polarization-direction-control-type spatial light modulator and the polarized beam splitter is exemplified, but the configuration of implementing the intensity modulation is not limited thereto. For example, a spatial light modulator capable of performing the intensity modulation as one body such as the SLM 101 or the DMD (Digital Micromirror Device; a registered trade mar) of the transmission-type liquid crystal panel described with reference to FIGS. 32, 33A, and 33B may be used to implement the intensity modulation.

The present application contains subject matter related to that disclosed in Japanese Priority Patent Application JP 2009-007844 filed in the Japan Patent Office on Jan. 16, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A light illuminating apparatus comprising:
a light source that allows light to illuminate a hologram recording medium having a recording layer, where information is recorded by an interference fringe of a signal light and a reference light, and a cover layer on an upper layer side thereof;
a spatial light modulator that performs spatial light modulation on the light from the light source to generate the signal light and/or the reference light; and
a light illuminating unit that allows the light, which is subject to the spatial light modulation by the spatial light modulator, as a recording/reproduced light to illuminate the hologram recording medium through an objective lens,
wherein a focus position of the recording/reproduced light is set so that a distance from a surface of the hologram recording medium to the focus position of the recording/reproduced light is smaller than a distance from the surface to a lower layer side surface of the recording layer.

2. The light illuminating apparatus according to claim 1, wherein the focus position of the recording/reproduced light is set to be in the vicinity of the surface of the hologram recording medium.

3. The light illuminating apparatus according to claim 1, wherein the focus position of the recording/reproduced light is set to be on an upper layer side surface of the recording layer.

4. The light illuminating apparatus according to claim 1,
wherein the hologram recording medium is constructed with a reflection-type recording medium having a reflecting layer in a lower layer side of the recording layer,
wherein the light illuminating unit is configured to guide the recording/reproduced light as a forward-path light, which is generated by the spatial light modulator, into the objective lens through a relay lens system and to allow the light as the backward-path light, which is obtained from the hologram recording medium in response to the illumination of the recording/reproduced light as the forward-path light, to be incident to the relay lens system, and
wherein the light illuminating apparatus further comprises a forward-path light selective suppressing unit that suppresses light outside a predetermined range including a center of an optical axis with respect to at least only the forward-path light at the time of recording, on a Fourier plane or a position in the vicinity thereof where the recording/reproduced light as the forward-path light is formed through the relay lens system.

5. The light illuminating apparatus according to claim 4, wherein the forward-path light selective suppressing unit is configured to include an apertures, in which a hole portion for transmitting the light within the predetermined range including the center of the optical axis is formed, and an insertion driver that inserts the aperture into the Fourier plane or the position in the vicinity thereof only at the time of recording.

6. The light illuminating apparatus according to claim 4, further comprising a backward-path light selective suppressing unit that transmits the forward-path light and suppresses only the light outside a predetermined range including a center of an optical axis with respect to the backward-path light, on a backward-path conjugating plane or a position in the vicinity thereof where the backward-path light is formed through the relay lens system.

7. The light illuminating apparatus according to claim 6, wherein the backward-path light selective suppressing unit suppresses only the light outside the predetermined range including the center of the optical axis with respect to only the backward-path light by using a partial diffraction device in which a polarization selective diffraction device having selective diffraction and transmission characteristics according to a polarization state of an incident light is formed in a portion excluding a predetermined portion of a central portion thereof.

8. The light illuminating apparatus according to claim 1,
wherein the focus position of the recording/reproduced light is set on an upper layer side of the upper layer side surface of the recording layer, and
wherein the spatial light modulator generates the reference light by extending a minimum modulation unit of the spatial light modulation for generating the reference light by 1×1 pixel.

9. The light illuminating apparatus according to claim 8, wherein the spatial light modulator is configured to extend the minimum modulation unit in a radial direction.

10. The light illuminating apparatus according to claim 8, wherein the spatial light modulator is configured to extend the minimum modulation unit in a circumferential direction.

11. The light illuminating apparatus according to claim 8, wherein the focus position of the recording/reproduced light is set to be a necessary position in the cover layer.

12. The light illuminating apparatus according to claim 8,
wherein a gap layer is formed between the cover layer and the recording layer in the hologram recording medium, and
wherein focus position of the recording/reproduced light is set on an interfacial surface of the cover layer and the gap layer.

13. The light illuminating apparatus according to claim 1, wherein the focus position of the recording/reproduced light is set to be a position on an upper layer side that is above the lower layer side surface of the recording layer by adjusting a separation distance between the objective lens and the hologram recording medium.

14. A light illuminating method in a light illuminating apparatus having a light source that allows light to illuminate a hologram recording medium having a recording layer, where information is recorded by an interference fringe of a signal light and a reference light, and a cover layer on an upper layer side thereof, a spatial light modulator that performs spatial light modulation on the light from the light source to generate the signal light and/or the reference light, and a light illuminating unit that allows the light, which is subject to the spatial light modulation by the spatial light modulator, as a recording/reproduced light to illuminate the hologram recording medium through an objective lens, the light illuminating method comprising the steps of:
setting a focus position of the recording/reproduced light so that a distance from a surface of the hologram recording medium to the focus position of the recording/reproduced light is smaller than a distance from the surface to a lower layer side surface of the recording layer; and
performing the illumination of the recording/reproduced light on the hologram recording medium.
